(19) United States
(12) Patent Application Publication
(10) Pub. No.: US 2004/0111410 A1
(43) Pub. Date: Jun. 10, 2004

(54) Information reservoir

(76) Inventors: David Alford Burgoon, Columbus, OH (US); Mark D. Davis, Sunbury, OH (US); Kevin E. Dorow, Kennewick, WA (US); Todd A. Hitt, Worthington, OH (US); Douglas David Mooney, Columbus, OH (US); Steven Wayne Rust, Worthington, OH (US); Loraine T. Sinnott, Columbus, OH (US)

Correspondence Address: DINSMORE & SHOHL LLP, One Dayton Center, Suite 500, Dayton, OH, 45402-2023, US

(21) Appl. No.: 10/684,975

(22) Filed: Oct. 14, 2003

Related U.S. Application Data
(60) Provisional application No. 60/418,011, filed on Oct. 14, 2002.

(51) Int. Cl. G06F 7/00

(52) U.S. Cl. 707/4

(57) ABSTRACT

Approximate answers to queries are provided by executing queries against a representation of a data source in addition to, or in lieu of accessing the source data itself. A representation of a data source, referred to herein as an Information Reservoir, is constructed and maintained using probabilistic methodologies based upon a Poisson sampling approach. The Information Reservoir provides approximate answers to ad hoc queries, potentially in a small fraction of the time required to calculate an exact answer. Associated variances are also provided that may additionally be used to calculate confidence intervals bounding the exact answer. An Information Reservoir may be biased toward a subset of the information in the original data source and/or tailored to the anticipated query workload. Queries expressed as if directed to the original data source may be automatically translated to run against the Information Reservoir with little or no additional burden placed on the Information Reservoir user. Information Reservoir collections may be created that offer users approximate answers of varying levels of precision. Information Reservoirs may also be combined with non-sampling concise representations to increase the precision of approximate answers for certain classes of queries. For example, approximations to specific multidimensional histograms may be combined with an Information Reservoir to accommodate highly selective queries that sampling does not effectively address.

### CROSS-REFERENCE TO RELATED APPLICATIONS

This application claims the benefit of U.S. Provisional Application Serial No. 60/418,011, filed Oct. 14, 2002.

### BACKGROUND OF THE INVENTION

The present invention relates in general to database systems and in particular to systems and methods for generating representations of data sources that can be used to obtain approximate answers to queries along with approximate variances for the approximate answers.

Currently, there are two general approaches commonly used for querying large relational databases. A first approach uses any combination of a broad range of solutions categorized under the heading of on-line analytical processing (OLAP). A second approach requires customized massively parallel computing solutions. Each of the above solutions can query very large databases in a reasonably timely manner. However, each has performance and cost consequences that must be weighed against a user's desired functionality.

For example, OLAP requires that a user plan ahead of time the types of queries anticipated. Basically, an OLAP data cube is developed to enable executing a limited range of queries in timely fashion. The developed OLAP data cube is not necessarily relational in character however. Further, OLAP does not support unplanned queries. Rather, unplanned queries must be executed against the original source database or modifications must be made to the developed OLAP data cube. Either of the above approaches to dealing with unplanned queries requires considerable computation times resulting in often-unacceptable delays in obtaining query answers.

As an alternative to OLAP, parallel computing solutions may be implemented to respond to queries of large databases. Typical parallel computing solutions support the ability to perform both planned and unplanned queries of large databases. However, parallel computing solutions require a combination of software and hardware to take advantage of advanced parallel computing methodologies. Such solutions require proprietary data structures and computational algorithms that speed the intensive calculations and disk access by employing massively parallel computing hardware. However, such hardware and software represent a tremendous annual capital expense few companies can afford.

In a traditional database setting, it is assumed that a response to a query should provide an exact answer. However, in an increasing number of applications, the associated cost for that exact query answer may be intolerable. For example, certain applications require users to analyze data interactively. In other applications, users or other computer processes may need to make quick decisions based upon query answers. Such actions are not possible, or become increasingly difficult as delays in providing query answers increase.

Accordingly, demands for immediate, or near immediate answers make OLAP and even parallel processing systems inadequate in certain applications. For example, as the number and type of queries supported by an OLAP data cube increase, the number of computations required to create the OLAP data cube increases, maintenance of the OLAP data cube becomes more complex and execution time for the supported queries becomes slower. Likewise, massively parallel systems also suffer from processing delays and system complexity. For example, continuing growth in the volume of considered data often makes formerly sufficient parallel solutions inadequate sooner than might be desirable.

However, it is recognized that in many circumstances, users can tolerate small amounts of error in query results in exchange for other cost benefits. For example, an approximate answer to a query may suffice, especially if accompanied by an associated approximate variance. Approximate answers to queries provide a trade off that allows acceptable levels of potential error in the results of a query in exchange for increases in speed and/or flexibility, and are thus useful in a wide number of applications ranging from decision support to real-time applications. For example, a manager of a business or other entity reviewing summary level information may tolerate or even prefer figures in the summary level information to be rounded to a level of precision less than the actual computed figures. Indeed, certain summary reports compute exact values and then intentionally round those values prior to presenting the data in the form of a summary report.

### SUMMARY OF THE INVENTION

The present invention overcomes the disadvantages of previously known database systems by providing systems and methods for generating representations of data sources that can be used to generate approximate answers to queries along with approximate variances for the approximate answers. The present invention is not limited to the solution of a particular problem, but rather presents a general solution that can be applied to a broad class of applications.

According to various embodiments of the present invention, a representation of a data source, referred to herein as an Information Reservoir, is constructed. The Information Reservoir can be constructed in a manner such that the representation of the data source is orders of magnitude smaller than the data source itself thus enabling a query executed against the Information Reservoir to respond significantly faster than that same query executed directly on the data source itself. Further, the Information Reservoir can be queried to provide answers to both planned and ad hoc queries. For example, according to an embodiment of the present invention, answers to ad hoc queries are obtained from the Information Reservoir and the results are provided to a user. If the Information Reservoir is incapable of returning the exact answer, an approximate answer is returned along with an approximate variance for the approximate answer. The approximate variance provides a measure of the accuracy of the approximate answer compared to an exact answer.

According to an embodiment of the present invention, probabilistic methodologies based upon a Poisson sampling approach are implemented to construct and maintain an Information Reservoir. Under certain conditions, the probabilistic sampling approaches herein may be implemented so as to mimic other sampling methodologies such as stratified sampling. Probabilistic sampling can further support additional functionality such as the association of probabilities assigned according to any desired strategy. For example, probabilities expressed in terms of rates of inclusion influenced by anticipated workloads and/or group-by queries can be employed in the sampling process and associated with the resulting samples.

In accordance with another embodiment of the present invention, systems and methods are provided for designing, building, and maintaining one or more Information Reservoirs as well as for using Information Reservoirs to provide approximate answers to queries. Designer and builder tools are provided to allow a user to build, bias and maintain one or more Information Reservoirs. Tools are also provided to manipulate and re-map queries against the data source to the Information Reservoir, and output tools are provided to convey the computed approximate query answers.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a block diagram of an approximate query answer system according to one embodiment of the present invention;

FIG. 2 is a schema/attribute diagram of a fictitious, exemplary relational database;

FIG. 3 is a table level directed, acyclic graph of the relational database of FIG. 2;

FIG. 4 is a chart illustrating fictitious, exemplary tuples for the SALESDEPT table of FIG. 2;

FIG. 5 is a chart illustrating fictitious, exemplary tuples for the CUSTOMER table of FIG. 2;

FIG. 6 is a chart illustrating fictitious, exemplary tuples for the ORDERS table of FIG. 2;

FIG. 7 is a directed, acyclic graph of the tuples of FIGS. 4 and 5 based upon the schema/attribute associations illustrated in FIG. 2;

FIG. 8 is a flow chart illustrating a method of constructing an Information Reservoir according to another embodiment of the present invention;

FIG. 9 is a schema/attribute diagram of a fictitious, exemplary Information Reservoir associated with the relational database of FIG. 2;

FIG. 10 is a flow chart illustrating a method for identifying and sampling that part of the data source that is of workload interest to the Information Reservoir user;

FIG. 11 is a partial schema/attribute diagram of the TCP-H test database;

FIG. 12 is a flow chart illustrating a method of establishing appropriate target rates of inclusion driven by minimizing the error associated with approximate answers to a selected set of queries according to an embodiment of the present invention;

FIG. 13 is a flow chart illustrating a method of determining a prediction interval for the number of tuples selected from a table into an Information Reservoir according to an embodiment of the present invention;

FIG. 14 is a flow chart illustrating a method of performing external control of Information Reservoir size according to an embodiment of the present invention;

FIG. 15 is a flow chart illustrating a method of performing external control of Information Reservoir space according to an embodiment of the present invention;

FIG. 16 is a flow chart illustrating a method of estimating upper and lower bounds on Information Reservoir size according to an embodiment of the present invention;

FIG. 17 is a flow chart illustrating a method of estimating Information Reservoir size according to an embodiment of the present invention;

FIG. 18 is a flow chart illustrating a method of adjusting the precision of an Information Reservoir according to an embodiment of the present invention;

FIG. 19 is a flow chart illustrating a method of selecting the appropriate size of an Information Reservoir according to an embodiment of the present invention;

FIG. 20 is a flow chart illustrating a method for creating an Information Reservoir using clustering and stratified sampling;

FIG. 21 is a flow chart illustrating a method of constructing an Information Reservoir according to one embodiment of the present invention;

FIG. 22 is a flow chart illustrating a sampling approach according to another embodiment of the present invention;

FIG. 23 is a flow chart illustrating a method of building an Information Reservoir from a distributed data source;

FIG. 24 is a flow chart illustrating a method of performing incremental maintenance on an Information Reservoir according to an embodiment of the present invention;

FIG. 25 is a flow chart illustrating a method of loading buffer tables for performing incremental maintenance of an Information Reservoir according to an embodiment of the present invention;

FIG. 26 is a flow chart illustrating a method of drawing samples during an add operation of incremental maintenance of an Information Reservoir according to an embodiment of the present invention;

FIG. 27 is a flow chart illustrating a method of adding samples to an Information Reservoir during incremental maintenance according to an embodiment of the present invention;

FIG. 28 is a flow chart illustrating a method of maintaining an Information Reservoir of desired size in the presence of incremental maintenance being performed on an Information Reservoir according to another embodiment of the present invention;

FIG. 29 is a flow chart illustrating a method for continually rebuilding an Information Reservoir according to an embodiment of the present invention;

FIG. 30 is a flow chart illustrating a method of subsampling an Information Reservoir according to one embodiment of the present invention;

FIG. 31 is a block diagram of a system architecture for constructing Information Reservoirs and providing approximate answers to queries based upon the created Information Reservoirs;

FIG. 33 is a flow chart illustrating a method for rewriting a complex query directed at a data source for execution against an Information Reservoir according to an embodiment of the present invention; and

FIG. 32 is a block diagram of a system architecture for constructing multi-modal Information Reservoirs and providing approximate answers to queries based upon the created multi-modal Information Reservoirs.

### DETAILED DESCRIPTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

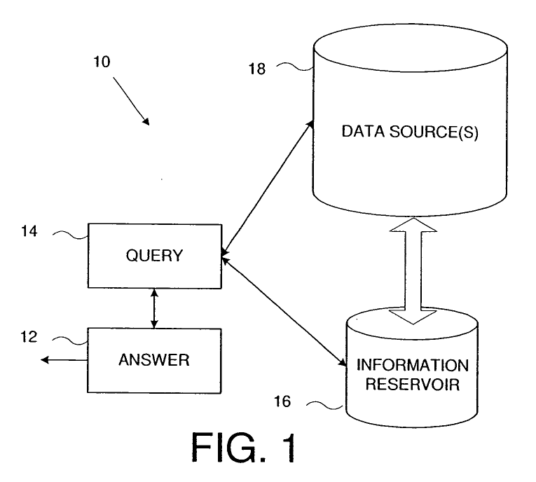

Referring to FIG. 1, according to various embodiments of the present invention, a system 10 is provided whereby an answer 12 is generated by executing a query 14 against an Information Reservoir 16 instead of, or in addition to, directly querying a data source 18. If the system 10 is incapable of returning the exact answer, an approximate answer is returned. As used herein, an Information Reservoir is a representation of one or more data sources. For example, the Information Reservoir may represent relational, network, flat, logic based, object oriented, and hierarchical databases, data streams, and other collections of data.

The various embodiments of the present invention may be implemented as a software solution executable by a computer, or provided as software code for execution by a processor on a general-purpose computer. As software or computer code, the embodiments of the present invention may be stored on any computer readable fixed storage medium, and can also be distributed on any computer readable carrier, or portable media including disks, drives, optical devices, tapes, and compact disks.

1. The Information Reservoir.

An Information Reservoir is a representation of a data source that is created by sampling from among individual data source elements and that can be used to generate approximate answers to queries directed at the data source along with approximate variances for the approximate answers. Any collection of data tables with defined relationships among the tables and specifications describing each table can serve as a data source. The Information Reservoir is in turn a collection of data tables with defined relationships among the tables and specifications describing each table.

Because an Information Reservoir is the result of a statistical sampling process, it is not possible to examine a single data table collection and determine whether or not it is an Information Reservoir for a given data source. Instead it is necessary to examine the process employed to create the data table collection to determine whether or not the collection is an Information Reservoir.

Consider the analogous task of determining whether or not a subset of n specific items from a population of N distinct items is a simple random sample taken without replacement (simple random sample) from the population. This determination can only be made by examining the process employed to create the subset of items. The subset of items is a simple random sample if and only if the process employed to create the subset is simple random sampling process. In turn, the process is a simple random sampling process if and only if every possible subset of n items from the population had equal probability of being produced by the process, regardless of the steps involved in the process.

In a similar fashion, a data table collection is an Information Reservoir for a given data source if and only if the process employed to create the collection is an Information Reservoir Creation Process. The process employed to create a data table collection is an Information Reservoir Creation Process if and only if the process output satisfies a set of specific conditions. Before specifying the set of conditions, it is useful to define a number of terms.

2. Terminology.

For the purposes of defining and describing the present invention, the term “table” is used herein to refer to information organized in row-column format. The terms “table” and “attribute” are used herein refer to a row of and a column of a table, respectively. The terms “attribute value” and “value” are both used herein to refer to the contents of a table cell. The term “table specification” as used herein includes a list of all the attributes in a table along with a set of valid values or valid value ranges for each attribute.

Two tables are said herein to have a “directed relationship,” or equivalently an “ancestor-descendant relationship”, if there exists a mapping function such that each and every tuple in one of the tables, referred to as the “descendant” table, may be mapped to no more than one tuple in the other table, referred to as the “ancestor” table. A tuple from the ancestor table and a tuple from descendant table are said herein to have a directed relationship, or equivalently an ancestor-descendant relationship, if the descendant tuple maps to the ancestor tuple.

If Table B is a descendant of Table A and an ancestor to Table C, then Tables A and C are said herein to have an “implied directed relationship” or equivalently an “implied ancestor-descendant relationship,” with Table A acting as the ancestor and Table C acting as the descendant. The mapping function that links Tables A and C is the composition of the function linking Table A to Table B and the function linking Table B to Table C. A tuple from the Table A and a tuple from Table C are said herein to have an implied directed relationship, or equivalently an implied ancestor-descendant relationship, if the descendant tuple from Table C maps to a tuple in Table B that, in turn, maps to the ancestor tuple from Table A.

The term “table collection” is used herein to refer to a set of two or more tables along with a table collection schema. The term “table collection schema” as used herein includes a list of the tables in the table collection, a list of the declared ancestor-descendant relationships among tables in the table collection each with a mapping function, and the table specifications for each of the tables in the table collection. It is not necessary to declare all existing relationships among the tables in a table collection. A declared relationship between two tables in a table collection is said herein to be a “parent-child relationship” if there are no equivalent relationships involving an intermediate table implied by the declared relationships. Without loss of generality, it is assumed herein that the declared relationships in a table collection schema are all parent-child relationships.

The term “table collection graph” is used herein to refer to directed graph with the tables in a table collection as vertices and the declared parent-child relationships as directed edges from the child tables to the parent tables. A table collection is said herein to be an “acyclic table collection” if the corresponding table collection graph is acyclic. A directed graph is considered to be acyclic if it is impossible to begin at any vertex, follow directed edges within the graph, and return to the original vertex.

The schema for Table Collection B (Schema B) is said herein to be “subordinate” to the schema for Table Collection A (Schema A) if (1) all tables listed in Schema B are also listed in Schema A, (2) all relationships listed in Schema B are also listed or implied in Schema A, (3) all attributes listed in Schema B are also listed in the specification of the corresponding table in Schema A, and (4) all valid attribute values or valid attribute value ranges listed in Schema B are included in the valid attribute values or valid attribute value ranges listed in the specification of the corresponding table in Schema A.

Finally, the term “data source” is used herein to refer to any acyclic table collection.

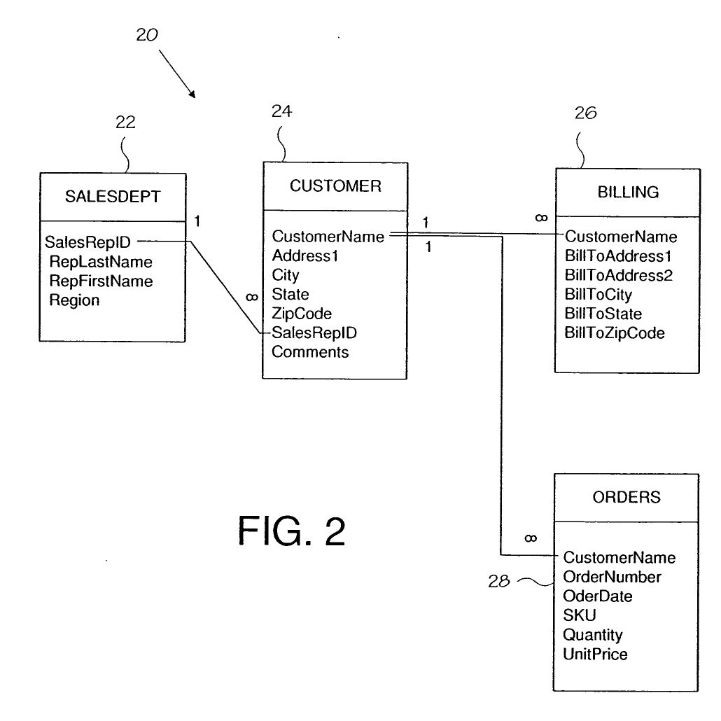

A most common example of a table collection is a relational database. Referring to FIG. 2, consider the simple case of an exemplary and purely hypothetical relational database 20 illustrated in a relationship/attribute format that describes a portion of the schema for the relations of the database 20. As shown, the relational database 20 includes a plurality of tables including a SALESDEPT table 22, a CUSTOMER table 24, a BILLING table 26 and an ORDERS table 28. A SalesRepID attribute is a unique key in the SALESDEPT table 22 and links in a one-to-many cardinality to a SalesRepID attribute (foreign key field) of the CUSTOMER table 24. A CustomerName attribute of the CUSTOMER table 24 links in a one-to-many cardinality to a CustomerName field (foreign key field) of the Billing Table 26. The CustomerName attribute of the CUSTOMER table 24 further links to a CustomerName field (foreign key field) in a one-to-many cardinality to the ORDERS table 28.

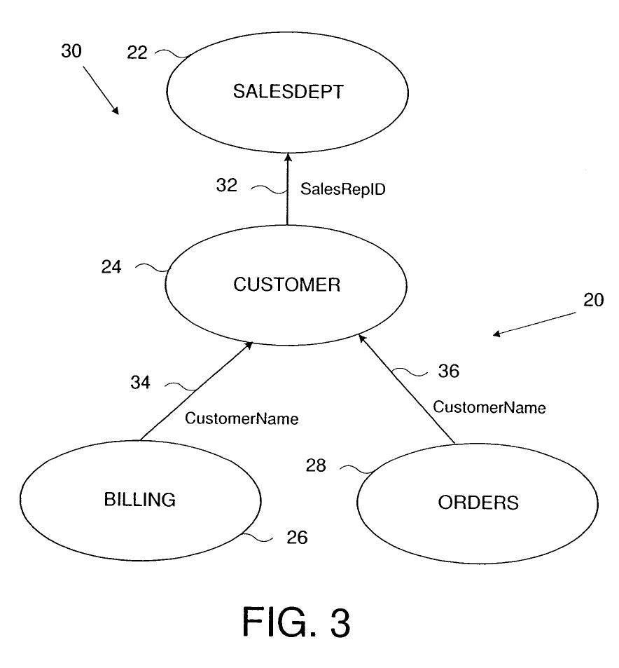

Referring to FIG. 3 a directed, acyclic graph 30 of the relational database 20 shown in FIG. 2, illustrates the relationships between the relations at the table level. As shown, the unique key attribute SalesRepID of the SALESDEPT table 22 links to the foreign key attribute SalesRepID of the CUSTOMER table 24 by a first directed edge 32. The unique key attribute CustomerName in the CUSTOMER table 24 links to the foreign key attribute CustomerName in the BILLING table 26 by a second directed edge 34. The unique key CustomerName in the CUSTOMER table 24 further links to the foreign key attribute CustomerName in the ORDERS table 28 by a third directed edge 36. As shown, the BILLING and ORDERS tables 26, 28 are children of the (parent) CUSTOMER table 24 and the CUSTOMER table 24 is a child of the (parent) SALESDEPT table 22. The SALESDEPT table 22 is an ancestor of the CUSTOMER, BILLING and ORDERS tables 24, 26 and 28. Likewise, the CUSTOMER, BILLING and ORDERS tables 26, 28 are descendants of the SALESDEPT table 22.

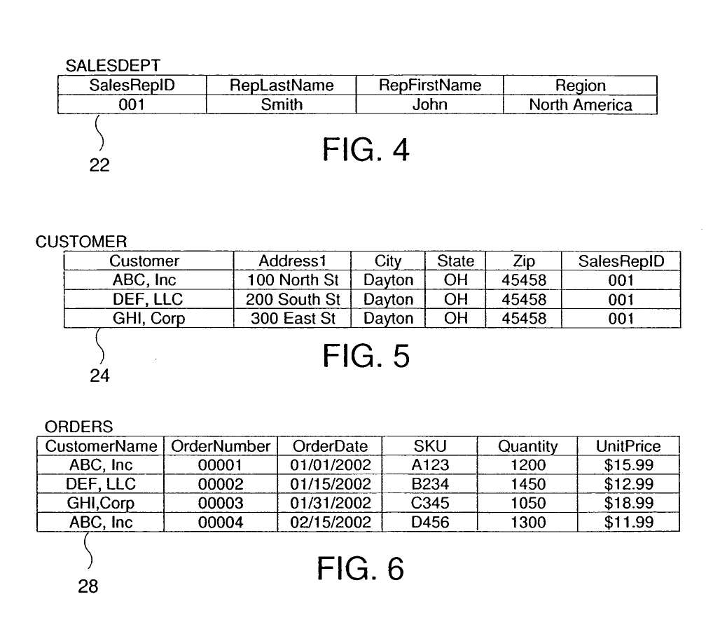

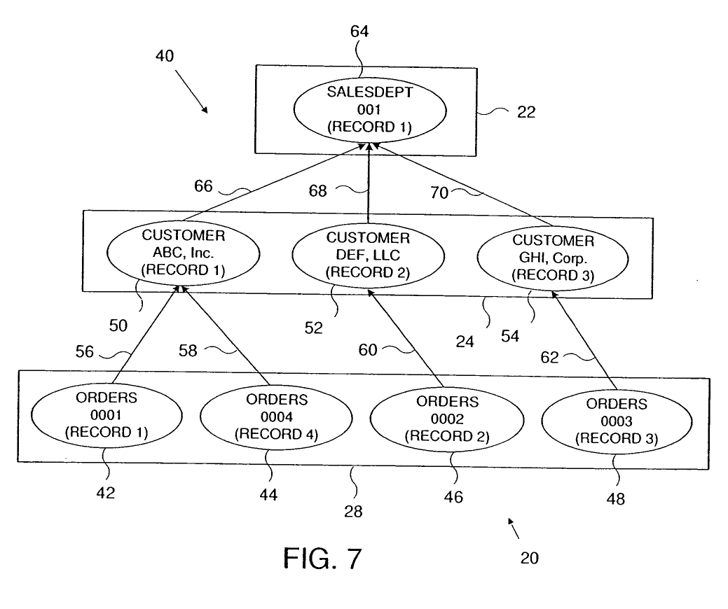

Referring to FIG. 4-6, some exemplary tuples (rows of data) are provided for the SALESDEPT table 22, the CUSTOMER table 24, and the ORDER table 28 associated with the relational database 20 shown in FIG. 2. Referring to FIG. 7, an acyclic directed graph 40 illustrates a mapping of a portion of the relational database 20 at the tuple level based upon the tuples in FIGS. 4-6. The child tuples 42, 44, 46 and 48 from the ORDERS table 28 map to the corresponding parent tuples 50, 52 and 54 of the CUSTOMER table 24 along respective directed edges 56, 58, 60 and 62. Tuples 42 and 44 are both children tuples of the (parent) tuple 50. Likewise, tuple 46 is a child of the (parent) tuple 52, and tuple 48 is the child of the (parent) tuple 54. Further, each of the tuples 50, 52 and 54 are children of, and connect to the (parent) tuple 64 in the SALESDEPT table 22 along respective directed edges 66, 68 and 70.

3. Information Reservoir Creation Process.

According to one embodiment of the present invention, a process for constructing a table collection from a data source is provided. According to the process, which may be considered an Information Reservoir Creation Process, the following conditions are satisfied:

i. A subset of the tables, among which there are no declared ancestor-descendant relationships, in the table collection are designated as “sampling initiation tables.”

ii. Each and every table in the table collection is a member of one and only one of the following two groups:

a. Directly-Sampled Tables—Tables that are either sampling initiation tables or ancestor tables to one or more sampling initiation tables; and

b. Descendant-Sampled Tables—Tables that are descendant tables to a sampling initiation table.

iii. The table collection schema is equivalent to the data source schema except that the list of attributes for each directly-sampled table includes a new attribute containing “actual rate of inclusion” values. Alternatively, the actual rate of inclusion values can be stored in any manner and linked to the associated tuples.

iv. Each tuple included in a table collection, after elimination of the actual rate of inclusion attribute value if present, is equivalent to one and only one tuple in the corresponding table of the data source.

v. If a tuple is included in a table collection produced by the process, then all ancestor tuples are also included.

vi. If a tuple from a sampling initiation table is included in a table collection produced by the process, then all descendant tuples are also included.

vii. The actual rate of inclusion value stored with a data source tuple when it is included in a directly-sampled table of a table collection produced by the process is always the same and represents the probability that a randomly selected table collection produced by the process will contain the data source tuple.

viii. The probability that a randomly selected table collection produced by the process will contain a select data source tuple within one of its descendant-sampled tables is equal to the rate of inclusion induced by the set of all ancestor tuples to the select tuple that reside in sampling initiation tables.

ix. For any set of data source tuples from directly-sampled tables such that no pair of tuples within the tuple set has an ancestor-descendant relationship, the probability that a randomly selected table collection produced by the process will contain all of the tuples in the set is equal to the product of the corresponding actual rates of inclusion stored with each of the individual data source tuples.

4. A Method for Creating Information Reservoirs.

One embodiment of the invention employs the following process to create Information Reservoirs from a data source.

i. Modify the Data Source—

a. If desired, reduce the size of the data source by reducing the number of

Tables,

Relationships between tables,

Attributes, and/or

Valid values for attributes.

b. If desired, add new attributes to data source tables to include aggregate values calculated from descendant tuples in order to improve the precision of the approximate answers for specific classes of queries.

ii. Identify Sampling Initiation Tables—Designate a subset of the tables in the data source as sampling initiation tables such that

a. There are no ancestor-descendant relationships among the sampling initiation tables, and

b. Every table in the modified data source is either a directly-sampled table (sampling initiation tables and their ancestor tables) or a descendant-sampled table (a descendant table to a sampling initiation table).

iii. Create the Information Reservoir Schema and Shell—Starting with the data source schema (optionally modified in Step i), create the Information Reservoir schema and shell by adding a single new attribute to each directly-sampled table to contain “actual rate of inclusion” values.

iv. Create the Sampling Frame—Starting with the data source (optionally modified in Step i), create the sampling frame by adding four new attributes to each directly-sampled table to contain values for the following rates of inclusion:

Target rate of inclusion;

induced rate of inclusion;

Residual rate of inclusion; and

Actual rate of inclusion.

V. Specify the Information Reservoir Design—Fill the new target probability of inclusion columns of the sampling frame with values in the inclusive range [0,1]. The target rate of inclusion π^{T} is the desired minimal probability that a tuple will be included in the Information Reservoir. The target rate of inclusion is also referred to as the target probability of inclusion, target inclusion probability and target inclusion rate.

vi. Calculate Induced, Residual and Actual Rates of Inclusion—Starting with the sampling initiation tables and proceeding via parent-child relationships through all directly-sampled tables, calculate induced, residual, and actual probabilities of inclusion and fill the corresponding new table columns of the sampling frame with these calculated values.

vii. Populate the Information Reservoir Shell.

a. Populate the Information Reservoir Via Direct Sampling—For each tuple in a directly-sampled table of the data source, generate a random number from a uniform distribution on the open interval (0,1) and include the tuple in the Information Reservoir if the random number is less than the residual rate of inclusion for that tuple.

b. Populate the Information Reservoir with Ancestors—For every tuple from a directly-sampled table that is included in the Information Reservoir as a result of direct sampling, include in the Information Reservoir all corresponding ancestor tuples in the sampling frame, if they are not already included.

c. Populate the Information Reservoir with Descendants—For every tuple from a sampling initiation table that is included in the Information Reservoir as a result of direct sampling, include in the Information Reservoir all corresponding descendant tuples in the sampling frame.

Details for method steps i, ii, v, vi and vii(a) are provided in the five sections immediately following this section.

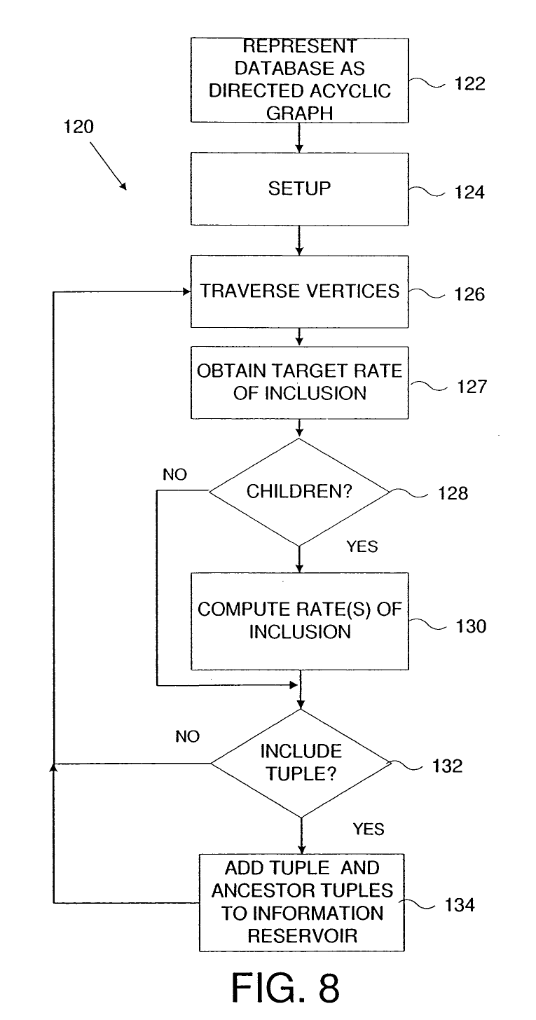

Referring to FIG. 8, a method 120 for selecting tuples into an Information Reservoir according to another embodiment of the present invention is illustrated. The method is useful for example, where the data source comprises a relational database. The data source or subset of the data source that is of interest to the Information Reservoir user is represented as a directed acyclic graph (schema graph) at step 122. An Information Reservoir setup takes place at step 124. The setup comprises those actions required by the computer environment in anticipation of tuples to be added into the Information Reservoir. For example, target rates of inclusion may need to be determined for each tuple in the data source that is to be considered.

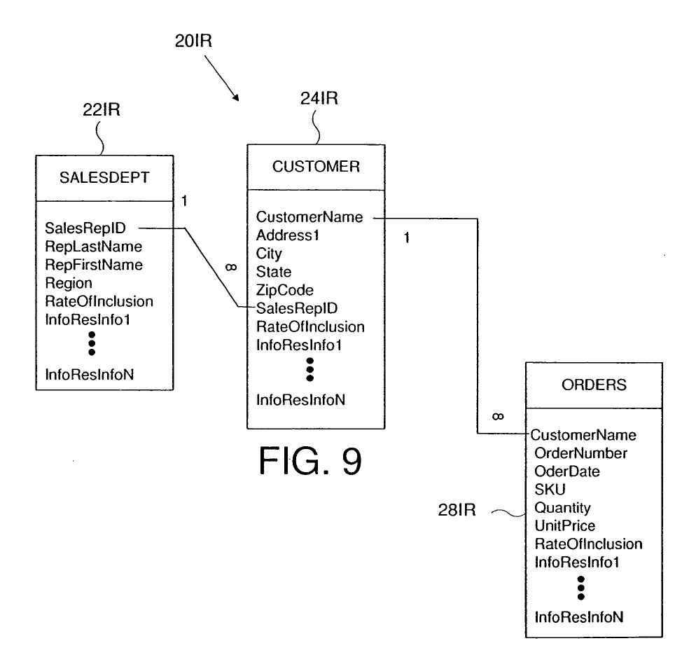

Also initially created during the set up at step 124 is an Information Reservoir that generally mimics the schema of the data source (or subset of the data source) that contains the information of interest to the Information Reservoir user. As an example, the Information Reservoir may be created by copying at least a subset of the data source schema to define an Information Reservoir schema (representation schema). Referring to FIG. 9, an Information Reservoir 20IR is essentially an instance of the subset of the schema from the relational database 20 shown in FIG. 2 that is of interest to an Information Reservoir user. The Information Reservoir 20IR includes a SALESDEPT table 22IR that corresponds generally to the SALESDEPT table 22 shown in FIG. 2, a CUSTOMER table 24IR that corresponds generally to the CUSTOMER table 24 shown in FIG. 2, and an ORDERS table 28IR that corresponds generally to the ORDERS table 28 shown in FIG. 2. In this example, only a subset of the relational database 20 of FIG. 2 is desired for the Information Reservoir 20IR. As such, the BILLING table 26 shown in FIG. 2 is not included in the Information Reservoir 20IR. If an Information Reservoir user wanted to run queries that include billing information, or if there is uncertainty whether such queries may be run on the Information Reservoir, the BILLING table 26 of FIG. 2 may also be included in the Information Reservoir 20IR.

The tables of the Information Reservoir 20IR may contain all of the attributes of the corresponding tables in the data source or a subset thereof. The selection of attributes into the various tables of the Information Reservoir 20IR may be determined by any numbers of factors such as the anticipated workload or other user requirements. For example, the CUSTOMER table 24 shown in FIG. 2 includes a Comments field that is not included in the CUSTOMER table 24IR in FIG. 9. Fields such as those for comments or miscellaneous text can consume significant amounts of memory and may not contain data that an Information Reservoir user will want to query.

The Information Reservoir 20IR may also include additional attributes not found in the data source. For example, the Information Reservoir may store a value such as a real-value realized probability attribute that corresponds to a rate of inclusion and/or a real-valued weight attribute associated with tuples selected into the Information Reservoir 20IR as described more fully herein. Referring to FIG. 9, each table 22IR, 24IR, 28IR of the Information Reservoir 20IR includes a RateOfinclusion attribute to store the actual computed rates of inclusion with each tuple added to the Information Reservoir 20IR. However, none of the tables of the relational database 20 shown in FIG. 2 include a corresponding RateOfinclusion attribute. Other information in one or more separate fields may also be stored with tuples in the Information Reservoir as represented generally by the InfoReslnfo attribute illustrated in each of the tables. Examples of additional attributes and types of information will be explained more fully herein.

Referring back to FIG. 8, sampling from the data source into the Information Reservoir according to an embodiment of the present invention, considers vertices of the acyclic graph representation at step 126. The sampling order may be carried out in any manner. However, according to one embodiment of the present invention, sampling begins with a breadth-first traversal of those vertices associated with sampling initiation tables, and then continues in the direction of the directed edges for directly-sampled tables and in opposition to the direction of the directed edges for descendent-sampled tables.

The target rate of inclusion is obtained for each tuple in the relation corresponding to the current vertex being visited at 127. A decision at step 128 determines whether the induced rate of inclusion should be computed at step 130. As an alternative, the induced rate of inclusion may be computed for each tuple in the relation corresponding to the vertex being visited at step 126 omitting the decision at step 128 because the induced rate of inclusion is zero for root nodes with in-degree zero and tuples with no descendants. Next, the residual rate of inclusion and the actual rate of inclusion are computed for each tuple in the relation corresponding to the vertex being visited at 130.

A decision is made whether to accept the tuple into the Information Reservoir at step 132. For example, a real, uniform, pseudo-random number is generated in the range of the inclusion probabilities for each tuple in the relation corresponding to the vertex visited. If this random number is less than the residual rate of inclusion for the tuple, the tuple is selected into the corresponding table of the Information Reservoir at step 134.

When a tuple is selected into the Information Reservoir, all of the ancestor tuples of the selected tuple are also included in the Information Reservoir. For example, as each vertex is visited, the tuples from the current vertex that are related to those tuples selected in the descendant vertices are selected and inserted into the corresponding table in the Information Reservoir. Referring back to FIG. 7, should tuple 42 from the ORDERS table 28 be selected into the Information Reservoir, tuple 50 from the CUSTOMER table 24 and tuple 64 from the SALESDEPT table 22 would also be selected into the Information Reservoir as tuples 50 and 64 are ancestors of tuple 42. When a tuple from a sampling initiation table is selected into the Information Reservoir, all of the descendant tuples of the selected tuple are also included in the Information Reservoir.

Prior to sampling a given table, some tuples from that table may have already had a chance to enter the Information Reservoir through foreign key linkages to tuples in previously sampled tables. For example, referring back to FIG. 5, when sampling tuples from the CUSTOMER table 24, each tuple may have already entered the Information Reservoir due to a foreign key linkage to the ORDERS table 28 illustrated in FIG. 6. Likewise, the tuple in the SALESDEPT table 22 in FIG. 4 may have entered the Information Reservoir due to the foreign key linkages to the ORDERS table 24 of FIG. 5 or the CUSTOMER table of FIG. 6. Referring back to FIG. 8, the effect of inclusion dependence is addressed by computing the induced rate of inclusion at step 130.

Because of the inclusion dependence across ancestor/descendent tables, a given ancestor tuple's chance of getting into the Information Reservoir may in fact exceed the target rate of inclusion π^{T} assigned to that ancestor tuple. Accordingly, the rate of inclusion at which a given tuple is sampled at the time that tuple's corresponding table is sampled is preferably adjusted to reflect prior opportunities for inclusion. For example, according to an embodiment of the present invention, if a tuple's prior chance of inclusion exceeds its assigned target rate of inclusion, the residual rate of inclusion of the tuple drops to 0 when its table is sampled.

Another embodiment of the invention employs the following generalizations of the method discussed above to create Generalized Information Reservoirs from a data source. Rather than include all ancestor tuples of a tuple selected during the sampling of a directly-sampled table in the Information Reservoir as specified in Step vii-b, the selection of a tuple during the sampling of a directly-sampled table induces a user-specified probability of selection on parent tuples that may be less than one. Similarly, rather than include all descendant tuples of a tuple selected during the sampling of a sampling initiation table in the Information Reservoir as specified in Step vii-c, the selection of a tuple during the sampling of a sampling initiation table induces a user-specified probability of selection on child tuples that may be less than one. The subsequent selection of each child tuple, in turn induces a probability of selection on child tuples that may be less than one. Finally, rather than including tuples from descendant-sampled tables in the Information Reservoir only as the result of an ancestor tuple from a sampling initiation table being included, descendant-sampled tables are also independently sampled giving each tuple in these tables an independent user-specified chance of being included in the Information Reservoir.

5. Modifying the Data Source.

As already indicated, an Information Reservoir user may not be interested in the entire data source. In this case, the user may modify the data source prior to creating the Information Reservoir by reducing the number of tables, the number of relationships among tables, the number of attributes in each retained table, or the number of valid values or valid value ranges for retained attributes. Also, the quality of the approximate answers provided by an Information Reservoir may be improved by adding a few carefully selected attributes to the data source before creating the Information Reservoir.

5.1. Reducing the Size and Complexity of the Data Source.

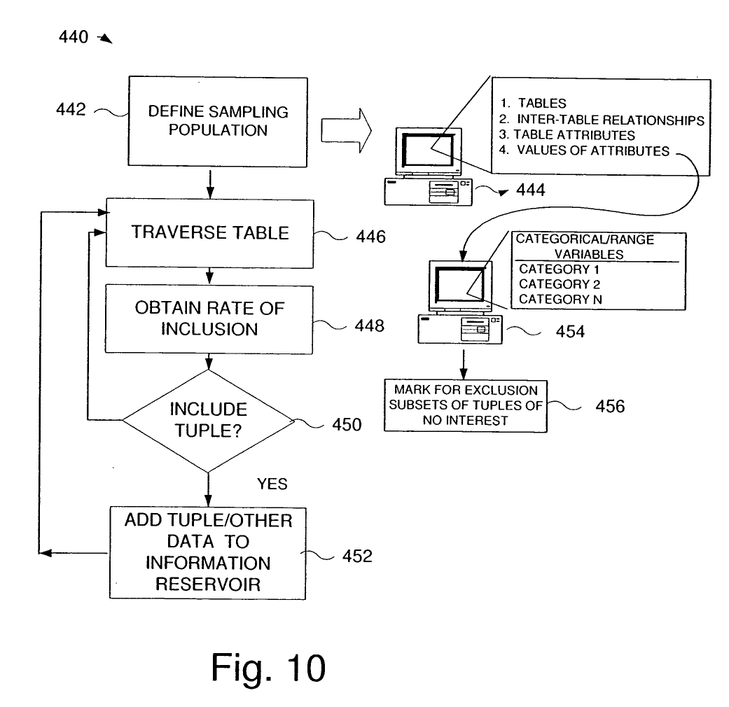

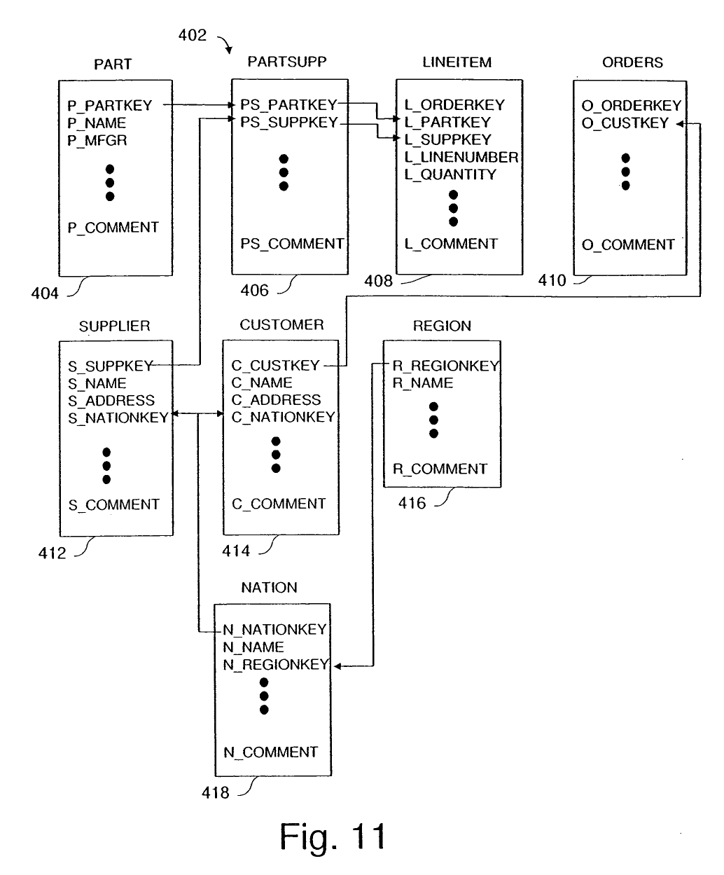

One possible approach to establishing appropriate target rates of inclusion begins by reducing the size and complexity of the data source in response to anticipated workload. Briefly, referring to FIG. 10, a first step in the process 440 of moving from workload to inclusion rates is to define the sampling population at 442, which is that portion of the database that will be assigned nonzero target rates of inclusion. The sampling population may be established, for example, through computer-supported interaction with the reservoir user at 444. The objective of the interaction is to identify the important aspects of the data source, such as tables, inter-table relationships, attributes, and values of attributes.

The relational integrity of the Information Reservoir need only match that of the database that is required to support the needs of the Information Reservoir user. For example, consider the benchmark TPC-H database, the partial schema of which is illustrated in FIG. 11. Suppose a user's need for the database is restricted to two of the database tables, the ORDERS and CUSTOMER tables 410, 414. Further assume that the user is interested in queries of the CUSTOMER table 414 and queries of the ORDERS table 410, but is not interested in queries that require their join. In TPC-H, the CUSTOMER table 414 is parent to the ORDERS table 410 as schematically represented by the arrow linking the respective CUSTKEY attributes. However, the linkage between the ORDERS and CUSTOMER tables 410, 414 is inconsequential to the user and need not be maintained in the Information Reservoir. In other words, for Information Reservoir sampling, the relationship can be ignored; parents of orders selected into the sample via sampling of the ORDERS table 410 need not be selected as well.

Referring back to FIG. 10, once the sampling population has been defined at 442, tuples are sampled by traversing each directly-sampled table and sampling the tuples of those tables. A directly-sampled table is traversed at 446 to obtain the next tuple. The rate of inclusion (such as the target rate of inclusion π^{T}) for that tuple is obtained at 448. A decision is made as to whether to accept that tuple at 450, such as by using the techniques described more fully herein. For example, the target rate of inclusion for a sample can be compared against a draw from a standard uniform distribution. If selected into the sample, that tuple is added to the Information Reservoir at 452. This procedure continues for each directly-sampled table defined in the sampling population.

The formulation of the sampling population at 442 can be accomplished through any desired interaction or input with a user. For example, to formulate the population component of the values of attributes, the user may be presented at 454 for example, with lists of the distinct values of categorical variables (e.g., geographical location, gender, product category) from dimension-defining tables. The lists would be used to mark for exclusion subsets of tuples of no interest to the user at 456. During the Information Reservoir build, for example at 448, tuples in the subsets would be assigned target rates of 0. Candidates for dimension-defining tables are upper-level tables in the directed graph of the database, including tables with no foreign keys e.g., the Region table 416 in TPC-H, the schema of which is partially illustrated in FIG. 11, or the SALESDEPT table illustrated in FIG. 2. The user could also be presented with key quantitative variables for the purpose of setting range limitations. Important classes of variables to use for range exclusion are size (e.g., sales volume, employee number, mileage) and time variables (e.g., date of transaction, season, time of day).

5.2. Including Additional Attributes.

The quality of the approximate answers provided by an Information Reservoir may be improved by adding a few carefully selected attributes to the data source before creating the Information Reservoir. Two examples of such attributes, associated with paent-restricted queries and educating the sample, are described here.

5.2.1. Parent-Restricted Queries.

It might be anticipated that users of the Information Reservoir will request the computation of aggregates in a parent table that are restricted to the parents of a particular kind of child. A query of the above-described type may not be answered as accurately as desired by an Information Reservoir that retains only the actual rate at which a parent tuple is sampled. An additional piece of information that would greatly improve estimates is knowledge that the tuple is or is not associated with the child type(s) of interest. Computations would then be limited to those tuples in the sample associated those child type(s). In a setting in which the children of concern can be anticipated, an Information Reservoir according to an embodiment of the present invention is supplemented with more than actual rates of inclusion allowing for the storage of additional information. For example, an indicator may be assigned to determine whether a tuple is associated with a given descendant. Referring to FIG. 9, each table 22IR, 24IR and 28IR in the Information Reservoir 20IR may optionally include 1 to N additional attributes identified generally by the attribute name InfoReslnfo. In this example, N is any integer greater than zero. Each additional attribute reflects the observation that each table in the Information Reservoir can hold any number of additional fields of information, including the above-described indicator in addition to an overall rate of inclusion. Moreover, each table need not include the identical number or types of additional attributes.

5.2.2. Educating the Sample.

As discussed more fully herein, there are a number of ways to bias the sampling rates for tuples in a table collection to make it more likely that subgroups of interest to users of an Information Reservoir are sufficiently represented. There are, however, many situations in which the potential for insufficient sample size cannot be overcome by targeted sampling. Under certain such circumstances, information can be added to a sample to make it more useful. The process of collecting such useful information is referred to herein, as educating the sample. In essence, information about the sampled tuples is extracted from the database. For example, selected aggregates like counts, sums, averages, minima, and/or maxima can be computed before sampling is performed and the results added to the data source as new attributes. Alternatively, these attributes can be computed either while the sample is being drawn, or after it has been drawn but while the database is still available for processing.

The principles of educating the sample according to an embodiment of the present invention can be illustrated by an example using the Transaction Processing Performance Council's ad-hoc decision support benchmark known in the industry as the TCP-H benchmark. The TCP-H benchmark consists of a number of business oriented ad-hoc queries that are to be executed on predetermined databases. This example focuses on educating the sample for the purpose of responding to queries requiring “Group By” aggregation, however, the principles discussed herein are in no way limited to this particular class of problem. Referring to FIG. 11, a schema 402 is illustrated to represent the structure of a 100-megabyte version of the TCP-H benchmark, referred to herein as “the test database”. An Information Reservoir based upon the test database was constructed using a fixed target rate of 1%, and is referred to herein as the “test reservoir”. As can be seen by the schema 402, the test database is a relational database comprised of eight tables including a PART table 404, PARTSUPP table 406, LINEITEM table 408, ORDERS table 410, SUPPLIER table 412, CUSTOMER table 414, REGION table 416 AND NATION table 418. Each table 404, 406, 408, 410, 412, 414, 416, 418 includes a plurality of attributes, however, for clarity, only a representation of the types of attributes associated with respective tables are illustrated. The foreign key joins of those tables are schematically illustrated by the arrowed lines, which point in the direction of the one to many relationships.

The value of storing pre-computed aggregates will be illustrated by considering the following correlated query, which is an adaptation of Query 17 from the set of TPC-H benchmark queries published in the TPC BENCHMARK™ H Decision Support Standard Specification Revision 2.0.0 published in 2002 by the Transaction Processing Performance Council (TPC) of San Jose Calif., which is herein incorporated by reference in its entirety.

select sum(l_extendedprice) / 7.0 as avg_yearly
from lineitem L1
where l_quantity < (

Select 0.2 * avg(l_quantity)
From lineitem L2
Where L2.l_partkey = L1.l_partkey
);

In this query, for each tuple, t, of the LINEITEM table 408, the value of I_quantity associated with t is compared to the quantity 0.2*avg(I_quantity), where the average is taken over those tuples in the table that have the same partkey value as t. If I_quantity<0.2*avg(I_quantity), t is included in the computation of the outer sum, sum(I_extendedprice).

In the test database, the LINEITEM table 408 had 600,000 tuples. The PARTKEY attribute had 20,000 distinct values. Thus, on average, 30 tuples are associated with each of the PARTKEY values. In the test reservoir constructed from the test database, 5083 of the 20,000 PARTKEYS were sampled. While a PARTKEY value may be shared by up to 3 tuples, most often it is associated with only one tuple. Therefore, the test reservoir was deemed inadequate for the derivation of highly useful estimates of avg(I_quantity) by PARTKEY.

If the test reservoir created against the test database contained the value of avg(I_quantity) by partkey for those partkeys actually sampled, the reservoir could better support a response to the query. This can be seen because, for the sampled lineitems, the inner query would be known exactly. Under this arrangement, estimation would be limited to the outer query sum.

6. Identifying Sampling Initiation Tables.

The first step in determining the characteristics of the Information Reservoir is identifying the sampling initiation tables. These tables represent the greatest level of detail required by the Information Reservoir user. While information at a greater level of detail may be included in the Information reservoir via descendant sampling, this descendant information may only be used to answer queries directed at sampling initiation tables or their ancestors. For example, referring back to FIG. 2, an Information Reservoir user may be interested primarily in customers and may find order level information useful only if all orders for a given customer are included in the Information Reservoir. In such a situation, the CUSTOMER table should be identified as the single sampling initiation table in FIG. 2, resulting in the BILLING and ORDERS tables being descendant-sampled and the SALESDEPT table being ancestor-sampled.

7. Specifying the Information Reservoir Design.

According to various embodiments of the present invention, an Information Reservoir may be constructed utilizing probabilistic methodologies based upon a Poisson sampling approach. Several different rates of inclusion are formulated by the probabilistic sampling methodologies according to the various embodiments of the present invention. For clarity, each rate of inclusion will be introduced here and expanded upon in more detail below.

According to an embodiment of the present invention, sampling a data source is list-sequential (linear). Initially, each tuple of the data source is assigned a target rate of inclusion π^{T}. The target rate of inclusion π^{T} is typically a real number between 0 and 1 inclusively, and describes the desired minimal rate at which the tuple will be sampled into the Information Reservoir. The target rate of inclusion π^{T} does not need to be the same from tuple to tuple. Assigning different target rates of inclusion may be used for example, to provide either an over-bias or under-bias to ensure adequate representation of any desired subgroup of tuples. For example, if the Information Reservoir is to be used to support ad hoc aggregate queries, tuples in important subgroups with relatively few tuples in the population may optionally be biased by assigning a relatively large target rate of inclusion π^{T} value to those tuples to make it more likely that the subgroups are represented in the final sample.

According to an embodiment of the present invention, the goal of an assignment strategy for setting the target rates of inclusion is to create an Information Reservoir that minimizes error in the kind of queries and/or modeling that the database is intended to support. Accordingly, it is desirable in certain circumstances to not only assign initial target rates of inclusion, but to adapt the rates of inclusion to the anticipated workload of the Information Reservoir.

All tuples in a data source are preferably assigned a target rate of inclusion before sampling begins. For example, if the goal is to sample all tables at a rate of at least 1%, all tuples are assigned target inclusion probabilities of 0.01 and sampling begins as discussed more thoroughly herein. However, often there is prior knowledge about how the data source will be used. For example, it may be known that only parts of the source data will be of interest or that selected subpopulations with relatively few tuples will be of concern. If this is the case, non-uniform assignment of inclusion probabilities may be used to improve the performance of the Information Reservoir.

7.1. Adapting Target Rates of Inclusion to Anticipated Workload.

An Information Reservoir can, in theory, support queries that request aggregates (including counts) and ratios of aggregates on base tables and their joins. However, building a reservoir that can adequately respond to an arbitrary query from this set may prove difficult in certain circumstances. Through constructs like GROUP BY and WHERE, queries may require information from subsets that have relatively few records in the database. Such subsets may have few, if any, records in the reservoir, making estimates and error bounds computed using them unacceptable in a number of applications.

Biasing a sample toward tuples needed by queries mitigates the difficulty with selective queries. If the workload of an Information Reservoir can be anticipated, tailoring the sample to the workload may prove beneficial even if selectivity is not an issue. For example, in general, error bounds tighten as the number of tuples used to respond to a query grows. If knowledge concerning a workload can be anticipated, then a number of approaches may be exploited to leverage that knowledge to tailor an Information Reservoir to the workload by establishing appropriate target rates of inclusion.

Error levels in the approximate answers obtained from an Information Reservoir may be improved by adapting the target rate of inclusion assigned to tuples in the data source to better match to the expected workload. Expected workload constraints may include any number of aspects relating to the user's preferences, the environment of operation, or may relate to the nature of the data source itself. As an example, a user may have needs that require querying only a single table in a relational database. Within this table no further partitioning of tuples according to expected use is possible. As another example, an environment in which a user is working may impose a memory constraint on the Information Reservoir such that the Information Reservoir is limited to about n tuples. An optimal Information Reservoir for this user may be constructed according to the present invention by logically limiting the data source to be the table of concern and setting the target rate of inclusion of each tuple in the base table of concern to:

$$min ( 1 , \frac{n}{N} ) ,$$

where N is the size of the table.

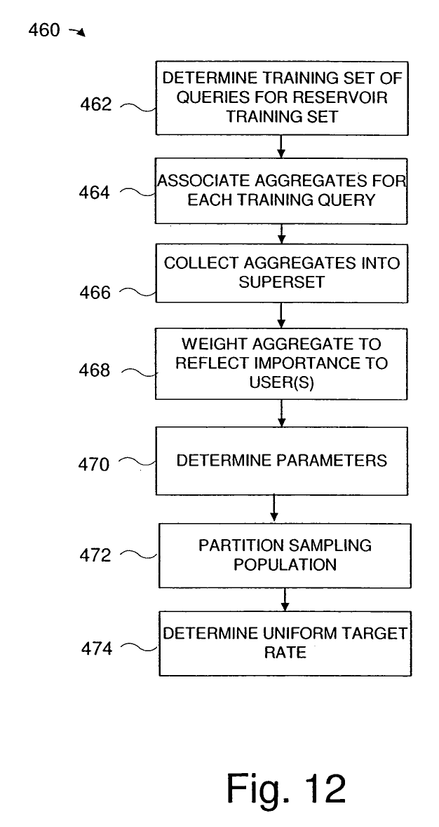

Referring to FIG. 12, another exemplary approach 460 to establish appropriate rates of inclusion if workload knowledge can be anticipated is to encode that knowledge in a fixed set of queries, Q={Q₁, . . . , Qₚ}. The fixed set of queries Q is determined at 462, and will be referred to herein as the reservoir training set. The reservoir training set can be composed of any type of query, including for example, simple queries with or without joins. It may be convenient, however, to limit the aggregates to sums (including counts) and means. If the aggregate is on a join, the variable aggregated should be a variable from the table at the base of the join.

The mix of subsets induced by the collection of WHERE and GROUP BY clauses in the fixed set of queries Q is preferably representative of those of interest to the reservoir user, with as little overlap as possible between queries. The variables aggregated and the types of aggregation called for should also reflect the interests of users. The training set can include queries that request a number of aggregates over the same set of tuples. The training set may include some but should not be the set of all future queries. To use the training set to derive sampling rates, the queries are preferably run against the database. If the training set is the workload, it would make more sense to compute exact answers rather than exploit the fixed set of queries Q to create a reservoir to compute inexact answers.

To each training query, Qᵢ, a set of aggregates, Aᵢ is associated at 464, the cardinality of which depends on the number of aggregates the query computes. For example, a GROUP BY query with k distinct grouping values may be associated with at least k aggregates, one for each group-by value. As indicated above, the training set can include queries that request a number of aggregates over the same set of tuples. For queries with more than one aggregate over the same tuple set, only one of the aggregates is chosen to be included in the query's aggregate set.

The set of aggregates Aᵢ is collected into a superset A at 466. Assume that the total number of aggregates in A is T. The Taggregates can be weighted at 468 to reflect their importance to users. Parameters which use the weights are established at 470. For example, the respective weights can be used to determine a tuning parameter at 470. In this approach, let the weight associated with aggregate j be denoted as wⱼ. Also, assume the weights sum to p, where p is a number between 0 and 1. The parameter p is a reservoir tuning parameter that allows the user to weight the general utility of the training set. If the training set is thought to capture most of the tuple selectivity of the expected workload, p should be set to a high value. If not, p should be set to a low value.

Each of the T aggregates has an associated sample estimate. We presume that the T aggregates are limited to sums and means. Given this limitation, variances associated with the Testimates will have one of two forms. For sum aggregates, the variance of estimates is given by:

$$\sum ( \frac{1 - {π}_{k}}{{π}_{k}} ) {y}_{k}^{2}$$

For mean aggregates, the variance of estimates is given by:

$$\sum ( \frac{1 - {π}_{k}}{{π}_{k}} ) {( \frac{{y}_{k} - \overline{y}}{N} )}^{2}$$

In both of the above variance of estimate formulas, y is the variable being aggregated and the sum is taken over tuples in the scope of the aggregate. For estimates of counts, the variance formula is that for the sum, with yₖ set to 1 for all k.

In the above equation of variance of estimates for mean aggregates, the parameters \overline{y} and N are population values. The parameter \overline{y} is the mean of the variable y over tuples in the scope of the aggregate and N is the cardinality of the tuple group.

The aggregates in the superset A partition the sampling population at 472 into two tuple groups, those tuples in the scope of the aggregates and those not in the scope. The later group excludes tuples assigned a zero target rate of inclusion because of category membership or variable range. Based upon the partitioning, target rates for each group can be determined at 474. Suppose the cardinality of tuples not in scope is M. Suppose the reservoir sample is to be about n tuples. Accordingly, n can be divided into two parts, n₁=p*n and n₂=(1−p)*n. Tuples out of the scope of the aggregates will be given a uniform target rate of n₂/M. Those within scope will be assigned rates as follows:

For tuples within the scope of aggregate j, rates are chosen that minimize the aggregate variance of estimates expressed above, subject to the constraint that:

Σ_{k ε Aggregate j} πₖ=wⱼ*nₗ

The rates that minimize the variance of the aggregate estimate subject to the above constraint are as follows:

If the aggregate is a sum, then tuple k should have target rate:

$${π}_{k} = \frac{{w}_{j} * {n}_{1} * \vert {y}_{k} \vert}{\sum \vert {y}_{k} \vert} .$$

If the aggregate is a mean, then tuple k should have target rate:

$${π}_{k} = \frac{{w}_{j} * {n}_{1} * \vert {y}_{k} - \overline{y} \vert}{\sum \vert {y}_{k} - \overline{y} \vert}$$

In the above rate formulas, the sum is taken over all tuples in the scope of the aggregate and \overline{y} is the average of the aggregate variable over this group. If a rate exceeds 1, it is set to 1.

Notably, the rate formula for tuples participating in sums has the property that tuples with variable values that are relatively large in magnitude are assigned larger target rates. The rate formula for tuples participating in mean calculations has the property that tuples with outlying variable values are assigned larger target rates. Tuples in the scope of more than one aggregate will be assigned more than one target rate. The actual target used for these tuples may be set to the mean or maximum or some other composite of the target rate possibilities. Although the training set is designed to minimize tuple overlap between queries, some overlap may still occur.

Overlap certainly exists for training queries requesting more than one aggregate of the same tuples. As previously described, in the case of queries requesting a number of aggregates over the same set of tuples, only one of the aggregates was included in the aggregate superset A. However, all related aggregates will be taken into account in the setting of tuple rates. For each remaining aggregate, the weight that was used for the aggregate actually selected into the superset A is used. Moreover, target rates are computed using the appropriate target rate formula. The actual target rate used for the tuples in the query scope will preferably be, as indicated above, a composite of the target rate possibilities.

7.2. Controlling the Size of an Information Reservoir.

The size of an Information Reservoir created via Poisson sampling typically cannot be exactly determined in advance. The Information Reservoir size is, in fact, a random variable. In practice, it may be useful to obtain a reservoir of at least a minimum size in order to satisfy accuracy requirements for the approximate answers produced or to assure that the reservoir does not exceed a certain size in order to stay within the resource constraints placed on the reservoir.

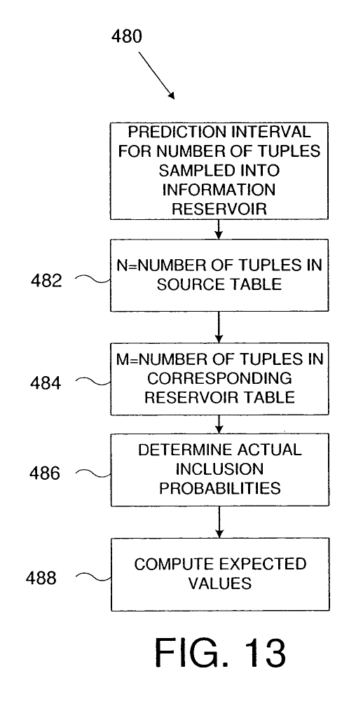

Referring to FIG. 13, a method 480 determines a prediction interval for the number of tuples selected from a single table into an Information Reservoir. Let N denote the number of tuples in the source table at 482 and M denote the number of tuples selected for the corresponding reservoir table at 484. Further let Πᵢ, i=1, . . . , N denote the actual inclusion probabilities of the tuples identified in the source table at 486. Then the expected values (number of tuples, variance and/or prediction interval) are computed at 488. For example, the expected value of M may be computed as

$$E ( M ) = {\sum }_{i ∈ T} {π}_{i} .$$

Under this approach, the variance of M is less than E(M). Thus a prediction interval for M is (E(M)−z(E(M))^{1/2}, E(M)−z(E(M))^{1/2}) where z is selected from a table of standard normal quantiles and determines the degree of confidence associated with the prediction interval. Other approximately-equivalent forms of this prediction interval may be used.

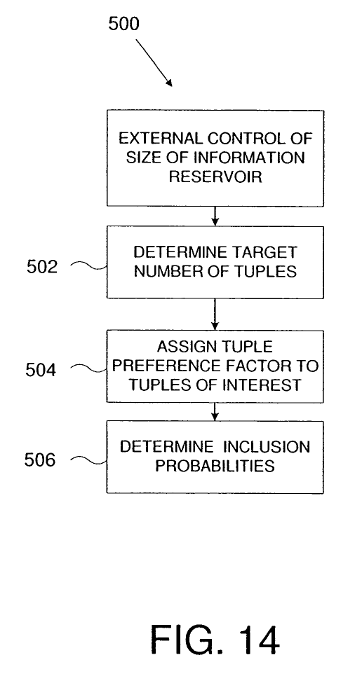

Referring to FIG. 14, a method 500 is provided for externally controlling the size of an Information Reservoir table. The target number of tuples is selected at 502 and a tuple preference factor is assigned at 504. Based upon the tuple preference factor, a rate of inclusion can be computed at 506. For example, through selection of the inclusion probabilities assigned to the tuples in the source table, specifically through selection of E(M), the expected number of tuples is selected. According to an embodiment of the present invention, given a target number of tuples m^{T}, a tuple preference factor, pᵢ, 0≦pᵢ≦N/m^{T}, i=1, . . . ,N is assigned to each tuple in the source table such that

$${\sum }_{i ∈ T} {p}_{i} = N .$$

In order to select on average a target number of tuples, m^{T}, from the source table, the inclusion probability for the ith tuple may be set to:

Πⱼ=(m^{T}/N)pᵢ, i=1, . . . ,N.

Other alternative equations may be used, such as:

Πᵢ=(m^{L}/N)pi and

Πᵢ=(m^{H}/N)pᵢ

where m^{L} is the solution to the equation m^{L}+z(m^{L})^{1/2}=m^{T} and m^{H} is the solution to the equation m^{H}−z(m^{H})^{1/2}=m^{T}. The use of m^{L} may be beneficial in certain applications to provide confidence that the number of tuples selected would not be more than m^{T}. Similarly, m^{H} may be used to provide confidence that the fraction selected would not be less than m^{T}.

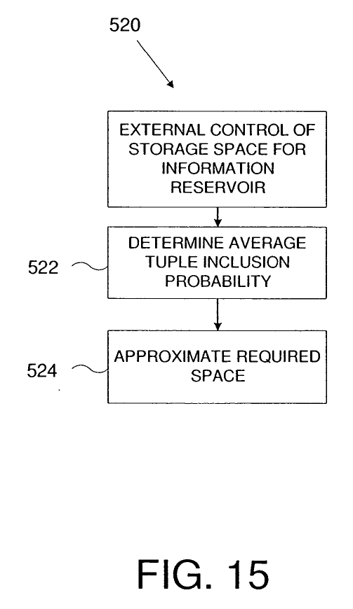

Referring to FIG. 15, a method 520 is provided to control the amount of storage space (S^{r}) required by an Information Reservoir table. The method 520 may be implemented for example, where the space required to store a tuple is independent of its tuple preference factor and the space required to store the source table can be expressed as:

S=S^{d}+S^{p}+Sⁿ

where S^{d} is the space required to store the actual data, S^{p} is the space required to store auxiliary structures whose sizes are proportional to S^{d} (e.g., unique indexes), and Sⁿ is the space required to store auxiliary structures whose sizes are not proportional to S^{d}, (e.g., non-unique indexes). For simplification, variable length tuples are ignored under the assumption that distribution of the tuple lengths in the sample will closely approximate the distribution of the tuple lengths in the original table. An average tuple inclusion probability, such as m/N, is given at 522. The space required for the reservoir table is then approximated at 524, for example by the equation:

S^{r}=(m/N)(S^{d}+S^{p})+Sⁿ.

For convenience, it is assumed that Sⁿ is independent of m. However, Sⁿ is likely to decrease with decreasing m, so S^{r} tends to overestimate the size of the reservoir table. Solving for m yields:

m^{T}=N(S^{r}−Sⁿ)/(S^{d}+S^{p}).

Thus, if the number of tuples selected is controlled at m^{T}, then the size of the reservoir table should be controlled at or below S^{r}.

Given the above methodologies for controlling the number of tuples selected from a source table and the storage space required for the reservoir table, it is straightforward to control the fraction of tuples selected from a source table or the fraction of storage space required by the reservoir table relative to the storage space required by the source table.

The expected size (number of tuples or storage space) of an Information Reservoir containing multiple tables is simply the sum of the expected sizes of the individual tables. Computing the expected size of a table requires knowing the expected average actual inclusion probability for the table. While this probability is simple to calculate for a reservoir containing a single table, it is much more complicated for a reservoir containing multiple related tables. This is because each actual inclusion probability is the larger of the target inclusion probability and the inclusion probability induced by descendant tuples. While target inclusion probabilities are known, induced inclusion probabilities are unknown and may be very dependent on the specific parent tuple to child tuple relationships present in the source database.

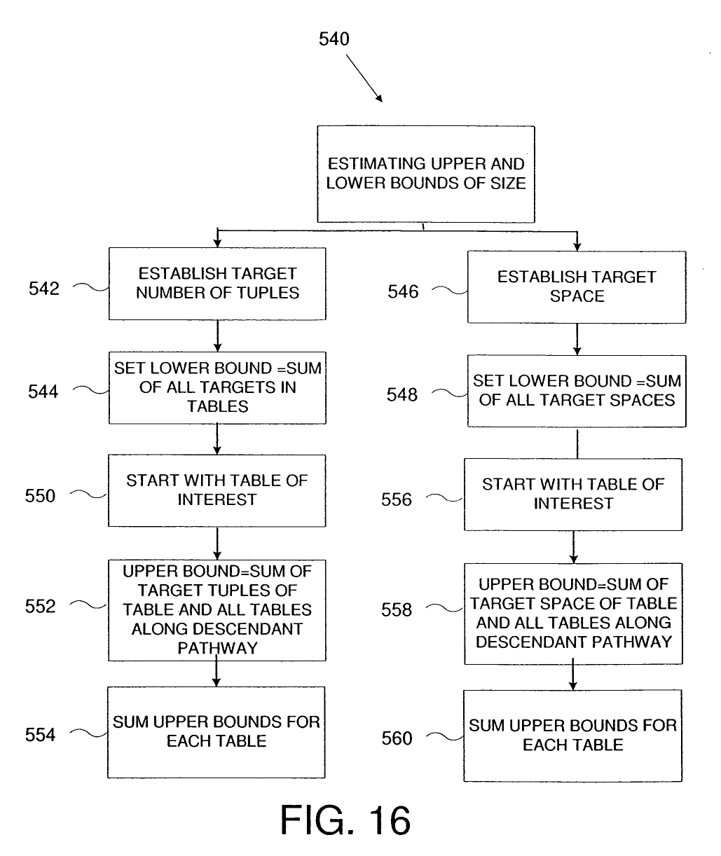

For example, referring to FIG. 16, a method 540 is provided to determine upper and lower bounds when estimating size (tuples or space) for an Information Reservoir with multiple tables. Let the “target number of tuples” of a reservoir table denote the expected number of tuples in the table assuming that the actual inclusion probabilities are equal to the target inclusion probabilities at 542. The sum of the target numbers of tuples for all the tables in a reservoir is set as a lower bound on the expected number of tuples in the reservoir at 544 since actual inclusion probabilities are always greater than or equal to target inclusion probabilities. Similarly, let the “target storage space” of a reservoir table denote the expected storage space for the table at 546 assuming that the actual inclusion probabilities are equal to the target inclusion probabilities. The sum of the target storage spaces for all the tables in a reservoir are set as a lower bound at 548 on the expected storage space for the reservoir.

To obtain an upper bound on the expected number of tuples in a reservoir table, the user can start with table of interest at 550 and sum the target numbers of tuples for that table and every table along any descendant pathway involving directly-sampled tables at 552. If a descendant table can be reached via more than one pathway, it contributes to the sum once for each of the pathways. Summing these upper bounds for each table in the reservoir produces an upper bound on the expected number of tuples in the entire reservoir at 554. It is straightforward to similarly construct an upper bound on the expected storage space for a reservoir given fixed and variable (per tuple) storage space requirements for each table. For example, the user can start with table of interest at 556 and sum the target space for that table and every table along any descendant pathway at 558. If a descendant table can be reached via more than one pathway, it contributes to the sum once for each of the pathways. Summing these upper bounds for each table in the reservoir produces an upper bound on the expected storage space requirements for the entire reservoir at 560.

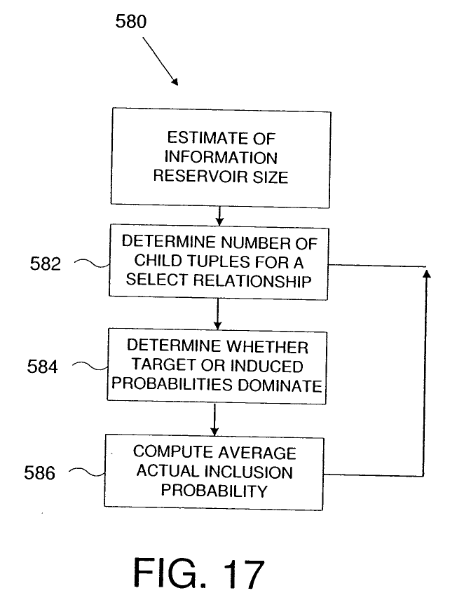

Since the bounds described above are valid no matter how the target inclusion probabilities are assigned, they may be very broad. In situations where inclusion probabilities are assigned in a somewhat uniform manner, it is possible to construct more useful estimates of reservoir size. For example, referring to FIG. 17, a method 580 is provided to estimate Information Reservoir size. Initially, a number of child tuples for a select relationship is determined at 582. For example, it is relatively easy to obtain frequency tables of the number of child tuples for a single relationship. This information is frequently maintained by database management systems along with other statistics about data distributions. If not, then the index on the foreign key can be read to obtain this information without reading the table data itself. A determination is made at 584 whether the target or induced inclusion probabilities will dominate for each entry in the frequency table. The induced inclusion probability for the set of parent tuples having c children with actual inclusion probability Π^{a} is 1−(1−Π^{a})^{c}. The average actual inclusion probability of the parent table can be calculated at 586. For example, the average actual inclusion probability may be calculated as the weighted average of the average inclusion probability of each subset of parent tuples having the same number of child tuples. This procedure can be applied recursively to obtain a reasonably accurate estimate of expected reservoir size.

7.3. Assigning Target Rates of Inclusion to Obtain an Answer of Specified Precision.

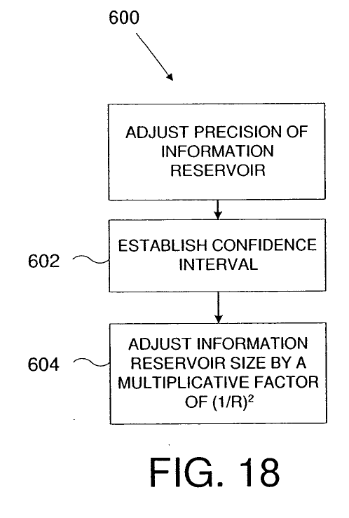

Suppose a user obtains an approximate answer from an Information Reservoir that is not large enough to provide the desired level of precision and would like to determine a single multiplicative factor, f, to apply to all target inclusion probabilities such that a new reservoir would provide the desired level of precision. Referring to FIG. 18 a method 600 is provided to adjust the precision of an Information Reservoir. Specifically, the confidence interval associated with the approximate answer from the initial reservoir is established at 602. The confidence interval has length Δ, however, the user desires a confidence interval of length r*Δ where r is between 0 and 1. To achieve the desired precision level, the Information Reservoir size is adjusted relative to the initial reservoir by the multiplicative factor f=(1/r)² at 604. The factor is based on the rule of thumb that error in approximate answers is inversely proportional to the square root of the number of tuples in the sample that are available for estimate computation.

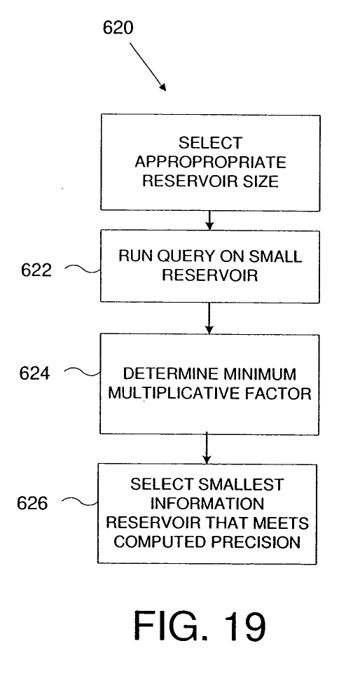

This technique may also be used to select the appropriate reservoir against which to run a particular query from within a collection of reservoirs of varying sizes. Referring to FIG. 19, the method 620, according to an embodiment of the present invention, is flowcharted. A query is first run against a small reservoir at 622. A required minimum multiplicative factor is then computed at 624. For example, the minimum multiplicative factor may be determined as described in the preceding paragraph. Next, the smallest Information Reservoir meeting the requirement for the desired precision is used to answer the query at 626.

7.4. A Method To Deal With Highly Influential Data Points.

A sample of a highly skewed variable may not contain the extreme values of the variable. As a result, estimates of aggregates of the variable may have poor precision. Also, very large sample sizes may be required before standard distributional assumptions apply to such estimates. For small sample sizes, error bounds may be wrong as their confidence level may be significantly inflated.

The flexibility of the Information Reservoir construction process allows any inclusion probability between 0 and 1 inclusively to be used on a tuple-by-tuple basis. Therefore, inclusion probabilities of 1 can be employed to ensure the selection of extreme values into the reservoir. The aggregate and variance estimators associated with the reservoir apply to all sampled tuples, even those sampled with certainty. To understand the implications of allowing a sampling rate of 1, consider sample size. With Poisson sampling, expected sample size is given by the sum of the sampling rates, where the sum is taken over the entire population. For simplicity, assume that the database is a single table with N tuples and reservoir size is limited to about n<N tuples. To achieve a sample size of approximately n, a target rate of n/N could be assigned to each tuple. If some tuples are singled out for rates of inclusion of one, the rates of inclusion of others must be set less than n/N in order to maintain the objective of a sample size of about n.

When a rate of one is allowed, the reservoir builder is implicitly adding to all possible samples of the reservoir a fixed set of tuples, i.e., those with rates of inclusion of 1. When used in aggregate estimates, tuples sampled with certainty add no variability to the estimates. However, additional variability may be introduced via the contribution of other tuples, since they must be sampled at relatively lower rates in order to maintain a bound on sample size. When a variable of interest has a small number of highly influential data values, the trade-off can result in significantly shorter confidence intervals for key query answers, provided that removal of the highly influential values from source table results in a significant reduction in the population variance of the variable of interest.

7.5. Assigning Target Rates of Inclusion by Subpopulation.

If the workload includes requests for aggregates of subpopulations (as in the GROUP BY operation), rates of inclusion can be adjusted to make it more likely that all subpopulations of concern are sufficiently represented in the Information Reservoir. For example, suppose a base or join table will be subjected to queries that require the computation of aggregates within each of G subpopulations. These subpopulations may be the result of one grouping attribute or the cross product of a number of grouping attributes. Suppose further that the table can contribute only about n tuples to the Information Reservoir, where G divides n. If it is desired that each subgroup be represented in the Information Reservoir in about the same proportion that it is represented in the data source, then rates of inclusion are set to

$$( \frac{n}{N} ) ,$$

where N is the size of the table.

However, if there is concern that with this strategy some subgroups may not be represented in the Information Reservoir in sufficient numbers, other assignment decisions can be made. For example, to gather about the same number of representations in each subgroup, rates of inclusion for tuples in each group g can be set to:

$$min ( 1 , \frac{( \frac{n}{G} )}{{N}_{g}} )$$

where N_{g} is the size of subpopulation g.

Sampling from subgroups of a population is called stratified sampling. One common reason for stratification is to sample from groups that are more homogeneous than the population. If this is achieved, more efficient estimation of population parameters is also achievable. Given the potential gain in estimation efficiency when sampling from more homogeneous subpopulations, it may be desirable to first cluster the population using the real-valued attributes that are of workload interest and then use the clusters as strata to build an Information Reservoir.

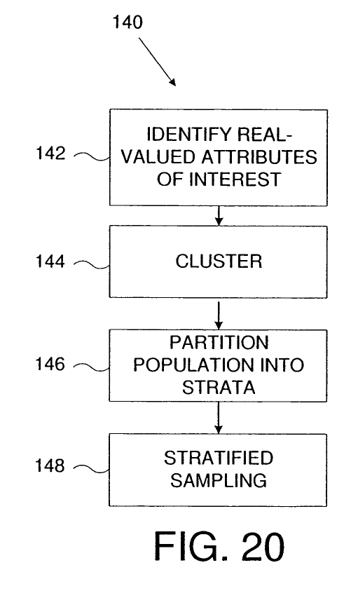

Referring to FIG. 20, a method 140 of constructing an Information Reservoir using clustering and stratified sampling techniques according to an embodiment of the present invention is provided. Initially, real-valued attributes of interest are identified at step 142. The data source is clustered using the identified real-valued attributes at step 144. The population is partitioned into subpopulations (strata) at step 146. Desired target inclusion rates are assigned to strata members and an Information Reservoir is built at step 148.

7.6. Assigning Target Rates of Inclusion to Mimic Stratified Sampling.

In the special case where group counts are known and one table is being sampled (or, more generally, the schema is such that the induced probability does not alter the target probability assignments), a sampling methodology may be provided that mimics stratified sampling. Note that the above case is a limitation of stratified sampling methodologies. Further, the methods herein are provided to show how an Information Reservoir can provide results comparable to stratified sampling in the situations where stratified sampling applies.

Assume that N and the N_{g} are known and that stratified sampling methods sample ng elements from group g. Assign the rate of inclusion π_{g}=n_{g}/N_{g} to each tuple in the group g. These rates of inclusion are the same probabilities of inclusion that would be used in stratified sampling of a table. The result is similar to stratified sampling, but since the Poisson sampling methodology herein is used, the number of observations per group is a random variable. The observed number of elements per group will be denoted as n_{g}^{o}. The estimator of the population mean

$$\hat{\overline{y}} = \frac{1}{N} {\sum }_{i ∈ S} \frac{{y}_{i}}{{π}_{i}}$$

can be algebraically rearranged to “mimic” the form of the stratified mean estimate:

$${y}^{\hat{\_}} = {\sum }_{g ∈ G} \frac{{N}_{g}}{N} ( \frac{1}{{n}_{g}} {\sum }_{i ∈ {S}_{g}} {y}_{i} ) .$$

The denominator used in the group mean is the target sample size n_{g}, not the observed sample size n_{g}^{o}, thus the rearranged estimator population mean has a form nearly identical to, but different from, the stratified sampling mean. For example, this estimator will have a larger variance than the variance of the stratified mean due to the variance in the sample size though much of the variance reduction expected by using stratified methods will be observed. Further reduction of variance is possible if the inclusion probabilities are altered after the sampling process.

If the inclusion probabilities are conditioned on the observed sample size, i.e.

$${π}_{i}^{cond} = \frac{{n}_{g}^{o}}{{n}_{g}} {π}_{i}$$

where n_{g}^{o} is the observed group sample size and n_{g} is the target sample size, then:

$${y}^{\hat{\_}} = {\sum }_{g ∈ G} \frac{{N}_{g}}{N} ( \frac{1}{{n}_{g}^{o}} {\sum }_{i ∈ {S}_{g}} {y}_{i} ) .$$

The calculations involved in this formula are exactly those of the stratified estimator. Again, variation in sampling size will cause this estimator to have slightly larger variance than observed in true stratified sampling, but for practical purposes the variances are essentially comparable.

8. Calculating Induced, Residual and Actual Rates of Inclusion.

For each tuple in a sampling initiation table, the induced rate of inclusion is equal to zero, the residual rate of inclusion is equal to the target rate of inclusion, and the actual rate of inclusion is equal to the target rate of inclusion. For each tuple in an ancestor-sampled table, the induced, residual and actual rates of inclusion are calculated as follows.

8.1. Calculating Induced Rates of Inclusion.

The induced rate of inclusion π^{l} is the rate of sampling of a parent tuple attributed to the sampling of descendant tuples. The induced rate of inclusion is also referred to as the induced probability of inclusion, induced inclusion probability, induced inclusion rate, prior rate of inclusion, prior probability of inclusion, prior inclusion probability and prior inclusion rate.

The induced rate of inclusion π^{l} for a tuple represents a rate of inclusion induced by that tuple's descendants. A tuple has an induced rate of inclusion π^{l}=0 if the tuple has no descendant tuples in a directly-sampled table. The induced rate of inclusion π^{l} of a tuple t is determined by the actual rates of inclusion of that tuple's children.

To compute induced rates of inclusion, first consider the simple case of a parent table v with only one child table u. Suppose a parent tuple in table v has m children in the child table u and the actual sampling rates of the m children are given by πᵢ, i=1, . . . ,m, respectively. The sampling rate induced on parent tuple v by the m descendant tuples from child table u is given by 1−(1−π₁)* . . . *(1−πₘ).

For the general case of a parent table v with p child tables, the collection of all the children of a given parent tuple in table v is partitioned into p groups according to which table the child tuple belongs. If the actual rates of inclusion of the children that belong to table uₖ are πₗ^{k}, . . . , πₙ_{ₖ}^{k}, then the inclusion rate of the parent tuple induced by the children of table k is given by:

{double overscore (π)}ₖ=1−(1−πₗ^{k}) . . . (1−πₙ_{ₖ}^{k}).

If a parent tuple has no children in table k then {double overscore (π)}ₖ=0. The parent's overall induced inclusion rate from all children is given by:

1−(1−{double overscore (π)}ₗ) . . . (1−{double overscore (π)}ₚ).

8.1.1. Sibling Partitioning. Generally speaking, there may be situations in which a parent's children are, for some reason, partitioned into subgroups. In such cases it may be convenient to compute an overall induced rate of inclusion from component rates of inclusion induced by each subgroup. For example, suppose that a parent tuple t includes children tuples that are partitioned into p groups. Further, let a select one of the p groups, denoted group k, contain n total tuples. The induced rate of inclusion induced by group k is given by:

πₖ^{l}=1−(1−πₗ^{k}) . . . (1−πₙ_{ₖ}^{k}).

The overall induced rate of inclusion for the parent tuple t is given by:

π^{l}=1−(1−πₗ^{l}) . . . (1−πₚ^{l}).

8.1.2. Temporal Partitioning. In many database environments, the database is not static, with new tuples arriving over time. In such an environment, sibling tuples may be partitioned by their arrival time. Suppose that at time τ a parent tuple's induced rate of inclusion is πₜ^{l} and at time τ+1, m new children tuples arrive into the database with actual rates on inclusion of π₁, . . . , πₘ. The component of the parent tuple's rate of inclusion π^{l} induced by the m new children tuples is expressed by:

π_{τ+l}^{new}=1−(1−π₁) . . . (1−πₘ).

The overall induced rate of inclusion of the parent tuple at time τ+1 is given by:

π_{τ+1}^{l}=1−(1−π_{τ}^{l})*(1−π_{τ+1}^{new}).

8.1.3. Spatial Partitioning. A database and/or the process of creating an Information Reservoir may be distributed over a number of computer devices. In such an environment, the processing of sibling tuples to create an Information Reservoir may be distributed across devices. Suppose sibling tuples are distributed across p devices. Suppose sibling subgroup k contains nₖ total tuples. Sibling subgroup k contributes an induced rate of inclusion given by πₖ^{l}=1−(1−πₗ^{k}) . . . (1−πₙ_{ₖ}^{k}). For example, each sibling subgroup result can be communicated to a central device. The central device can then compute a total induced rate of inclusion for the parent tuple according to the expression:

π^{l}=1−(1−πₗ^{l}) . . . (1−πₚ^{l}).

8.2. Calculating Residual Rates of Inclusion.

The residual rate of inclusion π^{R} is the rate at which a tuple is sampled when its table is sampled. The residual rate of inclusion may be expressed as max

$$max ( 0 , \frac{{π}^{T} - {π}^{I}}{1 - {π}^{I}} )$$

and is also referred to as the residual probability of inclusion, residual inclusion probability, residual inclusion rate, adjusted rate of inclusion, adjusted probability of inclusion, adjusted inclusion probability, and adjusted inclusion rate.

As an example, the computation for the residual rate of inclusion will be described in more detail for the case of a relational database containing two tables. For purposes of a simplified discussion, the case of a parent table P with only one incoming edge, i.e., only one child table C will be considered. Suppose that a tuple t in the parent table P has a target rate of inclusion π^{T} and is linked to m tuples in the child table C. Further, suppose that within the child table C, the actual rate of inclusion of each child tuple is given by πᵢ;i=1,2 . . . m for the m tuples. The rate of inclusion π^{l} of the tuple t in the parent table P induced by the m tuples of the child table C is then given by:

π^{l}=1−((1−π₁)*(1−π₂)* . . . *(1−πₘ)).

Given this prior chance of inclusion, the residual sampling rate of tuple t in the parent table P is given by:

$$max ( 0 ; \frac{{π}^{T} - {π}^{I}}{1 - {π}^{I}} ) .$$

Referring back to the directed acyclic graph shown in FIG. 7 and assuming that the ORDERS table is a sampling initiation table, when sampling the ORDERS table 28, there are no sampled descendants to any ORDERS tuples so each tuple is sampled at it's assigned target rate of inclusion. However, when sampling the CUSTOMER table 24, there is a prior probability that a given tuple has already entered the Information Reservoir. For example, tuple 50 of the CUSTOMER table 24 has two prior opportunities of entering the Information Reservoir even before sampling begins on the CUSTOMER table 24 because of the foreign key join to tuples 42 and 44 (records 1 and 4) of the ORDERS table 28. Likewise, tuples 52 and 54 of the CUSTOMERS table 24 each have one prior opportunity to enter the Information Reservoir due to tuples 46 and 48 of the ORDERS table 28 respectively. Tuple 64 of the SALESDEPT table 22 has seven prior opportunities to enter the Information Reservoir before sampling of the SALESDEPT table 22 begins due to tuples 42, 44, 46, 48, 50, 52 and 54 from the CUSTOMER and ORDERS tables 24, 28. As such, induced rates of inclusion are computed for each of the tuples in the CUSTOMER table 24 before sampling of the CUSTOMER table 24 begins and each tuple in the CUSTOMER table 24 will be sampled at the residual rate of inclusion max

$$max ( 0 ; \frac{{π}^{T} - {π}^{I}}{1 - {π}^{I}} ) .$$

8.3. Calculating Actual Rates of Inclusion.

The actual rate of inclusion π^{A} is the maximum of a tuple's target rate of inclusion π^{T} and the induced rate of inclusion π^{l} induced by that tuple's descendants. The actual rate of inclusion may be expressed as π^{A}=max(π^{T}, π^{l}) and is also referred to as the actual probability of inclusion, actual inclusion probability, and actual inclusion rate.

The actual rate of inclusion π^{A} computed for each tuple is optionally retained as an attribute in the Information Reservoir. The inverse of the actual inclusion rate may also be stored as an attribute with an associated tuple in the Information Reservoir. Alternatively, the inverse of the actual rate of inclusion may be computed from the actual rate of inclusion if such value is stored with the Information Reservoir. The inverse of the actual rate of inclusion may be used for example, to weight the contribution of the corresponding tuple in estimates of table-level aggregates. As such, the inverse of the actual rate of inclusion is also referred to herein as the tuple weight.

9. Populating the Information Reservoir Shell Via Direct Sampling.

Both a general sampling methodology and special sampling methodologies for equal rates of inclusion are presented here.

9.1. Direct Sampling in the General Case.

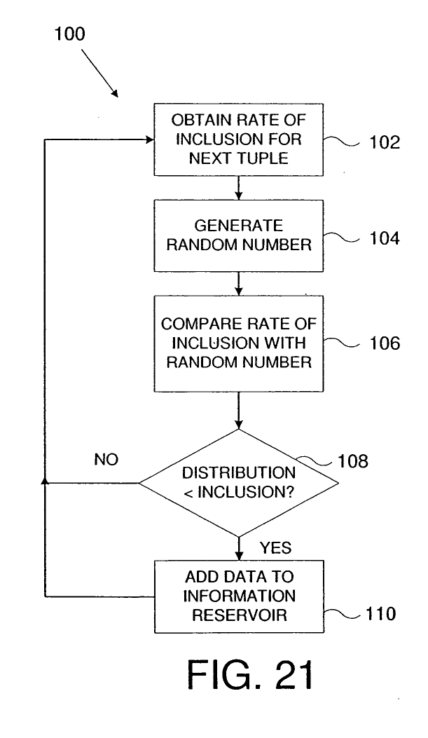

A tuple from a data source is integrated into an Information Reservoir if an independent draw from a probability distribution, most commonly a standard uniform distribution, is less than that tuple's rate of inclusion. For example, referring to FIG. 21, a method 100 for selecting samples into an Information Reservoir is illustrated according to an embodiment of the present invention. Prior to the start of method 100, a residual rate of inclusion is determined for each of the tuples of interest from the data source. Each tuple k of the data source is then considered in turn. At step 102 the residual rate of inclusion is obtained for a tuple k. At step 104, a (pseudo) random number is generated, where the random number is generally expected to be in the range of possible inclusion probabilities.

The generated random number is compared to the residual rate of inclusion of tuple k at step 106, and a decision whether to select tuple k into the Information Reservoir occurs at step 108. The tuple k (or a subset thereof) is added to the Information Reservoir at step 110 if the generated pseudo-random number is less than the residual rate of inclusion for tuple k. Also, additional data may be added to the Information Reservoir at step 110. The exact nature of the additional data will depend upon the data source, but may include for example, attributes added to one or more table schemas, information related to relationships and constraints in the data, descriptions of the relations (tables), relationships among the tables, or the association of concise representations. For example, attributes can be added to table schemas to hold rates of inclusion, pre-computed aggregates or other useful information; concise representations such as multi-dimensional histograms may be associated with the Information Reservoir.

After deciding whether or not to include the tuple k into the Information Reservoir, the next available tuple is considered. Accordingly, within a table, the chance that a tuple j gets into the Information Reservoir is independent of the chance that tuple k gets into the Information Reservoir for each distinct pair of tuples j and k. Also, there is no constraint on the minimum (or maximum) number of samples that enter the Information Reservoir. Accordingly, sample size is not fixed allowing the Information Reservoir to be scalable. This scalable nature allows for example, an Information Reservoir to be orders of magnitude smaller in size than the sources of data from which the Information Reservoir was constructed.

9.2. Special Methods for Equal Rates of Inclusion.

Special methods are presented for both the case of equal target rates of inclusion across a collection of tables and equal residual rates of inclusion within a single table.

9.2.1. Sampling a Collection of Tables with Equal Target Inclusion Probabilities. If all tuples in a collection of tables to be sampled have been assigned the same target inclusion probability, Π, one may exclude from direct sampling all tuples that have descendant tuples in a directly-sampled table within the collection. This is because any such tuple is guaranteed to have an induced sampling rate greater than or equal to the target inclusion probability Π.

9.2.2. Sampling a Single Table with Equal Residual Inclusion Probabilities. If all tuples in a source table have been assigned the same residual inclusion probability, Π, it is possible to significantly increase the efficiency of the tuple sampling process by basing the sampling process on the number of non-sampled tuples, M, between consecutively sampled tuples. The distribution of M is given by:

Prob(M=m)^{=(1-π)}^{^{m}}^{*π}, for m=1, 2, . . .

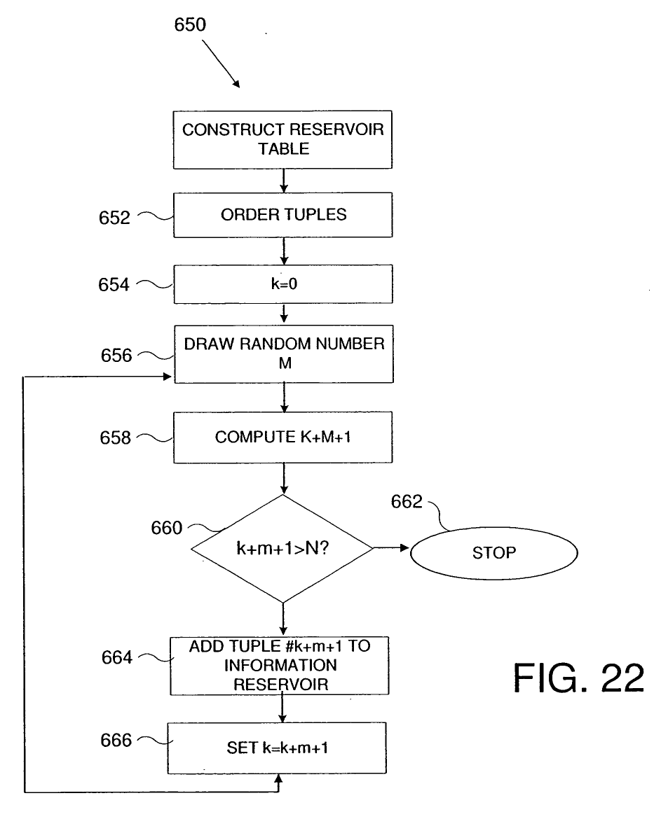

Based on this distribution, a reservoir table can be constructed from a source table with N tuples. For example, referring to FIG. 22, a method 650 for constructing a reservoir table is illustrated. Tuples are ordered in the source table at 652. For example, the tuples may be numbered sequentially, beginning at one. Let the variable k represent the last tuple sampled and set k equal to zero at 654. A random number is then generated from the distribution Prob(M=m)^{=(1-π)}^{^{m}}^{*π}, for m=1, 2, at 656. Next, the equation k+m+1 is computed at block 658. A decision block 660 compares k+m+1 to the table (N). If k+m+1 is greater than N, then the method stops at 662, otherwise, tuple number k+m+1 is placed into the Information Reservoir at 664. The value of k is updated to equal k+m+1 at 666, and the process loops back to generate a new random number (m) at 656.

9.2.3. Exploiting Uniform Target Rates of Inclusion for the Initial Build. The user may settle for a quickly built reservoir with the expectation that, over time, the reservoir will be shaped into a reservoir that more adequately supports that user's information needs. This user could begin with a reservoir constructed with a uniform target rate of inclusion, with construction exploiting the efficiencies described above. The reservoir could be modified over time to be more responsive to the user's information needs by joining reservoirs built using customized target rates; or simply waiting for a more useful reservoir to evolve through ongoing maintenance operations.

10. Methods for Creating Information Reservoirs from Distributed/Virtual Data Sources.

10.1. Building Information Reservoirs from Distributed Databases.

An Information Reservoir may be built from a distributed data source using at least two methods, naive and intelligent. The naive method relies upon a distributed database management system to handle the location of data transparently. In other words, the Information Reservoir builder treats the distributed data source as if it was not distributed and allows the database system to handle the details of data transfer. The naive method may be inefficient in certain environments because a large amount of data will need to be transferred between nodes of the distributed system.

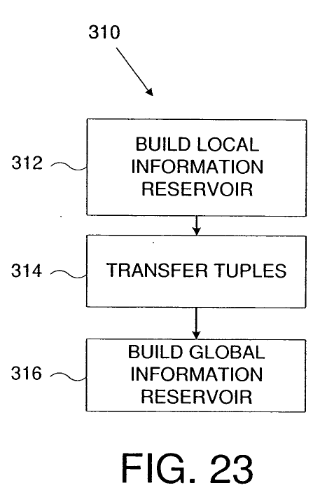

The intelligent method takes advantage of the fact that the union of two Information Reservoirs is itself an Information Reservoir. The Information Reservoir builder can use knowledge of the location of various parts of the distributed database to minimize transfer of data among nodes. For example, referring to FIG. 23, a method 310 of building an Information Reservoir from a distributed data source is illustrated. A local Information Reservoir is built upon each node in the distributed system at step 312. Tuples from each local Information Reservoir including their respective inclusion rates are transferred to a common location at step 314 and the local Information Reservoirs are merged into a global Information Reservoir at step 316 for example, using the closed union operation of Information Reservoirs. Using this method, only the actual rates of inclusion and sampled data need to be transferred between nodes, resulting in reduced build time.

An Information Reservoir built from a distributed database need not be reassembled into a database residing on a single node. Just like any other database, the Information Reservoir may be distributed over multiple nodes managed for example, by a distributed database system.

10.2. Building an Information Reservoir for a Virtual Database Comprised of Multiple Sources Too Complex or Large to Actually Combine.

It is technically difficult and expensive to combine massive amounts of data into a centralized database. For example, data collection may occur at numerous sites and centralization of that data may require transmission of impractical volumes of data. Further, duplicated data greatly increases hardware requirements. If data is continually collected over time, the integration of new data into a very large relational database is computationally intensive and can occur more slowly than the arrival rate of additional new data. Further, simply creating and maintaining very large databases requires specialized hardware and substantial technical expertise.

It is possible under certain circumstances to construct an Information Reservoir of a relational database that does not physically exist as a centralized entity. In certain applications, this element may be particularly significant as it can partially address or potentially eliminate the need for data warehousing. In particular such an Information Reservoir allows the user to run queries against a database that has never been built. In these situations, the technical and hardware issues associated with building a massive centralized data store are avoided.

For example, suppose that the relational database can be divided into natural partitions or pieces that have no records in common. Specifically, no parent record has child records in two different pieces at any level of the database schema. One natural partition is a database split according to independent data sources, perhaps data sources with different geographical locations or data collected in different time periods. Information Reservoirs can be created from each of these data sources and combined to form an Information Reservoir of the complete relational database. The small size of the individual reservoirs reduces problems associated with transmission and insertion of records.

Another example is a relational database that does not partition naturally (that is, parent records have child records in multiple partition elements using natural splitting approaches), but has one table in its schema that is very large relative to the other tables. In this case, the large table can be partitioned in a natural way and stored in a distributed manner, while the other small tables are centrally maintained. For instance a customer table may be centrally maintained, while a transaction table may be split among the many stores where the transactions took place. When constructing the Information Reservoir, any centrally stored small tables are sampled in the central location. Necessary information concerning the sampling is passed to the distributed tables. The distributed tables are sampled in parallel. These samples are passed to the central location and the construction continues using sibling partitioning methodology to assign inclusion probabilities. There are many variants of these two examples that are possible due to the strength of the sampling methodology disclosed herein.

11. Methods for Performing Operations on Information Reservoirs.

According to at least one embodiment of the present invention, an Information Reservoir is constructed in such a manner so as to preserve at least part of the schema and join relationships of the original data source. Accordingly, an Information Reservoir can itself be sampled to produce a new Information Reservoir that is a scaled down version of the sampled Information Reservoir. Also, set operators such as union and intersection can be performed on related Information Reservoirs to construct new Information Reservoirs.

11.1. Intersection of Information Reservoirs.

The intersection of two Information Reservoirs is defined herein in the obvious way. For each table in the original data source, the samples of that table in two corresponding Information Reservoirs are intersected. For a given data source, a tuple's rate of inclusion after an intersection operation is given by:

π=π₁π₂

where π₁ is the tuple's rate of inclusion in the first Information Reservoir and π₂ is the tuple's rate of inclusion in the second Information Reservoir.

11.2. Union of Information Reservoirs.

The union of two Information Reservoirs is also defined herein in the obvious way. The union operation can be viewed as joining to an initial Information Reservoir, a sample of those tuples not chosen in the first sampling. A tuple's rate of inclusion after a union operation is given by:

π=π₁+π₂−π₁×π₂

where again π₁ is the tuple's rate of inclusion in the first Information Reservoir and π₂ is the tuple's rate of inclusion in the second Information Reservoir.

In an Information Reservoir, a sample of a table ν is the union of two Poisson samples of table ν: the Poisson sample induced by descendants and the residual Poisson sample.

11.3. Subsampling an Information Reservoir.

Sampling an Information Reservoir (also referred to herein as subsampling) results in an Information Reservoir of the original data source that is smaller than the original Information Reservoir. This staged sampling can be exploited, for example, to create an Information Reservoir of more desirable size from a larger Information Reservoir or to resize an Information Reservoir that has grown to exceed a size constraint. At a table level, subsampling can be thought of as intersecting two samples of the table and the resultant rates of inclusion follow from the intersection formulas herein.

12. Methods for Incremental Maintenance of Information Reservoirs.

Once an Information Reservoir has been constructed, the original data source may change over time as inserts, updates, and deletions are processed. It is possible to incrementally maintain an Information Reservoir created via probabilistic sampling as updates to the data source occur. In the absence of incremental maintenance, the entire Information Reservoir may be periodically rebuilt.

Any number of systems and methods may be used to trigger incremental maintenance of the Information Reservoir. For example, the native relational database management system of the source data may be used to incrementally update the Information Reservoir. Triggers or rules may also be placed upon the data source to provide notification of inserts, updates, and deletes allowing incremental maintenance of the Information Reservoir. The Information Reservoir may also be updated by monitoring the transaction log of the data source for inserts, updates, and deletes. On database systems that support replication, the Information Reservoir could be set up as a read-only replicated copy of the original database with the incremental maintenance algorithm applied to the changes received from the updatable copies of the database. The incremental maintenance may occur asynchronously with the original transaction in order to maintain throughput, or synchronously with the original transaction if the consistency of the Information Reservoir is important.

The algorithm detailed herein for incremental maintenance uses buffer tables that mirror the Information Reservoir and database. The buffers hold added tuples and their ancestors and are sampled using any of the methodologies for sampling the data source discussed herein.

12.1. Incremental Maintenance of Information Reservoirs in the Presence of Database Insertions and Deletions.

An embodiment of the present invention allows for incremental maintenance of an Information Reservoir due to three types of events occurring to the data source: modification of a data record in a table, deletion of a record from a table, and insertion of a record into a table. Since the Information Reservoir mimics at least a part of the data source schema, if a record in a table is modified, the same record may be modified in the Information Reservoir if such a record exists. If a record in a table is deleted, the corresponding record in the Information Reservoir may be deleted if such record exists.

Given a set of tuples, the term “set closure” or “closure” is used herein to refer to the union of the set and all of the ancestor tuples associated with tuples in the set from directly-sampled tables and descendant tuples associated with tuples in the set from sampling initiation tables. The closure of an Information Reservoir is the Information Reservoir.

When tuples are added to directly-sampled tables of a data source, the Information Reservoir is updated by taking the closure of the set of new tuples, sampling the closure, and taking the union of the sampled closure and the existing reservoir. In the new reservoir, a tuple's rate of inclusion after the union operation is given by π=π₁+π₂−π₁×π₂ where π₁ is the tuple's rate of inclusion in the closure sample and π₂ is the tuple's rate of inclusion in the original reservoir. The stored actual inclusion rates are also preferably updated to reflect the new sampling rates.

When tuples that are descendants of existing ancestor tuples in the data source are added to descendant-sampled tables of a data source, the new tuples are added to the Information Reservoir if and only if the corresponding ancestor tuple in a sampling initiation table is already included in the Information Reservoir.

12.2. Incremental Maintenance Algorithm.

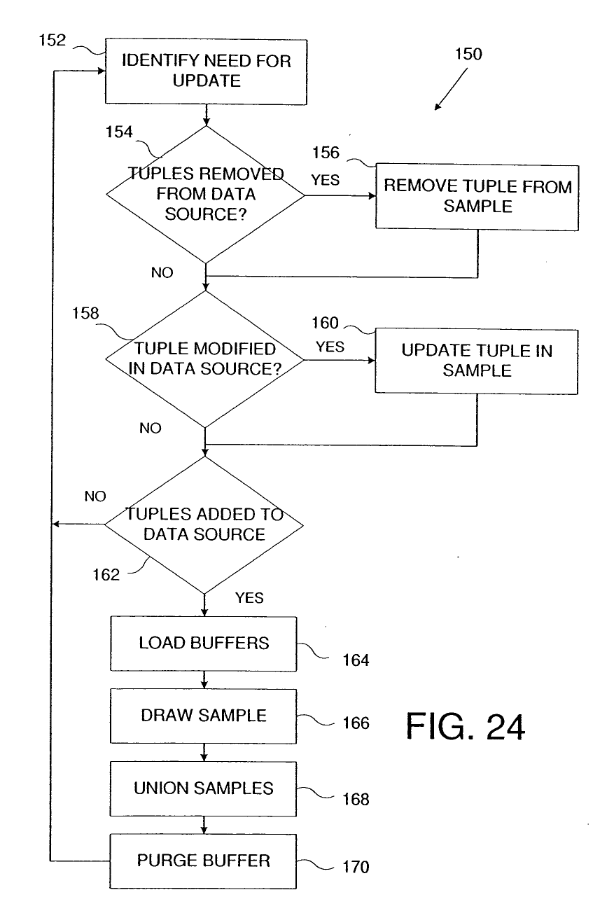

Referring to FIG. 24, a method 150 for performing maintenance on an Information Reservoir is illustrated. This method presumes the existence of a set of buffer tables that mirror the Information Reservoir schema and/or the data source schema. Initially, the changes to the data source are identified at step 152. Such changes may be identified in the form of replication logs from the database or similar sources of such information. For example, logs may be created of new tuples added, tuples modified, and old tuples removed from the data source.

A decision is then made as to whether or not to modify the Information Reservoir. Steps 154, 158, and 162 determine whether or not tuples have been added, deleted, or modified respectively. If it is decided at step 154 that tuples have been removed from the data source, then corresponding tuples are removed from the Information Reservoir at step 156 if such tuples exist in the Information Reservoir. If it is decided that tuples have been modified at step 158, then those tuples are also updated in the Information Reservoir at step 160 if such tuples exist in the Information Reservoir.

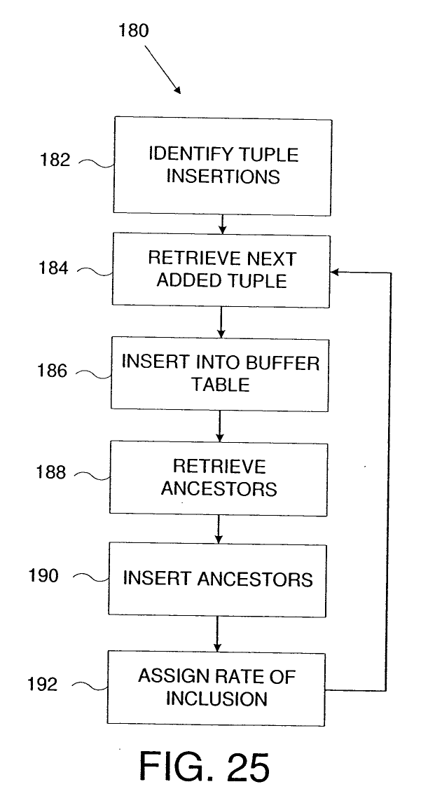

If it is decided that tuples have been added to directly-sampled tables of the data source at step 162 then buffers are loaded at step 164. For example, referring to FIG. 25, a method 180 of loading the buffer tables is illustrated. Initially, tuple insertions are identified at step 182. For example, a log of tuple insertions is scanned sequentially starting from the first insertion. The next added tuple is retrieved at step 184, and the tuple is inserted into the appropriate buffer table at step 186. Using typical log files, tuples are inserted into the population from parent tables to children tables, thus any newly inserted (i.e., recorded in the log) ancestor tuple may already exist in the buffer database. However, if the current tuple is missing one or more ancestors in the buffer database, then the appropriate ancestor tuples are retrieved at step 188 and inserted into the appropriate tables of the buffer database at step 190.

At step 192, the current tuple is assigned a target rate of inclusion. For example, the current tuple may be assigned a target rate of inclusion according to a predetermined sampling policy. However, ancestor tuples retrieved from the population database should have target inclusion probabilities set to 0, and ancestor tuples already in the buffer database should be left alone. Steps 184, 186, 188, 190, and 192 are repeated for each tuple added to the data source.

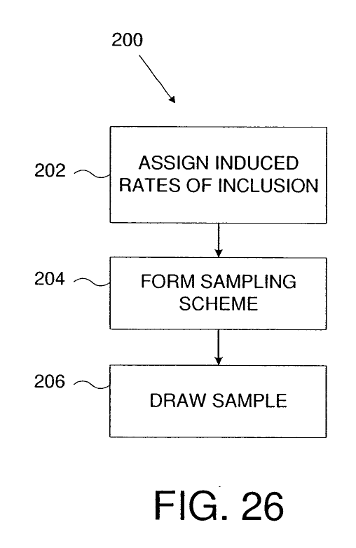

Referring back to FIG. 24, after the buffers are loaded at step 164, a sample is drawn. For example, referring to FIG. 26, one method 200 of drawing samples is illustrated. Induced rates of inclusion are assigned within the buffers at step 202 if such assignments have not already been carried out. This assigns the rates of inclusion, also referred to herein as π-values, for the actual sampling scheme. At step 204, a sampling scheme of the population is formed by setting the rates of inclusion to zero for all the tuples except for those within the buffers. At step 206, a sample is drawn from the population according to the sampling scheme.

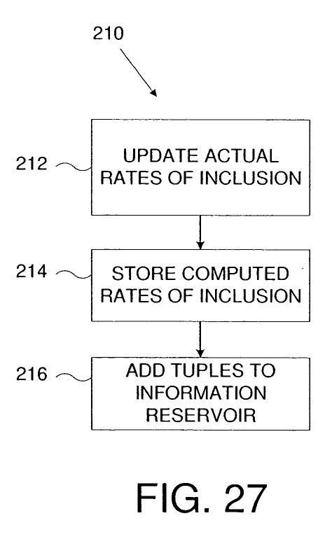

Referring back to FIG. 24, after a sample is drawn, the drawn samples are combined with the Information Reservoir at step 168. For example, referring to FIG. 27, one method 210 for adding samples is illustrated. Initially at step 212, the actual rates of inclusion (actual π-weights) of the tuples in the sample are updated. For each tuple in the buffer, the actual rate of inclusion is determined by the union formula provided herein. For example, π₁ is the probability in the buffer database, π₂ is the probability in the population database. The newly computed rates of inclusion preferably replace the stored existing rates of inclusion in both the Information Reservoir and data source (population database) at step 214.

Note that conceptually this is done over all tuples in the population database with π₁=0 for any tuples not in the buffer database. In practice it suffices to consider only the tuples in the buffer database. Further note that as the rates of inclusion are needed for the tuples in the buffer database, there may be some efficiency in creating these attributes in the buffer database tables and populating them as the buffer is populated. While there may be efficiency gains in doing so, it is not necessary to practice this embodiment of the present invention. Sampled tuples are then added to the Information Reservoir at step 216. Referring back to FIG. 24, the buffer database is then purged at step 170.

There are however, several special cases that do not fit into the default scheme. If the rates of inclusion are assigned based on a previously determined bias, such as workload, appropriate revisions need to be made to the rate of inclusion for the new tuple. For example, the rate of inclusion may be assigned a constant default probability or a probability based on the anticipated workload or other consideration as set out more fully herein. The assignment of a constant default probability may be useful for example, where the source data comprises a data stream that has no source probabilities to compare against. Further, the rate of inclusion may be assigned a probability based on proximity to existing data or other relational characteristic such as the average of the rates of inclusion of the n nearest neighbors to the tuple. As a further example, the rate of inclusion may be assigned by maintaining an evolving group-by structure and using group inclusion probabilities that are periodically updated. Thus the Information Reservoir may initially be created using a constant rate of inclusion, but subsequent tuples may have rates of inclusion indicative of workload or other criterion.

If a relatively constant Information Reservoir size is required in view of the addition of tuples to the source data, then at some point, information must be removed from the Information Reservoir. In fixed sampling schemes, if one tuple is added to the Information Reservoir, a corresponding tuple must be removed from the Information Reservoir. However, in Poisson sampling inclusion is always a probabilistic process. Conversely when maintenance requires tuples be removed from an Information Reservoir, information must eventually be added to maintain the relatively constant Information Reservoir size desired. Further, as the sophistication of foreign key joins (inter-tuple inclusion dependence) increases, the complexity of the objects that need to be added or removed creates the need for a sophisticated algorithm to maintain size.

12.3. Algorithm for Maintaining Reservoir Size.

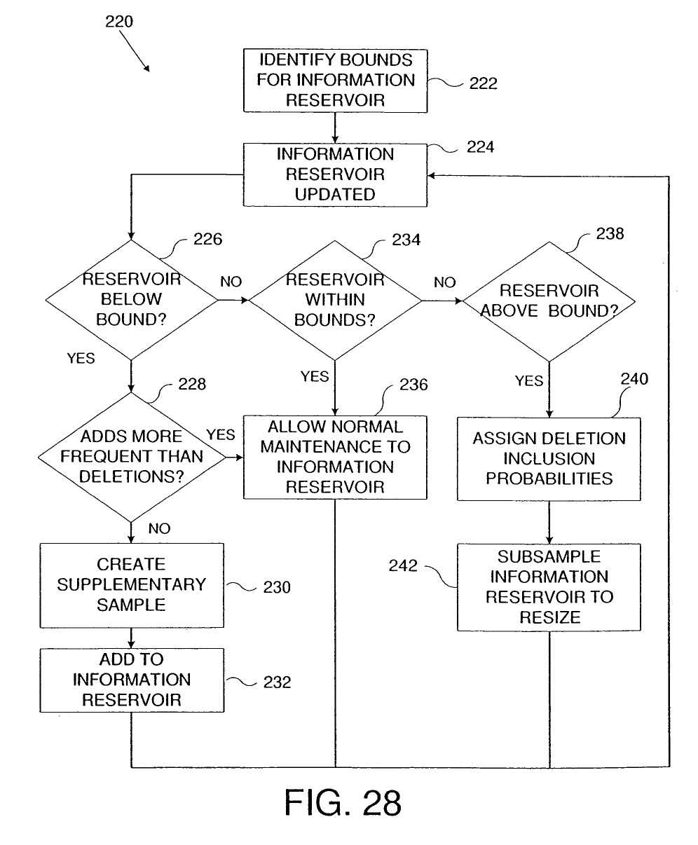

Referring to FIG. 28, a method 220 outlines an algorithm to maintain the size of an Information Reservoir. Bounds are set for the smallest and largest acceptable Information Reservoir in step 222. The Information Reservoir is updated at step 224, such as by using the method 150 discussed with reference to FIGS. 24-27. If the reservoir is detected at step 226 to be below the identified bounds, then a decision may be made as to whether there are additions to the data source that are sufficiently more frequent than deletions to the data source at optional step 228. Such a decision may be possible for example, where data are arriving rapidly enough to make such a determination.

If additions to the data source occur more frequently than deletions to the data source, it may be desirable to allow normal maintenance of the Information Reservoir to occur as described more fully herein. However, if deletions are more frequent to the data source, or if the optional step 228 is not executed, then a supplementary sample is created at step 230 and the supplementary sample is added to the Information Reservoir at step 232. For example, a small Poisson sample is taken from the data source and unioned with the Information Reservoir at steps 230 and 232.

If the Information Reservoir is determined to be within bounds at step 234, normal maintenance continues at step 236. If a determination is made that the Information Reservoir exceeds the upper bound at step 238 then “deletion inclusion probabilities” are set at step 240 so that the expected size of the Information Reservoir following subsampling at step 242 will be within bounds. Any number of target rate schemes may be used to implement Information Reservoir subsampling. Examples include assigning deletion rates of inclusion:

πᵢ^{del}=Desired Information Reservoir Size/Current Information Reservoir Size.

Another exemplary approach to setting target rates of inclusion is to assign probabilities to favor tuples in certain groups or workloads. Because of the nature of the Poisson sampling methodologies as set out herein, it is not possible to anticipate exactly how many tuples will be deleted from the Information Reservoir. Thus an Information Reservoir is created with a given target size, but due to chance variation of the Poisson sampling methodology, an Information Reservoir of a different observed size (smaller or larger) can be created.

It may be desirable to update the rates of inclusion to improve the performance of the Information Reservoir. For example, sometimes observations such as workload trends can identify biases that may be introduced into the Information Reservoir to improve query performance, in terms of speed and/or accuracy of the responses returned by querying the Information Reservoir. According to an embodiment of the present invention, the Information Reservoir is periodically recreated to account for improved rates of inclusion.

13. Methods for Dynamic Maintenance of Information Reservoirs.

Incremental maintenance accommodates changes to the information in the data source brought about by the addition, deletion, and modification of database records. It does not, however, account for drifts in the rates of inclusion brought about by insertions and deletions, nor does it incorporate changes to the rates of inclusion due to changes in sampling policies. According to an embodiment of the present invention, a dynamic maintenance algorithm is provided that works continually to keep the properties of the Information Reservoir in sync with the target rates of inclusion of the data source even as these target rates of inclusion change. The algorithm described here never actually synchronizes the Information Reservoir and data source, but continually refreshes the Information Reservoir so that it lags, but keeps approaching the rates of inclusion of the data source. If changes to the data source cease, the Information Reservoir would approach the final state of the data source, for example, within one build cycle.

The essence of the algorithm is that two background processes are always running. A first background process continually rebuilds the Information Reservoir, and the second background process continually subsamples the Information Reservoir. The rebuilding of the Information Reservoir continues to put fresh tuples with current rates of inclusion into the Information Reservoir. The resampling of the Information Reservoir continually lowers the rates of inclusion of tuples in the Information Reservoir making such tuples less likely to remain in the Information Reservoir. Moreover, resampling has less certainty when used in estimation. The rates of rebuilding and resampling must be chosen so that the size of the Information Reservoir remains within specific bounds on size if such constraints are imposed on the Information Reservoir.

13.1. Continual Rebuild of the Information Reservoir.

The first background process assumes that target rates of inclusion are updated with the occurrence of insertions and deletions and with changes in workload or user-defined design requirements. According to an embodiment of the present invention, an algorithm for implementing the first background process continually rebuilds the Information Reservoir. For example, the original build process used to construct the Information Reservoir is used to construct a buffer that mimics the Information Reservoir. As each tuple is sampled, if the tuple is selected into the buffer, the tuple and the tuple's ancestors (the closure of the tuple) are added to the buffer. The sample in the buffer is then joined to the Information Reservoir with the union operation.

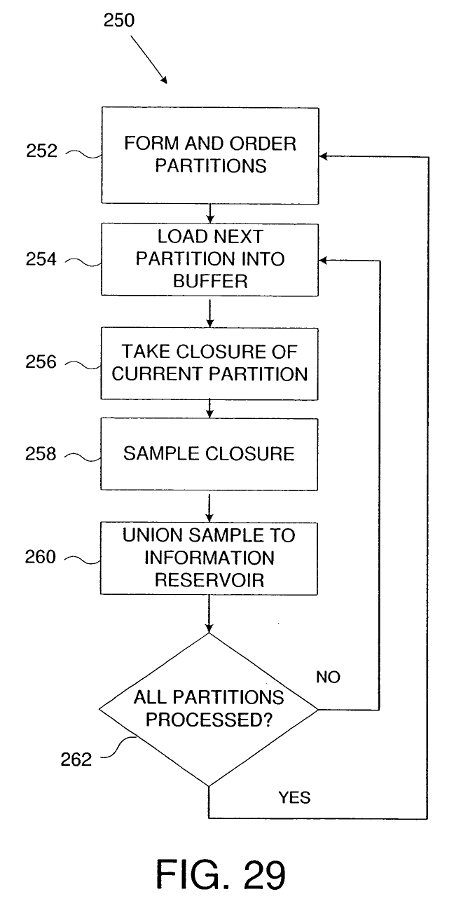

For example, referring to FIG. 29, a method 250 of continually rebuilding an Information Reservoir is illustrated. The embodiment begins with a definition of sampling units and completes a build process as described above for each unit. Specifically the Information Reservoir designer defines logical partitions of tables in the data source at step 252 and orders the partition elements. In general a partition will be defined at a table level and can include within each partition element, one or more tuples. For example in the schema presented in FIG. 2, the user might decide to partition the tables in the schema based on CustomerName in the Customer table. The user may however, choose to extend a partition through parent-child links to all descendant tables.

A partition is loaded into a buffer that mirrors at least part of the database schema at step 254 and tuples are added to the buffer as necessary for the buffer to contain the closure at step 256. That is, sampling units are defined at step 256 by taking the closure of each partition. The buffer is sampled at step 258 and the sample is then unioned with the Information Reservoir at step 260. Part of the union operation is the update of inclusion probabilities in both the Information Reservoir and the population database. The process repeats by selecting the next partition at step 262 if the current partition is not the last partition. When all partitions have been selected, the partitioning process is repeated to incorporate changes to the database since the last partitioning, and the process continues. The rate at which this process proceeds is chosen to be slow enough that undue system resources are not consumed, yet fast enough so that changes to population database are incorporated in the Information Reservoir in a timely manner.

There are multiple possibilities for partitions at step 252 and the decision of which partition to use may be made for example, by the designer of the Information Reservoir. It is likely that several partitions must be used simultaneously in order that the closures of all partition elements of all partitions cover all elements of the Information Reservoir. For example in the schema presented in FIG. 2, partitioning the Customer table by CustomerName alone might not be sufficient since there may be a SalesRepID in the Sales table with no customers. An Information Reservoir designer may choose to partition the Customer table and all its descendants based on CustomerName and the Sales table with none of its descendants by SalesRepID. As another example, the designer may choose to only partition the SalesRepiD and all of its descendants.

13.2. Repeated Subsampling of the Information Reservoir.

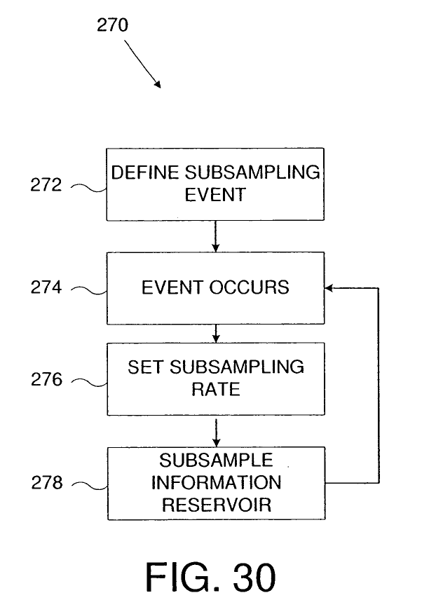

As the rebuild process continually adds tuples to the Information Reservoir, tuples must also be removed. The goals are to maintain sample size and to keep more recently chosen tuples at the expense of tuples chosen long ago. Referring to FIG. 30, a method 270 for subsampling an Information Reservoir is illustrated. At step 272, the event that triggers subsampling is defined. A triggering event may include for example, the exceeding of an upper bound on Information Reservoir size, but other possibilities are also possible. Monitoring the subsampling event occurs at step 274. When the trigger event occurs, the inclusion probabilities for subsampling are defined at step 276. If Information Reservoir size is the trigger, then subsampling inclusion probabilities are set to maintain size. The Information Reservoir is subsampled at step 278. Since resampling rates are typically less than one (though probably near one), each successive subsampling causes a tuple's rate of inclusion to tend to zero over time, which biases the reservoir in favor of newer tuples in the database.

13.3. Changing the Design to Emphasize a Subset of Data Source Tuples.

An Information Reservoir user may discover that the current Information Reservoir does not adequately represent parts of the population that the reservoir user wants to learn about. An alternative to creating an entirely new reservoir is to let the user identify the set of tuples of concern, take the closure of the set, and sample the closure. The result can be added through a union operation to the existing Information Reservoir. For cases in which the targeted tuples can be identified without scanning the entire database, this approach to reservoir building may be more efficient than building an entirely new reservoir. For example, typically a database indexes foreign and primary keys. If a user would like a reservoir to know more about tuples linked to particular foreign or unique key values, the targeted tuples can be located through the indexes.

14. Methods for Creating Information Reservoir Collections.

While a single Information Reservoir may be sufficient for one users purposes, other users may desire a collection of Information Reservoirs to meet their purposes. Several methods are given here for creating collections of Information Reservoirs.

14.1. Scalable Information Reservoirs.

The intelligent sampling techniques discussed more fully herein can be used to construct an Information Reservoir of any size. Typically, the size of the Information Reservoir will be guided by hardware requirements and limitations, required speed, and required precision. For example, an Information Reservoir may be scaled so as to be usable on any computing hardware from networks to handheld portable electronic devices such as palm held computers. Essentially, the Information Reservoir user must be willing to trade off potential precision for size, speed and/or portability.

One concept of an Information Reservoir is the trade-off between precision and resources (usually disk space or time). Exact answers generally require all the data and may take a long time to compute, while approximate answers can be obtained with a sample that uses less disk space and can give answers much more quickly. Naturally even smaller samples use even fewer resources and give faster answers still, but at the expense of additional precision.

According to one embodiment of the present invention, a method for constructing Information Reservoirs is provided that may produce a nested sequence of decreasingly smaller sub-information Reservoirs. A nested sequence of identified sub-information Reservoirs is referred to herein as a multi-resolution Information Reservoir collection. Conceptually the multi-resolution Information Reservoir collection is an Information Reservoir with a nested series of subsets identified, each of which is itself an Information Reservoir.

For example, one approach is to build the largest possible Information Reservoir given the resources available and then to allow the user to select a smaller Information Reservoir if it is desirable to process the query in less time at the cost of answer precision. Conceptually, the user has a “click-stop dial” with successive clicks corresponding to sub-Information Reservoirs of increasing size up to the maximum Information Reservoir. The user runs a query at a particular “dial setting”. If the query runs too slowly, the user can turn the dial to a smaller sub-Information Reservoir. If the query results are not precise enough, the user can turn the dial to a larger sub-Information Reservoir. This approach allows the user to choose a sub-Information Reservoir which provides answers with prescribed confidence bounds.

One concept underlying this embodiment is that an Information Reservoir can be subsampled to yield a new Information Reservoir. For example, if a data source consists of a database having a single table, the rate of inclusion for record i of the original Information Reservoir is π₁ᵢ, and the Information Reservoir is sampled at a rate of π₂ᵢ, then the records in the Information Reservoir will have rates of inclusion defined by πᵢ=π₁ᵢ*π₂ᵢ. In this single table case, if an Information Reservoir with an expected size of 90% of the original Information Reservoir is desired, then one approach is to assign π₂ᵢ=0.9 for all i.

The situation is more complicated with a database schema that involves more than one table due to induced rates of inclusion, but the fundamental concept still holds. In particular, subsampling an Information Reservoir gives an Information Reservoir of smaller size and the rates of inclusion associated with the new reservoir are given by the formula πᵢ=π₂ᵢ. What changes in a multiple table schema, is the simplicity of setting the 90 ₂ᵢ to get a desired scale down. Issues associated with setting the π₂ᵢ are discussed in more detail herein.

An Information Reservoir can be subsampled a finite number of times and the result is again an Information Reservoir with a rate of inclusion for each tuple equal to the product of the sequence of π-weights used in each subsampling step. Accordingly, at design time, the rates of inclusion π₁ᵢ are assigned according to the desired probabilistic sampling scheme so as to create the largest Information Reservoir desired within the limits of computing resources. Also at design time, the π₂ᵢ, π₃ᵢ, etc., are defined to scale down the largest Information Reservoir.

The multi-resolution Information Reservoir collection is created by drawing a sample according the π₁ rates of inclusion (weights), sampling the sample according to the π₂ weights, sampling the most recent sample according the π₃ weights, and so on until all the subsamples specified at design time are drawn. (As noted below, the multi-resolution Information Reservoir collection can also be built from an existing Information Reservoir and in this case the only the design and build of the nested sequence need to be performed.) Note that this process involves the addition of no tuples.

14.2. Multi-Resolution Architecture.

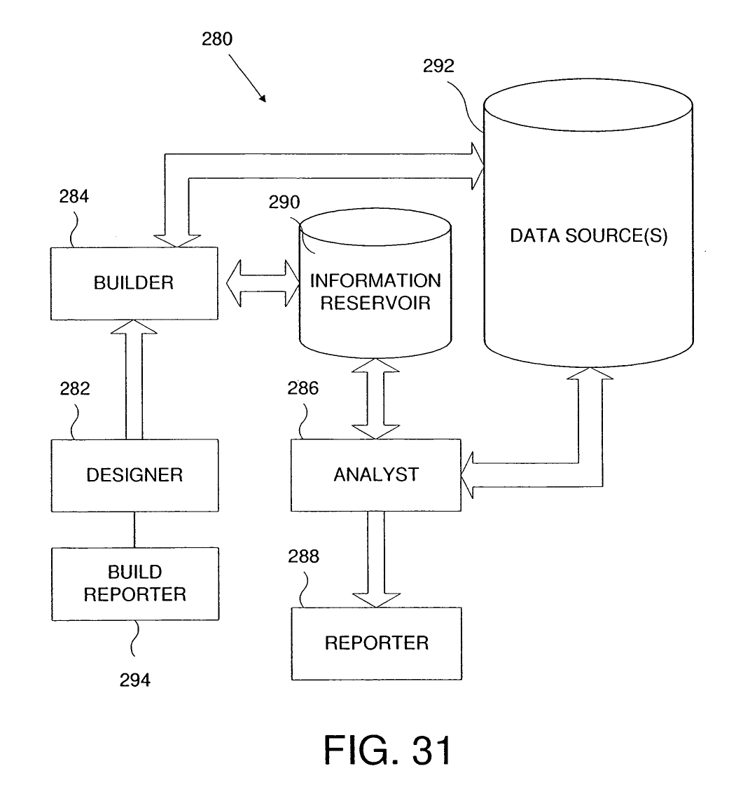

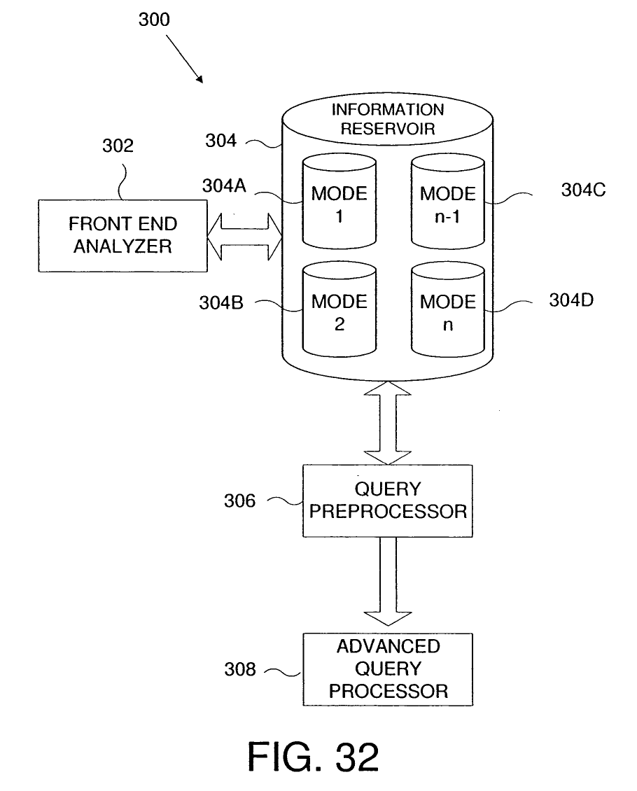

A multi-resolution Information Reservoir can be used with the system 280 discussed with reference to FIG. 31. Under such usage, the architectural components discussed later herein including the Designer 282, the Builder 284, the Analyst 286 and the Reporter 288 may be modified as follows.

The multi-resolution Information Reservoir requires that the Designer 282 accommodate nested sequences. Depending on the application and implementation of this embodiment of the present invention, support for nested sequences may be integrated directly into the Designer 282, or such capability may be implemented as a separate stand-alone component.

The Builder 284 creates the Information Reservoirs. As such, the Builder 284 additionally constructs the mechanism for storing and/or referencing the separate sub-Information Reservoir(s) of the multi-resolution Information Reservoir. The Builder 284 should thus be configured so as to be able to perform maintenance of the sequence of π-weights associated with a record. A record will have a different π-weight for each sub-Information Reservoir of which it is a member. Several proposed implementation mechanisms are discussed more thoroughly herein for maintaining different rates of inclusion.

The Analyst 286 may also be modified to accommodate the multi-resolution Information Reservoir. For example, according to one embodiment of the present invention, a “Click-Stop Dial” is added to the Information Reservoir Analyst 284 to give the user the option of which Information Reservoir to use. Queries are then directed to the appropriately selected Information Reservoir. The Analyst 284 may be required to identify and use the appropriate π-weight for a tuple. Also, benchmark queries may optionally be run against the various Information Reservoirs of a multi-resolution Information Reservoir to provide a “Response Surface” detailing the precision/time tradeoffs. Such information gleaned from such benchmark analysis may be presented to the user through the user interface of the Analyst 286. The Reporter 288 is preferably modified to identify the Information Reservoir used in determining the approximate answer to the query under consideration.

14.3. Design/Build Considerations for Multi-Resolution Information Reservoir Collections.

The flexibility of the Information Reservoir allows the user to optionally highly customize the Information Reservoir to meet particular user needs. As such, the user may need to resolve issues concerning Information Reservoir design. For example, a user may want to consider whether a multi-resolution Information Reservoir collection should be constructed from scratch or from an existing Information Reservoir. A user may also want to address what the desired scale-down factor sequence should be for a multi-resolution Information Reservoir. As another example, a user may want to consider whether any of the sub-information Reservoirs should be created using a subsampling scheme other than a simple proportional scale-down. These and similar considerations may be addressed for example, in the user interface of the Designer 282.

In considering whether a user should build a multi-resolution Information Reservoir collection from the data source or from an existing Information Reservoir, there are at least two approaches to consider. For example, a first approach involves the design of the nested sequence at the same time as the design of the Information Reservoir. In this case the designer for the nested sequence is an extension of the designer for the Information Reservoir and the user can at once specify all design parameters for both the Information Reservoir and the multi-resolution Information Reservoir.

An alternative approach involves the conversion of an existing Information Reservoir into a multi-resolution Information Reservoir. Under such a construction, the designer only addresses issues of the nested sequence and not the issues of the initial Information Reservoir design.

Preferably, the scale-down rates of inclusion π₂ᵢ, π₃ᵢ, etc., are defined at design time. Each scale-down rate of inclusion corresponds to a click on the click-stop dial. For example, consider a single table schema if all the πⱼᵢ's are 0.1, then each sub-Information Reservoir will be roughly an order of magnitude smaller than the previous sub-Information Reservoir. Turning the dial one click will give answers roughly an order of magnitude faster, but with the precision loss associated with using an order of magnitude less data. Thus part of the Information Reservoir design process is the determining the numbers of click stops (number of subsamples to create) and the amount of change in time/precision expected per click (the value to assign the scale-down rates of inclusion).

While this invention allows for the possibility of a user making very complicated scale-down rate of inclusion assignments, a default approach may also be included. For example, a default approach may be implemented such that in the design phase, the user specifies one scale-down factor for each iteration of subsampling. This scale-down factor is assigned uniformly to all tuples as the target sampling scheme and the actual scheme adjusts the target scheme to accommodate the rates of inclusion. While the resulting subsample will be larger than the specified scale-down percentage, this default approach will likely be close to what is desired while accommodating the realities of the multi-table database schema.

Since the multi-resolution aspect of the Information Reservoir is being performed on a sample, its computation is very fast relative to the creation of the original Information Reservoir from the database. For example, the process introduces no new tuples. Thus in many situations it may not be unreasonable for the Designer and Builder components 282, 284 of the multi-resolution Information Reservoir to be run multiple times. To make the actual scale-down sequence more in line with the target sequence specified by the user and to address scale downs of size rather than record counts, certain enhancements may be made to the system 280 of FIG. 31 to support repeated design and build cycles for multiple-resolution Information Reservoirs.

For example, referring to FIG. 31, a Build Reporter 294 that reports the actual scale down observed for a given scale-down factor may be added to the system 280. This may provide for example, the ratio of the before and after size, either in bytes or records as the user desires. The user may then optionally reset the scale-down factor sequence to obtain a sequence closer to that desired by the user.

As a further refinement, the results of the output from the Build Reporter 294 may be combined with a simple root finding algorithm to automate the process of finding an actual sequence of scale-down factors that gives the target scale-down factors. This may be accomplished, for example, by an iterative process that stops at each stage when the size of the sampled Information Reservoir is within an expected range due to the uncertainty in sample size inherent in Information sampling.

14.4. Implementation Issues for Multi-Resolution Information Reservoir Collections.

As a point of clarity, let the sub-Information Reservoirs of a multi-resolution Information Reservoir collection be denoted by IR₁, . . . , IR_{N}, with IR₁ being the smallest sub-information Reservoir and IR_{N} being the largest Information Reservoir. Further let n₁, n_{N} be the number of tuples in each respectively. By design,

IR₁⊂IR₂⊂ . . . ⊂IR_{N}.

A naive implementation of the multi-resolution Information Reservoir would order the tuples so that the tuples of the smallest sub-information Reservoir are first, followed by the tuples of the next smallest sub-Information Reservoir and so on. Specifically the database would have the tuples of IR₁ first, followed by IR₂IR₁, followed by IR₃R₂, and so on with IR_{N}IR_{N}, last. Under such an arrangement, the second smallest Information Reservoir includes the tuples of the smallest Information Reservoir. Thus a query on the smallest sub-Information Reservoir uses the first n₁ tuples. A query on the second smallest sub-information Reservoir uses the first n₂ tuples, and so on with a query on the full Information Reservoir using all of the sampled tuples. With this implementation, when a user sets the click dial to i, they are effectively limiting the query to using the first nᵢ tuples. The construction ensures that the first nᵢ tuples are a sub-Information Reservoir (i.e., a representative sample according the prescribed sampling scheme).

Actual implementation of the multi-resolution Information Reservoir may require deviations from the naive implementation however. Even so, the naive implementation has value by providing a clear conceptual image of an embodiment of the present invention. Among the implementation issues is that a database system may not be able to restrict queries to the first n tuples without considering all the tuples, thus negating any performance boost. This is largely an issue of implementation within the limits and confines of an off-the-shelf database software environment however, and more complicated implementations can resolve this issue.

For example, the tuples of the first sub-Information Reservoir may be placed into one table, the additional tuples of the second sub-Information Reservoir (IR₂IR₁) into a second table, and so on. A query on the j^{th} sub-Information Reservoir must then resolve to j queries on the j tables making up the j^{th} sub-Information Reservoir. Alternatively, an attribute may be added to the tables of the Information Reservoir specifying the IRⱼIRⱼ₋ₗ to which the tuples belong. For example if the attribute value is j, that tuple belongs to the jth sub-information Reservoir and higher. A method may thus be implemented by indexing on this attribute and rewriting the query to include this attribute in the where clause (“where attribute<=j” would access the j^{th} sub-information Reservoir). If possible, the query plan may be further influenced to perform this subset early in the query process.

As still a further alternative, a database software company may implement the capability of constructing multiple-resolution Information Reservoir collections. As still a further alternative, the system may reserve memory equal to the size of the second largest sub-information Reservoir IR_{N-l} and immediately create the sub-information Reservoir of the desired size when the user sets the click dial. Subsequent queries are run against this copy, or the full Information Reservoir if the final click is chosen.

14.5. Multiple Independent Information Reservoirs.

Additionally, as the data source is sampled, two or more independent Information Reservoirs can be created by giving each tuple two independent chances to enter the sample. For most queries of the Information Reservoir, the union of two such reservoirs can be used to compute estimates. According to this embodiment of the present invention, for queries in which two statistically independent aggregates are desired, two independent reservoirs are available to support estimation.

15. Methods for Storing Approximate Answers and Variance information as Table-Level Metadata.

Associated with the Information Reservoir is a structure for storing table-level metadata. In this context “table” refers to base tables in the original data source, temporary tables produced as the result of queries whether stored or not, and base or temporary table definitions used in query translation that contain no data.

Table-Level Metadata would include:

Name and aliases

Number of records (in particular are there more than one or only one)

Table Type: Base, Derived, or Terminal

Primary key

Foreign keys with linkage information

Attribute-Level Metadata

Attribute-Level Metadata would include:

Name

Data Type

Sampling Type

Variance Type

Uncertainty Metadata

Uncertainty Metadata would include:

Name of variance variable if applicable

Name of variable containing sampling rate if applicable

Linkage to table containing sampling rate if applicable

Several pieces of the metadata are discussed further below.

Table Type is used for query translation. The category Base means that it is part of the original data source. Derived means that it is the result of a query. Terminal means that the table cannot be used for any further queries. Typically a terminal table is returned as a result of a query that cannot be handled by the Information Reservoir methodology and the terminal type enables the query translator a means to gracefully handle such queries.

Sampling Type refers to whether an attribute in a table has been sampled (directly or as a descendant of a sampled table). Potential values are “Unsampled,” “Sampled,” and “Descendant Sampled.”

Variance Type refers to whether the value of the attribute is a known number or whether it has an associated variance. Potential values are “None” and “Simple Variance.” The type “Categorical” is used to denote non-numeric types, or numeric types for which aggregation is not meaningful. Typically key attributes are Categorical, as are dates and classifications. For the automated translation process, types of “Terminal” and “Administrative” are also defined to indicate either that the attribute is the result of an operation that the system cannot handle or is a variable created by the system for administrative purposes such as PI (Π) weights and should not be accessed by a user query. We note that operations such as joins potentially produce tables with multiple types of attributes so this metadata is more properly stored at the attribute level rather than the table level.

This metadata contains the information necessary to determine whether a query written against the original database can be re-expressed as a query against the sampled representation, and, if so, how such a reconstruction should be written.

16. Methods for Querying an Information Reservoir or Information Reservoir Collection.

Methods for query re-expression and automated query translation are given here. An example rule set is presented to illustrate the automated query translation process and the manner in which the rule set applies to standard atomic table collection and database operations is explained.

16.1. Methods for Query Re-Expression.

Queries applied to the source database need to be re-expressed in a form appropriate for obtaining approximate answers from an Information Reservoir. For example, consider a SQL query of the form

SELECT SUM(X)

FROM T

where X is an attribute of a table T which has been directly-sampled in the Information Reservoir representation. Applied to the original database, this query returns the sum of attribute X over all the tuples in table T. Directly applied to the Information Reservoir, this query returns the sum of attribute X over all the tuples in the sample of table T, which is typically not useful for obtaining an answer from the information reservoir quickly. Rather a weighted sum needs to be computed when using the sample to estimate SUM(X) over the source table. The previous query when directed against the Information Reservoir should be translated to the following SQL query:

SELECT SUM(X/PI) as sumX, SUM(((1-PI)/PI*PI)*X*X) as var_sumX FROM T.

TABLES 1, 2, and 3 present a set of formulas for computing aggregate functions on Information Reservoirs created using probabilistic sampling. These TABLES include formulas for both point estimates (i.e., the approximate answer) and the variance associated with the point estimate. The point estimate and variance may be used to create confidence bounds. TABLES 1 and 2 present aggregation formulas for queries on records or tuples. The suffix “_ir” refers to “Information Reservoir.” The formulas of TABLE 2 are special cases of some of the formulas of TABLE 1 when one attribute is a dummy taking only the value 1. These include Count and Average statistics. Formulas in TABLE 3 are for computing aggregates on attributes that are not sampled, but rather have uncertainty in the form of a variance. For example, attributes of this type could be the result of an aggregation query. The formulas in TABLE 3 allow for a series of aggregation queries where each successive query acts on the results of a previous query.

According to an embodiment of the present invention, the formulas used to implement the approximate answer query extend to the case of weighted aggregates. By re-expressing formulas in an algorithmic form, the formulas can be recursively applied, not just to data tables, but also to the results of queries. The result is a formulation that is suitable for implementation into extensions of database query languages such as SQL. Specifically equations 1, 2, and 3 of TABLE 1 are structured so that they may be computed by completing the sum in any order. Equations 1, 2, and 3 form the basis for the equations in TABLE 3, which explicitly address queries on the results of queries (or group results). The formula for varavg_ir(Y) is missing from TABLE 3, but this can be computed on the results of queries using Equation 11 from TABLE 2, which is built up out of components from TABLE 3. In the case of queries on queries, other formulas from TABLES 1 and 2 can similarly be composed out of formulas from TABLE 3 including products and ratios. Thus the formulas of these tables are building blocks for a wide class of functions that be computed on both records and on the results of queries.

TABLE 1
Aggregation Formulas for Use with Information Reservoir Tuples
(Summations are over the items in the reservoir satisfying the
query predicate)

| REFERENCE | AGGREGATION FORMULA |
|---|---|
| 1 | sum_ir(Y) = Σ (Wᵢ*Yᵢ/πᵢ) |
| 2 | varsum_ir(Y) = Σ (((1-πᵢ)/ πᵢ²)*Wᵢ²*Yᵢ²) |
| 3 | covarsum_ir(Y1,Y2) = Σ (((1-πᵢ)/ πᵢ²)*(Wᵢ²*Y1ᵢ*Y2ᵢ)) |
| 4 | ratiosum_ir(Y1,Y2) = sum_ir(Y1)/sum_ir(Y2) |
| 5 | varratiosum_ir(Y1,Y2) = (1/(sum_ir(Y2))²) |
| | *varsum_ir(Y1) + ((sum_)ir(Y1))²/(sum_ir(Y2))⁴) |
| | *varsum_ir(Y2) − 2*(sum_ir(Y1)/(sum_ir(Y2))³) |
| | *covarsum_ir(Y1,Y2) |
| 6 | productsum_ir(Y1,Y2) = sum ir(Y1) * sum_ir(Y2) |
| 7 | varproductsum_ir(Y1,Y2) = ((sum_ir(Y2))²) |
| | *varsum_ir(Y1) + ((sum_ir(Y1))²)*varsum_ir (Y2) + |
| | 2*(sum_ir(Y1)*sum_ir(Y2))*covarsum_ir (Y1,Y2) |

TABLE 2
Special Case Aggregation Functions for Use with Information
Reservoir Tuples (Summations are over the records obtained
as the result of an aggregation query. Let “*” represent
an attribute that is equal to one for all records.)

| REFERENCE | AGGREGATION FORMULA |
|---|---|
| 8 | count_ir(*) = sum_ir(*) = Σ (Wᵢ/ πᵢ) |
| 9 | varcount_ir(*) = varsum_ir(*) = Σ (Wᵢ²*(1 − πᵢ)/πᵢ²) |
| 10 | avg_ir(Y) = ratiosum_ir(Y,*) |
| 11 | varavg(Y) = varratiosum_ir(Y,*) |

TABLE 3
Aggregation Functions for Use with Aggregation Records (In the
following formulas, it is assumed that the records are
partitioned into G groups. The notation estimator_{g} (e.g.,
sum_ir_{g}) is an estimator computed using the appropriate formula
above, but over only the records in group g. The summations are
taken over the groups.)

| REFERENCE | AGGREGATION FORMULA |
|---|---|
| 12 | sum_ir(Y) = Σ_{gεG} sum_ir_{g}(Y) |
| 13 | varsum_ir(Y) = Σ _{gεG} varsum_ir_{g}(Y) |
| 14 | covarsum_ir(Y1, Y2) = Σ _{gεG} covarsum_{—} |
| | ir_{g}(Y1, Y2) |
| 15 | count_ir(*) = Σ _{gεG} count_ir_{g}(*) |
| 16 | varcount_ir(*) = Σ _{gεG} varcount_ir_{g}(*) |
| 17 | avg_ir(Y) = (1/count_ir(*))Σ _{gεG} |
| | (count_ir_{g}(*) * avg_ir_{g}(Y)) |

The formulas in TABLES 1 and 2 provide the basis for translating “simple queries” on the source database into queries on the Information Reservoir. In this context, a “simple SQL query” is an aggregate expression composed of linear combinations of the aggregate functions specified for tables with attributes that have been directly sampled using Poisson sampling methodology. The query may specify subsetting of the table if the selection rule is based on a comparison of an attribute with a quantity without uncertainty. For example, a simple query could contain clauses such as “WHERE X<2” or “WHERE Date>12Dec02”, but not clauses such as “WHERE X<0.2*AVG(X)” because AVG(X) is computed on the sample and has an associated variance.

TABLE 3 provides the basis for translating “simple queries on aggregates.” These are aggregate queries on the result of a “simple query” as defined above with the same selection restrictions. This type of query arises naturally when the user is requesting a sequence of queries be performed and a later query uses the results of an earlier query.

In special cases where population sizes or group population sizes are known, estimators associated with sampling methods that use this known information, such as stratified sampling, may have a relatively smaller estimated variances than sampling methods which ignore this information, in particular Poisson sampling and the formulas of TABLES 1 through 3. According to an embodiment of the present invention, the approximate aggregate algorithms listed in TABLE 1 through 3 may be modified to incorporate known population information so that the probabilistic estimated variance is comparable to that computed using stratified methods. The improvements to the probabilistic estimators are generally applicable where appropriate population sizes are known, which in general consists of queries with no WHERE clause or anticipated queries where group population sizes are predetermined and retained. Currently the metadata retains the number of tuples in tables. To use this methodology, the metadata must be enriched to include group counts from the source tables for the groups of interest.

Assume that the population P is partitioned into a set of groups G, the size of P is N, and the size of the g^{th} group is N_{g}. If the population size is known there are two versions of the mean estimator:

$${y}^{\hat{\_}} = \frac{1}{N} {\sum }_{i ∈ S} \frac{{y}_{i}}{{π}_{i}} \qquad and \qquad {y}^{\hat{\_}} = \frac{1}{\hat{N}} {\sum }_{i ∈ S} \frac{{y}_{i}}{{π}_{i}} .$$

While one generally uses a known value over its estimate in a formula, it is preferable when using the Information sampling methodologies herein to use the second version of the mean estimator even when N is known, since \hat{N} controls for uncertainty due to sample size variation. Thus the formula for avg_ir(Y) in tables 2 and 3 herein, remains unchanged in the presence of known population or group counts. These ideas are repeated in the formulations below; namely, replacing \hat{N} by N when N is known and does not control for variance, and not replacing \hat{N} when N does control for variance.

For example, one core formula herein is the modification of the varavg_ir(Y) formula. The aggregation formula in TABLE 2 for varavg_ir(Y)=varratiosum_ir(Y,*) is a restatement in algorithmic notation of the following mathematical formula:

$$Var\_hat ( {y}^{\hat{\_}} ) = \frac{1}{\hat{N}} ( \frac{1}{\hat{N}} \sum ( ( \frac{1 - {π}_{i}}{{π}_{i}^{2}} ) {( {y}_{i} - {y}^{\hat{\_}} )}^{2} ) ) .$$

The modifications of this section keep the inner \hat{N} to control for variance and replace the outer \hat{N} by N, thus giving

$${Var\_hat}^{*} ( {y}^{\hat{\_}} ) = \frac{1}{N} ( \frac{1}{\hat{N}} \sum ( ( \frac{1 - {π}_{i}}{{π}_{i}^{2}} ) {( {y}_{i} - {y}^{\hat{\_}} )}^{2} ) ) .$$

This is expressed in algorithmic notation in Equation 21 of TABLE 4. Therein, varavg_{g}(Y) is defined to be varavg (Y) and is applied only to the elements of group g. TABLE 4 presents modified formulas for use when the population size N is known. TABLE 5 presents modified formulas when the group sizes N_{g} are known. As long as the estimator and its corresponding estimated variance are used together, there is also no change to the confidence bound formulas presented later in TABLE 6.

TABLE 4
Modified Aggregate Functions for Known Population Size N

| REFERENCE | AGGREGATION FORMULA |
|---|---|
| 20 | Avg_ir*(Y) = avg_ir(Y) (no change) |
| 21 | varavg_ir*(Y) = varratiosum_ir (Y1,*) = |
| | (1/N²)*(varsum_ir (Y) + ((sum_ir(Y))²/ |
| | (sum_ir(*))²)*varsum_ir (*) − 2*(sum_ir(Y)/ |
| | (sum_ir(*)))*covarsum_ir (Y,*)) |
| 22 | sum_ir*(Y) = N avg_ir(Y) |
| 23 | varsum_ir*(Y) = N² varavg_ir*(Y) |

TABLE 5
Modified Aggregate Functions for Known Group-bys

| REFERENCE | AGGREGATION FORMULA |
|---|---|
| 24 | avg_ir*(Y) = (1/N) Σ_{gεG} (N_{g} * avg_ir_{g}(Y)) |
| 25 | varavg_ir*(Y) = (1/N)² Σ _{gεG} (N_{g2} * |
| | varavg_ir*_{g}(Y)) |
| 26 | sum_ir*(Y) = Σ_{gεG} N_{g} avg_ir_{g}(Y) |
| 27 | varsum*(Y) = Σ _{gεG} N_{g}² varavg_ir*_{g}(Y) |

16.2. Methods for Automated Query Translation.

In the case of “simple queries,” translation is straightforward and can be done either manually or automatically with a text substitution script—though it should be noted that the formulas become very complicated very quickly making manual translation time consuming and tedious. “Simple queries on aggregates” are similarly translated by text substitution. If both “simple queries” and “simple queries on aggregates” are to be translated, the script needs to be informed as to whether aggregation is occurring on an aggregate table so that the correct text substitution rules may be applied. This information could be supplied by the user on a query-by-query basis. Other possibilities include having the translator maintain a list of base tables in the original data source either through the user supplying a list up front or by the translator accessing the metadata. Any table not specified as being a base table is assumed to be the result of a prior aggregation and the translation proceeds autonomously.

One embodiment of this invention has such an automated query translator which simply substitutes aggregate formulas in the original query with the formulas for the point estimate and variance indicated in TABLES 1 , 2, and 3. This embodiment acts on the very restricted, though useful, set of “simple” and “simple aggregate” queries defined above. The onus of determining whether a query is “simple” falls on the user. The translator needs to be informed as to whether a query is acting on a base table or an aggregated table through one of the mechanisms discussed.

Another embodiment of this invention has a much more sophisticated query translator which can handle a significantly more extensive class of queries and does not require the user to vet queries for whether or not they can be handled by the Information Reservoir methodology. This embodiment allows for base tables which have been sampled through a variety of schemes including being unsampled (i.e., taken in their entirely), directly sampled, sampled indirectly through a parent, and directly subsampled after being sampled indirectly. Queries may act on the objects other than base tables and tables resulting from aggregate queries, such as the join of tables or tables that are the result of many prior queries. Further complex queries such as those involving subqueries can also by handled by this embodiment. This embodiment of the translator will handle such queries to the extent of being able to identify them and, when indeterminate, returning information indicating that they cannot be handled. Thus, the onus of determining whether or not the query can be handled falls on the translator, not on the user. As the Information Reservoir methodology develops, the rule set of this embodiment of the translator can be augmented. Further with augmentation of the rule set and stored metadata, this approach can be extended to handle tables that have been sampled multiple times by different methodologies or sampling schemes and tables represented by techniques other than sampling.

Queries written in procedural languages such as SQL are hard to translate directly and it is hard to determine if the Information Reservoir technology can currently handle them because many operations are being specified simultaneously. For example, a typical query will likely specify one or more joins, a selection or subsetting, one or more aggregations, a group-by requirement, and possibly a subsetting of the results based on the group-by categories. Sorting may also be requested. More complicated queries may have subqueries, each of which may contain several of these steps.

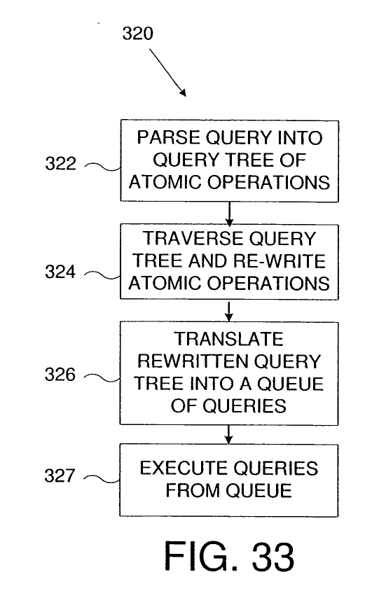

The steps in this process are presented in FIG. 33. As indicated above, translation is simple when the query is simple and consists of little more than deciding which rule to use and then performing a text substitution. For these reasons, the query translation methodology specified in this embodiment begins with a query (320) in a procedural language like SQL and parses it in 322 into a query tree of atomic operations. Such operations include pair-wise joins, cross products, selections, projections, and aggregations. The collection of these operations is frequently referred to as a database relational algebra. The operations specified in a query tree can be ordered in a sequential manner by performing a depth-first traversal of the tree. A “series query” (a set of queries in which later queries act on the results of earlier queries) can be written as a single tree with each query in the series as a sub-tree. A user may specify a sequence of independent queries. Such a sequence will be represented as a sequence of disjoint query trees. Finally, a user may also specify a sequence of queries, some of which may be independent and some of which form series queries. Further the series queries may not be contiguous in the sense that independent queries may be interspersed among the pieces of the series query or pieces of several series queries may be interspersed. When converted to a parse tree, the pieces of a series query are put into a singe query tree. Thus the parse tree provides a method for identifying relationships between procedural statements that may be far apart in a long query script, as would be the case when an analyst is computing many subresults and then later combining the results in some way.

The parsing (322) of queries in database languages such as SQL to relational algebra query trees has been extensively researched and is well documented. Similarly the conversion of relational algebra query trees to query language is also well-documented (326). It should also be observed that each atomic operation can be expressed as a query language query in a very straight forward, though perhaps computationally inefficient, manner. Teachings in the art provide guidance for more efficient translation. The present invention addresses the translation (324) of atomic database operations applied to the source database to atomic database operations applied to the Information Reservoir. Different embodiments of this invention could use different combinations of these steps. For example, a typical embodiment would start with a query or a queue of queries in a query language on the source database (320), convert to a relational algebra query tree on the source database (322), convert to a relational algebra query tree on the Information Reservoir (324), and then convert to a queue of queries in a query language on the Information Reservoir (326). The queue of queries can then be executed (328). It is not required that the query language used with the source database be the same as the query language used with the Information Reservoir. As a second example, if this invention is implemented in the context of a native database system, it is likely that translation will consist of starting with a query in a query language and end with relational algebra on the Information Reservoir. From there the database system translates the relational algebra query tree into an appropriate native database language. This presumes the database system has a native capability for handling relational algebra.

As discussed above, an atomic operation will have different conversion rules depending on the type of the attributes in the table. An automated query translator needs to decide which rule to use on its own. In order to do this, it needs to make use of the Table-Level metadata (which includes the Attribute-Level and Uncertainty metadata). The atomic operations of the relational algebra act on one, or at most two, tables. The result of an atomic operation is a table. As the translator proceeds up the query tree it maintains the metadata for the result tables. Thus whenever an aggregation needs to be performed on an attribute, the metadata for the current table is available. Metadata can be used to determine what type of sampling the attribute has experienced and what type of variance is associated with the attribute. The rule set is constructed by listing each atomic operation, its inputs, determining the nature of the inputs from the metadata, and then determining the appropriate manner of treating this operation in the Information Reservoir. The rule set determines both the manner in which an atomic operation is converted and the values of the metadata for the result table and, especially, the attribute metadata.

In the process of working its way through a query, the translator establishes the metadata for many temporary and permanent tables. These tables with their metadata may be added to the schema information for the database. A common practice in database querying is to name or make permanent the results of a query for future use. The use of metadata allows such tables to be automatically created with foreign and virtual key relationships relative to existing tables already in place. Strategically chosen result tables can be added to the Information Reservoir for more efficient future querying. From the point of view of query translation, identical sub-trees yield identical results and the metadata for temporary tables can be reused to prevent the translator from reparsing the same operation string. One important use of this is that the translator requires that atomic aggregations perform at most one aggregation. Any query that has multiple aggregations specified gets split into separate nodes for each aggregate computation and the results are then combined through a series of joins. The query tree beneath each of these splits is identical and it is known to be identical at parse time. The translator need traverse only one of these sub-trees and then use the result for each distinct aggregation.

16.3. Example Rule Set for Aggregating an Attribute by a SUM Function.

As an example of the rule set, consider the atomic operation of aggregating an attribute by a SUM function. The notation for the relational algebra notation used here is AGG(R, <SUM(attr) as alias>, group-by list) where AGG indicates that the atomic operation is an aggregation, R is the input table, the list of aggregations performed by this operation is contained within the < . . . > along with their aliases or the names to be given to them in the resulting table, attr is the attribute being aggregated, and group-by list is the level at which the aggregation is to be performed and is a list of variables in R. It makes no difference to this approach whether a projection operation has been performed so that R has only the variables attr and those listed in group-by-list or whether the projection is implicitly assumed to be part of the AGG operation.

The conversion of AGG(R, <SUM(attr) as alias>, group-by list) depends on the sampling and variance type of attr. A sample of a possible rule set for this conversion is presented here. This sample is for illustrative purposes only and is not exhaustive and is not intended in any way to limit the capabilities or implementation of this embodiment of the translator. The translation rules are not unique and this sample presents only one possible instantiation of them.

This example makes reference to several other atomic relations. The notation J(Table 1, Table 2, join conditions) indicates an inner join between Table 1 and Table 2. The symbol <- is the operation of naming the result table and is used here so that a sequence of linked operations can be expressed in a more readable form. Finally AGG(R, <MIN(attr) as alias>, group-by list) is used to indicate a minimum aggregate operation. For atomic operations on the source database we require only one aggregation be performed at each atomic operation to enable use of the rule set. This condition is relaxed on the translated atomic operations where several aggregations may occur within a single atomic operation. The most common occurrence of this is the calculation of both a point estimate and its variance in a single AGG operation. Case: Atomic operation=AGG(R, <SUM(attr) as alias>, group-by list)

Sub-Case: attr has Sampling Type=Unsampled and Variance Type=None

Metadata Needed: None

Rule:

AGG(R, <SUM(attr)> as alias, group-by list) becomes

AGG(R, <SUM(attr) as alias>, group-by list);

Metadata Updated:

Attributes Retained: alias and the attributes in group-by list

alias has type Sampling Type=Unsampled and Variance Type=None

attributes in group-by list have Type=Categorical

key is group-by list

if group-by list is empty then Number of records=1 else it is given a default

value

Sub-Case: attr has Sampling Type=Sampled and Variance Type=None

Metadata Needed: the name of sampling weight variable (referred to as T.PI in Rule, T is the base relation containing attr)

Rule:

AGG(R, <SUM(attr)> as alias, group-by list) becomes

AGG(R, <SUM(attr/T.PI) as alias, SUM(attr*attr*(1−T.PI)/(T.PI*T.PI)) as Var_alias>, group-by list)

Metadata Updated:

Attributes Retained: alias, Var_alias, and the attributes in group-by list alias has type Sampling Type=Unsampled and Variance Type=Simple Variance

attributes in group-by list have Variance Type=Categorical

key is group-by list

if group-by list is empty then Number of records=1 else it is given a default value

Sub-Case: attr has Sampling Type=Unsampled and Variance Type=Simple Variance

Metadata Needed: the name of variance associated with attr (called Var_attr in the Rule)

Rule:

AGG(R, <SUM(attr)> as alias, group-by list) becomes

AGG(R, <SUM(attr) as alias, SUM(Var_attr) as Var_alias>, group-by list)

Metadata Updated:

Attributes Retained: alias, Var_alias, and the attributes in group-by list alias has type Sampling Type=Unsampled and Variance Type=Simple Variance

Var_alias has Variance Type=Administrative

Attributes in group-by list are of Variance Type=Categorical

if group-by list is empty then Number of records=1 else it is given a default value

Sub-Case: attr has Sampling Type=Descendant Sampled and Variance Type=None

Metadata Needed:

Linkage to the ancestor table containing sampling weight attribute

(In the rule this anscestry is denoted by a sequence of parent tables P1, P2, . . . , PN and foreign_key_relation_1, . . . , foreign_key_relation_N) The name of sampling weight attribute (referred to as PN.PI in Rule)

Primary key of the sampled ancestor

Sub-Sub-Case: Group-by is finer than the primary key of the sampled ancestor.

Rule:

AGG(R, <SUM(attr)> as alias, group-by list) becomes

AGG(R, <SUM (attr) as alias>, group-by list)

Metadata Updated:

+P4

Attributes Retained: alias, Var_alias, and the attributes in group-by list

alias is of Sampling Type=Descendent Sampled and Variance Type=None

Var_alias has Variance Type=Administrative

Attributes in group-by list are of Variance Type=Categorical if group-by list is empty then Number of records=1 else it is given a default value

Sub-Sub-Case: If group-by list is coarser than the primary key of the sampled ancestor:

Rule:

(The following joins should be implemented within if-then logic and only performed if key/pi information is not already in the table)

AGG(R, <SUM(attr)> as alias, group-by list) becomes

T<-J(R, P1, foreign_key_relation_{—}1)

T<-J(T, P2, foreign_key_relation_{—}2)

•

•

•

T<-J(T, PN, foreign_key_relation_N)

T<-AGG(T, <MIN(PN.PI) as PI, SUM (attr) as temp>, N_primary_key)

AGG(T, <SUM(temp/PI) as alias, SUM(temp*(1−PI)/(Pi*Pi)) as Var_alias>, group-by list)

Metadata Updated:

Attributes Retained: alias, Var_alias, and attributes in group-by list alias has Sampling Type=None and Variance Type=Simple Variance

Var_alias has Variance Type=Administrative

Attributes in group-by list have Variance Type=Categorical

if group-by list is empty then Number of records=1 else it is given a default value

Sub-Sub-Case: Else

Metadata Needed: None

Rule:

AGG(R, <SUM(attr)> as alias, group-by list) becomes Null Operation

Metadata Updated:

Table marked as Terminal.

Sub-Case: Else

Metadata Needed: None

Rule:

AGG(R, <SUM(attr)> as alias, group-by list) becomes Null Operation

Metadata Updated:

Table marked as Terminal.

As seen in the sample, the rule set addresses each atomic operation individually. For each operation, the rule addresses the question “How is this operation performed in an Information Reservoir?” Typically the answer to this question depends upon the nature of the table or the attributes being acted upon, and to obtain this information the metadata for the table is examined. With this information, the rule set specifies how the conversion is carried out. Finally the metadata for the result table needs to be specified and note that operations may change the type of attributes. We also note that while the rule set technically handles every possibility, it may handle some cases by returning a Null Operation or by marking the metadata for a table or attribute as Terminal, indicating that the results cannot be used in subsequent queries.

16.4. The Rule Set Applied to Standard Atomic Operations.

The rule set addresses the following standard atomic operations.

INNER AND OUTER JOINS. The Information Reservoir methodology currently allows inner joins along foreign key relationships specified in the schema or virtual key relationship established during Reservoir design and construction. Currently FULL, LEFT, and RIGHT OUTER JOIN are handled by the translator by returning a terminal condition.

CROSS JOINS. Currently CROSS JOINS are supported only if one table contains exactly one record (number of records is part of the Table-Level metadata and any aggregate query which aggregates without a Null group-by list sets this metadata variable to one). The translator handles other cases by returning a terminal condition.

UNIONS. With the current rule set, UNIONS can be performed only if comparable attributes in both tables have the same sampling and variance type and both tables are subsets of the same predecessor table. This would be the case if a query involved a selection operation with a compound predicate joined by OR. In breaking the query into atomic operations, each part of the compound attribute becomes its own SELECT operation and the results may be unioned if attribute types have not changed.

PROJECTIONS. The rule set supports projections, but the result table will contain additional administrative attributes such as variances and any keys necessary to retrieve administrative data from another table (as would be the case with a descendant sampled attribute). The metadata contains sufficient information to determine the additional attributes that must be kept.

SELECTIONS. The selection or subsetting operation has a complicated rule set. There are several issues.

1. Subsetting can change the variance type of attribute. In general, a comparison with a number or attribute with no variance poses no problems, but a comparison with uncertain quantities is complicated. As an example, consider a query with “WHERE X<AVG(Y)” where Y is a sampled attribute. AVG(Y) is now a quantity with variance that is assumed to have an approximately normal distribution by the Central Limit Theorem. The condition X<AVG(Y) is no longer true or false, rather it has a probability of being true. The variance type of attributes selected by this WHERE clause is new and will referred to here as “Fuzzy.” A comparison with an attribute with Fuzzy variable type is also possible and potentially creates another new variance type. Comparing with this type potentially creates yet another type, and so on recursively. Comparisons may also occur between attributes of different complicated types arising from previous queries. At the current development of the rule set, any type more complicated than Fuzzy is considered to be Terminal, but the machinery readily allows for more types to be handled as the technology develops.

2. Conjunctions and Disjunctions. A WHERE clause can contain multiple logical conditions joined by AND or OR. Conditions connected by AND can be written as sequence of SELECTION operations, each containing one condition. This is the preferred atomic form. Conditions connected by OR can be written as a sequence of UNION operations. This can be problematic as WHERE clauses can change attribute types and the current methodology cannot UNION two tables with comparable attributes having different types. On the other hand if the comparisons do not change types, then there is no need to split the statement into a sequence of UNIONs. The rule set currently separates disjunctive statements to examine comparisons using the metadata to see what type changes occur. If the type changes are consistent across all comparisons, then the original OR statement is kept intact and the metadata reflects the effect of any one of the comparisons. If the type changes are not consistent, this is a terminal operation and the metadata is updated to reflect this.

3. More Conjunctions and Disjunctions. Many conditionals have both AND and OR statements. Due to the complicating issues addressed in 2 above, conditional statements will be rewritten into conjunctive normal form before being processed further. [From elementary logic theory, any statement formed by joining conditions using AND and OR can be rearranged to have the form (OR OR . . . OR ) AND (OR OR . . . OR ) AND . . . AND (OR OR . . . OR) where statements exist on either side of the ORs. This form is called conjunctive normal form.] In this form the translator splits the statements separated by AND into a sequence of SELECT operations consisting entirely of a single disjunctive conditional statement. These disjunctive conditional statements are processed as discussed in 2.

SORTS. Sorting requires no translation.

RENAMES. Renaming tables requires no translation. The symbol<-denotes renaming.

AGGREGATES. The following aggregate functions can be handled by the Information Reservoir methodology.

SUM

COUNT

RATIOSUM

AVERAGE

The rule set translates these for the following Sampling—Variance types: (Unsampled, None), (Sampled, None), (Descendent Sampled, None), and (Unsampled, Simple Variance).

MIN and MAX. MIN and MAX may not be handled well by Information Reservoir methodology, in which case the translator returns a terminal condition. These aggregates appear in some of the rewritten queries because special known conditions (such as constant attribute values) allow for their use. This was seen in the example above.

EXPRESSIONS. Expressions of aggregates can be handled provided the expression is a linear combinations of aggregates (sums of constants times aggregates). The translation performs each aggregation as a separate atomic operation then joins the results and applies the expression to the computed aggregates.

RATIOTOREPORT. The rule set addresses some specialized and complicated operations such as RATIOTOREPORT. The notation RATIOTOREPORT(R, SUM(attr), alias, group-by list) refers to an operation that returns a list of ratios of group sums to total sums. The rule set can handle RATIOTOREPORT(SUM) attributes of the following Sampling—Variance Types: (Unsampled, None), (Sampled, None), and (Descendent Sampled, None).

The RATIOTOREPORT(SUM) is a complicated translation since a single atomic operation is replaced by a sequence of atomic operations and it is included here for illustration for the (Descendant Sample, None) case with the subcase that the group-by partition is coarser than the primary key of the sampled ancestor.

Case: RATIOTOREPORT(R, SUM(attr), alias, group-by list)

Sub-Case: group-by is coarser than the primary key of the sampled ancestor

Metadata need:

The link to the sampled ancestor R->P1->P2-> . . . ->PN

The sampling weight of the sampled ancestor (denoted in the Rule as PN.PI)

Primary key of the sampled ancestor

Rule:

T<-J(R, P1, foreign_key_relation_{—}1)

T<-J(T, P2, foreign_key_relation_{—}2)

•

•

•

T<-J(T, PN, foreign_key_relation_N)

T1<-Agg(T, <MIN(PN.PI as T1.PI, SUM(attr) as pot_sum1>, group-by list ∥ primary key of PN)

T2 <-Agg(T1, <MIN(T1.PI) as T2.PI, SUM(pot_suml) as pot_sum2>, primary key of PN)

T3<-Agg(T2, <SUM(pot_sum2/T2.PI) as pot_den SUM(((1−T2.PI)/(T2.PI*T2.PI))*pot_sum2*pot_sum2) as var_pot_den>, NULL)

T<-J(T1 as T1, T2 as T2, primary key of PN)

T<-CROSS(T, T3 as T3)

T<-AGG(T, <SUM(T1.pot_sum1)/T3.pot_den as alias,

(1/(MIN(T3.pot_den)*MIN(T3.pot_den)))*(alias*alias)*

MIN(T3.var_pot_den)+SUM(((1−

T2.PI)/(T2.PI*T2.PI))*((T1.pot_sum1*T1.pot_sum1)−

alias*T1.pot_sum1*MIN(T2.pot_sum2))) as var_alias>, group-by list)

Metadata Updated:

Attributes retained: alias, Var_alias, and the attributes in group-by list

alias has Sampling Type=Unsampled and Variance Type=Simple Variance

Var_alias has Variance Type=Administrative

Attributes in group-by list have Variance Type=Categorical

if group-by list is empty then Number of Records=1 else it is given a default value

17. Methods for Testing and Optimizing Queries Using Information Reservoirs.

An Information Reservoir could be used for query testing and optimization in a number of ways. First, a software developer could use an Information Reservoir as a test bed while testing software involving queries on a database. The Information Reservoir would allow the developer to test the software using a small, realistic model of the database requiring much less time and space.

Second, a database developer could use an Information Reservoir to profile the execution of a query without running it on the larger database. While the run times of the query will not be linearly predictive of actual run times, many aspects of a query such as access paths and join methods can be tuned using the Information Reservoir.

Finally, a database management system could use an Information Reservoir internally to optimize queries. Many statistics useful in dynamic query optimization, such as selectivity, relationship cardinality, distinct value count, etc. are readily available from an Information Reservoir. More importantly, the DMBS can obtain confidence bounds on these values, as well as information on the actual distribution of data values and the interdependence of attributes. Classical query optimizers assume uniform distribution of data and independence between attributes. More recent database management systems may store histograms of data distributions, but they still assume that the data distribution of a subset matches the superset. Very few DBMS address the issue of dependence between attributes.

18. Approximate Query Architectures.

Approximate query architectures are discussed here in general and specifically addressing interplay between query translation and the Analyst component.

18.1. General Discussion of Approximate Query Architectures.

A system 280 for constructing and using an Information Reservoir according to an embodiment of the present invention is shown in FIG. 31. Basically, the system architecture may be implemented using four components including a Designer 282, Builder 284, Analyst 286, and Reporter 288.

The Designer 282 is used to design the constraints for one or more Information Reservoirs 290. For example, according to an embodiment of the present invention, the Designer 282 is used to select sampling initiation tables and determine the target rates of inclusion for each tuple in the original data source 292. These inclusion probabilities, in turn, affect the overall size of an associated Information Reservoir 290 and the relative accuracies of different types of queries that may be run thereon. The Designer 282 is capable of establishing generic criteria for building an Information Reservoir 290, or alternatively, the Designer 282 can apply different biases that will affect select subgroups of tuples as explained more fully herein.

According to an embodiment of the present invention, the Designer 282 automatically generates a starting framework, such as by establishing the schema of the Information Reservoir 290. A user may then interact with a collection of options to customize the Information Reservoir 290, such as by manipulating the manner in which target rates of inclusion are determined. The user can preferably opt for increasingly detailed layers of options depending upon the user's sophistication and familiarity with the Information Reservoir 290.

The Builder 284 may be implemented as a separate component, or optionally the Builder 284 may be integrated with the Designer 282. According to an embodiment of the present invention, the Builder 284 receives as input the rates of inclusion derived from the Designer 282. The Builder 284 then outputs the actual rates of inclusion embedded within the resulting Information Reservoir 290. The scalability of the Information Reservoir 290 according to the present invention allows the Builder 284 to apply a build recursively to efficiently create an Information Reservoir collection with any number of Information Reservoirs 290 based upon the same original source data 292 but stored with different resolutions.

The Analyst 286 allows querying of Information Reservoirs 290 using the same analysis methods and syntax employed to analyze the original data source 292. According to one embodiment of the present invention, the Analyst 286 translates a query submitted against the source data 292 into a suitable format for submission against the Information Reservoir 290 and optionally, the data source 292 itself. For example, many database management systems support a semi-standardized query language known in the art as SQL (structured query language). However, other systems only support proprietary languages. Construction of sophisticated queries often requires expertise in the query language being used. Accordingly, the Analyst 286 is preferably configured to convert a query constructed in any query language (4GL language) to a format that can be efficiently executed on the Information Reservoir 290.

Some exact information is easily and quickly obtainable from the original data source 292. For example, exact information such as record counts, minimum values for attributes, and maximum values for attributes may often be obtainable directly from the data source 292 within acceptable computational timeframes. Other types of query information such as aggregates are much more time consuming to obtain from the original data source 292. By using the exact information easily and quickly obtained from the original data source 292 in conjunction with the approximate answers obtained quickly from the Information Reservoir 290, it is sometimes possible to compute an approximate answer that is more accurate than can be computed using the approximate representation alone and faster than can be computed using the original data source 292 alone.

The translation of the submitted query by the Analyst 286 may be accomplished manually, automatically, or provide automatic translation with a provision for manual intervention. For example, according to one embodiment of the present invention, the translation of the native query to a format suitable for processing against the Information Reservoir 290 is transparent to the user. The Analyst 286 module then returns approximate query answers to the submitted queries, preferably including confidence bounds for query answers to characterize the associated degree of precision.

The Reporter 288 seeks to integrate approximate answers into both novel and existing result reporting methodologies. According to an embodiment of the present invention, query answers are reported with accompanying precision information such as confidence intervals indicating the precision of the approximate answer. The precision information may be retained as hidden metadata when reported to the Reporter 288 thereby enabling delivery of Information Reservoir derived answers using most existing visual and tabled report mechanisms.

The components of the present invention may be implemented as individual modules that can be independently executed. Alternatively, the components may be integrated into one application. Irrespective, the various components may be distributed independently. Further, the system architecture of the present invention is portable to any number of operating systems. For example, the present invention may be implemented on servers running a version of Windows NT. Alternatively, the system may be implemented on a Unix based system operating an open-source Linux operating system. Further, the present invention may be practiced on distributed processing techniques as well as parallel processing techniques.

18.2. Query Translation and the Analyst Component.

The query translator as discussed so far takes queries against the source database and turns them into queries against the representation which return point estimates and variances with variances being a natural representation for use with subsequent queries. The end user may be less interested in variances and more interested in confidence intervals. In that case, confidence intervals for any desired confidence level can be obtained from the point estimates and variances using the formulas in TABLE 6.

TABLE 6
The Structure of Confidence Bounds
(Estimator and VarEstimator are any estimated statistic and
it estimated variance, including count, sum, and average.)

| REFERENCE | AGGREGATION FORMULA |
|---|---|
| 18 | $LCB = Estimator - ( {z}_{( \frac{α}{2} )} or {t}_{( \frac{α}{2} )} ) * SQRT ( VarEstimator )$ |
| 19 | $UCB = Estimator - ( {z}_{( \frac{α}{2} )} or {t}_{( \frac{α}{2} )} ) * SQRT ( VarEstimator )$ |

The manner by which the results of queries get converted to confidence intervals depends upon the particular embodiment and implementation of the invention. Several potential methodologies are presented.

One embodiment of the Information Reservoir is that is implemented in a commercial third party database system and the query translator is an independent stand-alone program. Queries are written and translated outside of the database system, then submitted. In this context, it is a straight-forward addition to the query translator to add queries which return results with confidence bounds. This is a text substitution technique which is suitable for either embodiment of the query translator discussed.

An issue here is which tables to re-represent in this manner. A basic automated approach is to re-represent every table. Since the variance form is needed for subsequent queries, two tables will be produced at each step: one for viewing and one for subsequent queries. A naming or metadata system will identify which is which. A slightly more involved approach would be to augment the query language so that tables of interest will be indicated and the translator will write queries which return results with confidence bounds for these tables only.

Several embodiments of this invention specify an Analyst Component as part of the Approximate Query Architecture. If the Analyst Component is such that the user need to interact only with the Analyst and not with the database directly (i.e., the user writes queries in the Analyst and views results via the Analyst), then the work of using the formulas in TABLE 6 can be performed by the Analyst Component, and not the query language. One embodiment would be for the translated queries to always be invisible to the user and for the results to always be returned with variances. Whenever the user accessed results (e.g., by viewing, printing, or exporting), the formulas of TABLE 6 would be applied. In this embodiment the system would always store results with variances and the user would only ever see results with confidence bounds.

The Analyst Component is a vehicle by which the user preferences can enter the querying and query translation process. Through its interface the user can set parameters dictation how results will be returned (e.g., confidence bound, variances, or standard deviations), confidence level of confidence bounds (e.g., 90% or 95%), and if a multi-resolution Information Reservoir is implement the user may either select setting for the “click stop dial” or set time versus precision controls.

Implementation will dictate whether these tasks are performed by the query translator in particular or by other logic in the Analyst Component. For example the translator will not need to compute confidence bounds if the user always interacts with tables with an Analyst Component Interface. In the case of multiple-resolution Information Reservoir collections, if each sub-information Reservoir is in a separate database, it is expected that the Analyst Component will direct queries appropriately. If the sub-information Reservoirs are stored in a single database, it is expected that the queries would need to be rewritten with appropriate table names and the translator would deal with this task. Similarly if the different resolutions represent row ranges within a set of tables, the queries then need to reflect this and again the query translator is the appropriate vehicle for implementation.

19. Architecture for Combining Information Reservoirs with Other Forms of Concise Representation of Data Sources.

Given the variety and dynamics of data, there are a number of techniques to represent data sources that can be used to further leverage the flexibility of Information Reservoirs according to various embodiments of the present invention. Specific methodologies such as histograms, wavelets, Bayesian networks, data cubes, data clouds, and statistical or mathematical models each have strengths and weaknesses that may be exploited depending upon the type of underlying data. As such, there may not be one representation for a source database that is superior under all situations and proposes for a given set of user applications.

For example, histograms are generally suited for categorical data with relatively few categories. Histograms can produce generally poor results however, when the number of data categories is large relative to the number data records. Further, histograms are usually not associated with continuous data, but may provide a good solution for data that partitions nicely into “bins” and this change in granularity of the data does not adversely affect quality of the query results. Wavelets offer a compression method for very large histograms, but may not give the type of error bounds that a user may require.

Different representations have strengths and weaknesses. One notable weakness in sampling representations is the ability to answer queries requesting minima or maxima. Histograms (in particular, Bayesian networks) answer these queries very well with absolute error bounds consisting of the bin width of the histogram. Further once the tables to model and binning parameters are chosen, a Bayesian network Information Reservoir maintains essentially constant size regardless of the size of the database. One weakness with Bayesian networks is that they are impractical to use to model an entire relational database, rather they are more practical when modeling parent-child pairs of tables. They also have the drawback of not providing confidence bounds, except for extrema queries, but the answers they provide are typically very good.

According to an embodiment of the present invention, the Designer 282 may optionally use data representations that are optimal for a particular data type or query purpose. For example, approximations to specific multidimensional histograms may be included in the Information Reservoir to accommodate highly selective queries that cannot be effectively answered by the data gathered through intelligent sampling. Thus rather than proposing a single approach, a framework is provided within which any and all database representations may be integrated.

Referring to FIG. 32, a system 300 is provided for exploiting multiple representations of a data source concurrently according to an embodiment of the present invention. The architecture comprises four components including a front-end analyzer 302, a multi-modal Information Reservoir 304, a query preprocessor 306, and an advanced query processor 308. Each component may be integrated together, or executed independently.

The front-end analyzer 302 examines the data source to determine valid and preferably optimal representations for particular attributes. The front-end analyzer 302 optionally interacts with a user of the Information Reservoir 304 to ascertain the scope and breadth of limitations the user is willing to accept in the Information Reservoir 304. The front-end analyzer 302 also preferably gives the user options concerning performance versus the size of Information Reservoir 304. and presents tradeoffs between size and data redundancy (e.g., storage of a single attribute in multiple modes).

Based on the analysis and decisions made by the front-end analyzer 302 (optionally with assistance from the user), a (multi-modal) Information Reservoir 304 is constructed optionally consisting of multiple data representations 304A, 304B, 304C, 304D. For example, some attributes may be sampled, others may be in wavelet-compressed histograms, and still others may be represented multiple times by sampling, histograms, and other representations. Metadata from these representations may also be a component of the Information Reservoir.

The preprocessor 306 analyzes submitted queries, checks the query requirements against any available metadata, and determines which representation(s) 304A, 304B, 304C, 304D of the Information Reservoir 304 to use to respond to the query. For example, the preprocessor 306 may select representations 304A, 304B, 304C, 304D from the Information Reservoir 304 based on optimality considerations. In the simplest case of each attribute being represented only once, the preprocessor 306 merely identifies for the advanced query processor 308 the method of data representation. In other cases where attributes are represented in several valid ways, the preprocessor 306 also decides which representation 304A, 304B, 304C, 304D to use. Preferably, such decisions can occur on an attribute-by-attribute basis. For example, the choice of a representation 304A, 304B, 304C, 304D may depend on the combination of attributes in the queries and the type of aggregate (or other statistic) requested. An optimal query plan and other standard pre-query operations may also be performed.

The advanced query processor 308 is capable of processing a query and returning the query result. The query processor 308 can may, for example, process different portions of a query using different methodologies based on the representation type of the attribute in the Information Reservoir 304. The advanced query processor 308 can determine an attribute type for example, based on metadata stored with the Information Reservoir 304, and then perform the proper calculation. Also, the query output may vary with type of multimodal representation used. For example, different representations 304A, 304B, 304C, 304D may require maintaining auxiliary variables or handle errors in a particular manner. For example, an embodiment of this invention combines a sampled Information Reservoir with Bayesian networks of the key parent-child pairs. The advanced query processor 308 uses the Bayesian network representation to process extrema queries as well as queries where sampling is deemed a poor approach. Other queries are directed to the sampled Information Reservoir.

Having described the invention in detail and by reference to preferred embodiments thereof, it will be apparent that modifications and variations are possible without departing from the scope of the invention defined in the appended claims. For example, while approximate database querying can enable valuable solutions almost anywhere large databases are being queried, it may be useful to consider some specific problems that can be addressed using these techniques. The most obvious applications are data mining, trend prediction/forecasting, and model building based on large databases. For example, cross-selling or measuring program effectiveness based on customer and/or transaction databases. Similarly, approximate querying can be used for data exploration—reducing the statistical expertise needed, allowing statistical comparison across data sets of different sizes, or facilitating faster, more advanced querying. This could enable faster hypothesis exploration, rapid “what if” analysis, as well as remote or off-line querying by making datasets portable, due to their reduced size. In addition, approximate querying can enable anomaly detection (e.g. in credit card fraud detection) and indexing (including in the creation of indexes for world wide web pages).

Specific market targets where approximate querying has clear and immediate value include financial services (including insurance, product warranties, portfolio management/investment analysis), health care (disease surveillance, insurance, drug development), retail and supply chain management (product tracking, such as using RFID data; inventory management/tracking; retail analytics), government (homeland security, network security, network traffic analysis, IRS tax data, immigration data), and science (space object analysis/monitoring, such as analysis of potential earth impacts; environmental monitoring; oil and gas exploration; weather modeling; large-volume data from instruments, such as high-energy particle/collision analysis, protein structure analysis, telescope signal analysis).

What is claimed is:

1. A computer-implemented information reservoir creation process wherein:
a table collection is constructed from a data source;
said table collection includes a subset of tables designated as sampling initiation tables;
each table in said table collection is a member of either a directly-sampled table set or a descendent-sampled table set;
said directly-sampled table set is characterized by tables that are either sampling initiation tables or ancestor tables to one or more sampling initiation tables;
said descendant-sampled table set is characterized by tables that are descendant tables to a sampling initiation table;
said table collection is characterized by a table collection schema equivalent to a data source schema of said data source, with the exception that a list of attributes for each table of said directly-sampled table set includes an additional attribute containing actual rate of inclusion values;
each tuple included in said table collection is equivalent to one and only one tuple in the corresponding table of said data source;
an actual rate of inclusion value stored with a select data source tuple and included in a directly-sampled table of said table collection represents the probability that a randomly selected table collection produced by the process will contain said select data source tuple.

2. A computer-implemented information reservoir creation process as claimed in claim 1 wherein each tuple included in said table collection is equivalent to one and only one tuple in the corresponding table of said data source.

3. A computer-implemented information reservoir creation process as claimed in claim 1 wherein each tuple included in said table collection is equivalent to one and only one tuple in the corresponding table of said data source after elimination of said actual rate of inclusion value.

4. A computer-implemented information reservoir creation process as claimed in claim 1 wherein said table collection includes all ancestor tuples of each tuple included in any directly-sampled table of the table collection.

5. A computer-implemented information reservoir creation process as claimed in claim 1 wherein said table collection includes all descendant tuples of each tuple included in any sampling initiation table of the table collection.

6. A computer-implemented information reservoir creation process as claimed in claim 1 wherein said probability that a randomly selected table collection produced by the process will contain a given data source tuple in a descendant-sampled table is equal to the actual rate of inclusion stored with a corresponding single ancestor tuple residing in a sampling initiation table.

7. A computer-implemented information reservoir creation process as claimed in claim 1 wherein no pair of data source tuples within any select tuple set taken from directly-sampled tables has an ancestor-descendant relationship.

8. A computer-implemented information reservoir creation process as claimed in claim 7 wherein the probability that a randomly selected table collection produced by the process will contain all of the tuples in said select tuple set is equal to the product of the corresponding actual rates of inclusion associated with each of the individual data source tuples.

9. A computer-implemented method for constructing a representation from a data source in order to provide relatively quick response to queries related to information in said data source, wherein said data source has a plurality of tuples stored in said data source and a data source schema that includes defined relationships among at least a subset of the tuples in the data source, said method comprising:
creating said representation by copying at least a subset of said data source schema to define a representation schema;
adding additional data to said representation that represents information that is not in said data source;
defining tuples of interest within said data source and a degree of interest for each tuple of interest;
sampling tuples from said tuples of interest into said representation based upon said degree of interest in a manner that preserves at least a subset of said relationships among tuples in the data source; and
storing values in the representation that relate to a likelihood that each tuple sampled into said representation would be sampled into the representation if the sampling process were to be repeated.

10. A computer-implemented method as claimed in claim 9 wherein said data source is a table collection.

11. A computer-implemented method as claimed in claim 10 wherein said table collection is a relational database and said defined relationships among tuples are foreign key relationships.

12. A computer-implemented method as claimed in claim 9 wherein said representation schema comprises a logically limited subset of said data source schema.

13. A computer-implemented method as claimed in claim 9 wherein said additional data for an individual tuple includes selected aggregates of descendant tuples.

14. A computer-implemented method as claimed in claim 9 wherein:
said representation is to be used to respond to queries against a parent table that are restricted to parents of a particular kind of child type; and
said representation further includes data added to said representation that is indicative of whether a select tuple in said parent table is associated with said particular kind of child type.

15. A computer-implemented method as claimed in claim 9 wherein said tuples of interest are defined by a plurality of attributes and only a subset of said plurality of attributes are copied for each tuple into said representation.

16. A computer-implemented method as claimed in claim 9 wherein said tuples of interest are defined by associating with each tuple of interest a target rate of inclusion greater than zero and said degree of interest is indicated by the magnitude of the target rate of inclusion.

17. A computer-implemented method as claimed in claim 16 wherein determining said target rate of inclusion comprises taking a minimum of the quantity one and the result of dividing the number of tuples desired in the representation by the total number of tuples in the data source that are to be considered for sampling.

18. A computer-implemented method as claimed in claim 16 wherein said representation is biased by assigning a higher target rate of inclusion for a subset of said tuples of interest.

19. A computer-implemented method as claimed in claim 16 wherein determining said target rate of inclusion comprises taking the minimum of the quantity one and the result of dividing the number of tuples desired in the representation by a number of subpopulations, and dividing that result by the number of tuples in each subpopulation.

20. A computer-implemented method as claimed in claim 16 further comprising:
identifying one or more real-valued attributes of interest in said data source;
clustering said data source based upon said real-valued attributes of interest; and
partitioning said population into subpopulations based upon said clustering, wherein said rates of inclusion are assigned to tuples by subpopulation.

21. A computer-implemented method as claimed in claim 16 wherein said target rate of inclusion is set to its maximum value for tuples containing attribute values that have a high degree of influence on anticipated query results.

22. A computer-implemented method as claimed in claim 16 wherein knowledge of an anticipated workload is encoded into a first set of queries that are representative of said knowledge of said anticipated workload to derive weighting factors used to establish said target rates of inclusion.

23. A computer-implemented method as claimed in claim 22 further comprising:
determining a training set of queries defining a reservoir training set;
associating a set of aggregates with each training query;
collecting said aggregates into a superset;
determining weights for said aggregates in said superset to reflect the importance to users of said representation;
determining a tuning parameter from said weights;
partitioning a sampling population into at least those tuples in the scope of said aggregates, and those tuples outside the scope of said aggregates; and
determining target rates of inclusion for the tuples in each group.

24. A computer-implemented method as claimed in claim 23 wherein said target rates of inclusion for said tuples in the scope of said aggregates in said superset are chosen to minimize the variances of aggregate estimates computed from the representation.

25. A computer-implemented method as claimed in claim 23 wherein said rate of inclusion for tuples participating in sums has the property that tuples with attribute values that are relatively large in magnitude are assigned larger target rates of inclusion.

26. A computer-implemented method as claimed in claim 23 wherein said rate of inclusion for tuples participating in averages has the property that tuples with outlying attribute values are assigned larger target rates of inclusion.

27. A computer-implemented method as claimed in claim 16 further comprising controlling the size of said representation by:
establishing a target number of tuples for said representation;
assigning a tuple preference factor to each tuple among said tuples of interest; and
computing said target rate of inclusion for a select tuple among said tuples of interest based upon said target number of tuples and said tuple preference factor.

28. A computer-implemented method as claimed in claim 27 wherein said tuple preference factor is selected between the values of zero and the quotient defined by the number of said tuples of interest in said data source divided by said target number of tuples such that the sum of all tuple preference factors equals the number of said tuples of interest.

29. A computer-implemented method as claimed in claim 27 wherein said target rate of inclusion for a select tuple among said tuples of interest is computed by multiplying said target number of tuples by said tuple preference factor, and dividing that product by the number of said tuple of interest.

30. A computer-implemented method as claimed in claim 9 wherein the space required by said representation is determined comprising:
determining an average tuple inclusion probability; and
approximating said space by multiplying said average tuple inclusion probability by the sum of a first space required to store the actual tuples in said data source to be considered for sampling and a second space required to store auxiliary structures whose sizes are proportional to said first space, and adding to that product, a third space required to store auxiliary structures whose sizes are not proportional to said first space.

31. A computer-implemented method as claimed in claim 30 wherein said average tuple inclusion probability is determined by dividing a target number of tuples in said representation by the number of said tuples of interest in said data source.

32. A computer-implemented method as claimed in claim 9 further comprising determining an estimate of the size of said representation by:
obtaining the number of child tuples for a single relationship;
determining whether a target or an induced inclusion probability dominates;
calculating an average actual inclusion probability of a parent table; and
repeating the above steps recursively until an estimate of the expected size of said representation results.

33. A computer-implemented method as claimed in claim 32 wherein the number of child tuples is obtained using a frequency table.

34. A computer-implemented method as claimed in claim 32 wherein the number of child tuples is obtained using an index on the foreign key linking said relationship to said child tuples.

35. A computer-implemented method as claimed in claim 32 wherein said average actual inclusion probability of said parent table is calculated as a weighted average of the average inclusion probability of each subset of parent tuples having the same number of child tuples.

36. A computer-implemented method as claimed in claim 9 wherein ancestor tuples, both within and outside of said tuples of interest, of at least a subset of tuples selected into said representation may be given a higher chance of being selected into said representation.

37. A computer-implemented method as claimed in claim 36 wherein ancestor tuples of at least a subset of tuples selected into said representation are necessarily included in said representation.

38. A computer-implemented method as claimed in claim 9 wherein descendant tuples, both within said tuples of interest and outside of said tuples of interest, of at least a subset of tuples selected into said representation are given a higher chance of being selected into said representation.

39. A computer-implemented method as claimed in claim 38 wherein descendant tuples of at least a subset of tuples selected into said representation are included in said representation.

40. A computer-implemented method as claimed in claim 9 wherein an adjusted rate of inclusion is determined for each tuple of interest, said adjusted rate comprising possible contributions from said degree of interest in said tuple, from the results of sampling ancestor tuples of said tuple, and from the results of sampling descendant tuples of said tuple, and the act of sampling an individual tuple among said tuples of interest comprises:
considering a select tuple from said tuples of interest;
simulating a trial in which an event occurs with probability equal to the adjusted rate of inclusion;
determining whether or not the event has occurred; and
copying select tuple into said representation if and only if said event occurs.

41. A computer-implemented method as claimed in claim 40 wherein said event is that a uniform random number on the open interval (0,1) is less than said adjusted rate of inclusion.

42. A computer-implemented method as claimed in claim 40 wherein said trials for any pair of tuples within a table are simulated independently.

43. A computer-implemented method as claimed in claim 40 wherein said act of determining an adjusted rate of inclusion comprises:
assigning a target rate of inclusion to the select tuple of interest;
computing an induced rate of inclusion that represents the rate of inclusion induced by any descendant or ancestor tuples of said select tuple, said induced rate of inclusion set to zero if said select tuple has no descendants or ancestors; and
computing an adjusted rate of inclusion based upon said target rate of inclusion and said induced rate of inclusion, wherein said tuples of interest are sampled based upon said adjusted rate of inclusion.

44. A computer-implemented method as claimed in claim 43 wherein said induced rate of inclusion and said adjusted rate of inclusion are computed only if said select tuple is related to any descendant or ancestor tuples.

45. A computer-implemented method as claimed in claim 43 wherein said tuple of interest is associated with descendant and ancestor tuples that are partitioned into subgroups and said induced rate of inclusion is determined by:
computing an induced rate of inclusion for each subgroup based on the actual rates of inclusion associated with descendant and ancestor tuples in the subgroup; and
computing an overall induced rate of inclusion from the component rates of inclusion induced by each subgroup.

46. A computer-implemented method as claimed in claim 45 wherein said data source is dynamic with new tuples arriving over time, wherein each subgroup comprises sibling tuples partitioned by their arrival time into said data source.

47. A computer-implemented method as claimed in claim 45 wherein said data source is distributed over a number of computer devices greater than one, wherein each subgroup comprises sibling tuples partitioned by computer devices.

48. A computer-implemented method as claimed in claim 43 wherein said adjusted rate of inclusion is equal to the greater of zero and the result of the induced rate of inclusion subtracted from the target rate of inclusion divided by the result of subtracting the induced rate of inclusion from one.

49. A computer-implemented method as claimed in claim 43 wherein said select tuple is sampled at the time said select tuple's corresponding table is sampled at a sampling rate equal to the adjusted rate of inclusion.

50. A computer-implemented method as claimed in claim 43 wherein said select tuple is not sampled if said induced rate of inclusion is greater than or equal to said target rate of inclusion.

51. A computer-implemented method as claimed in claim 9 wherein an actual rate of inclusion is computed for each tuple selected into said representation, said actual rate of inclusion reflecting all opportunities for said tuple to be included in said representation.

52. A computer-implemented method as claimed in claim 51 wherein said actual rate of inclusion is part of said additional data added to said representation.

53. A computer-implemented method as claimed in claim 9 wherein said method further comprises:
representing said subset of said data source schema as a directed, acyclic graph having tables as vertices and table relationships as directed edges, said edges defining ancestor-descendant relationships between tuples in said data source;
traversing said vertices of said acyclic graph;
sampling each tuple associated with said vertices as each vertex is visited;
copying each tuple selected through sampling into said representation; and
optionally copying ancestor and descendant tuples associated with each tuple selected through sampling into said representation.

54. A computer-implemented method as claimed in claim 53 wherein said data source is a table collection.

55. A computer-implemented method as claimed in claim 54 wherein said table collection is a relational database and said ancestor-descendant relationships between tuples are foreign key relationships.

56. A computer-implemented method as claimed in claim 53 wherein said act of traversing said vertices comprises:
identifying a subset of the vertices as sampling initiation points;
performing a breadth-first traversal of those vertices identified as sampling initiation points;
traversing all vertices that can be reached from a sampling initiation point via pathways that follow the direction of said directed edges; and
traversing all vertices that can be reached from a sampling initiation point via pathways that follow the opposite direction of said directed edges.

57. A computer-implemented method as claimed in claim 9 wherein said representation defines a second representation that is a subsample of a first representation, and said method further comprises:
constructing said first representation;
defining subsample tuples of interest within said first representation and a subsample target rate of inclusion for each tuple of interest within said first representation;
constructing said second representation by sampling said first representation according to said subsample target rates of inclusion;
determining a subsample actual rate of inclusion for each tuple included in said second representation; and
determining the actual rate of inclusion for a select tuple in said second representation based on the actual rate of inclusion of said select tuple in said first representation and the subsample actual rate of inclusion of said select tuple in said second representation.

58. A computer-implemented method as claimed in claim 9 wherein said representation defines a third representation that is the union of a first representation and a second representation, and said method further comprises:
constructing said first representation;
constructing said second representation as a result of a sampling process that is independent of the sampling process for said first representation;
constructing said third representation by including any tuple that is included in either said first representation or said second representation; and
determining the actual rate of inclusion for a select tuple in said third representation based on the actual rate of inclusion of said select tuple in said first representation and the actual rate of inclusion of said select tuple in said second representation.

59. A computer-implemented method as claimed in claim 9 wherein said representation defines a third representation that is the intersection of a first representation and a second representation, and said method further comprises:
constructing said first representation;
constructing said second representation as a result of a sampling process that is independent of the sampling process for said first representation;
constructing said third representation by including any tuple that is included in both said first representation and said second representation; and
determining the actual rate of inclusion for a select tuple in said third representation based on the actual rate of inclusion of said select tuple in said first representation and the actual rate of inclusion of said select tuple in said second representation.

60. A computer-implemented method as claimed in claim 9 wherein said representation defines a first representation and said method further comprises establishing a maximum size for said representation and when said maximum size is exceeded, reducing the size of said representation by:
assigning a subsampling target rate of inclusion to each tuple in said first representation;
constructing a second representation by sampling said first representation according to said subsample target rates of inclusion;
determining a subsample actual rate of inclusion for each tuple included in said second representation;
determining the actual rate of inclusion for a select tuple in said second representation based on the actual rate of inclusion of said select tuple in said first representation and the subsample actual rate of inclusion of said select tuple in said second representation; and
replacing said first representation by said second representation.

61. A computer-implemented method as claimed in claim 60 wherein said subsample target rate of inclusion is equal to the desired size of said second representation divide by the size of said first representation.

62. A computer-implemented method as claimed in claim 61 wherein said size is measured in units of numbers of tuples.

63. A computer-implemented method as claimed in claim 61 wherein said size is measured in terms of bytes of disk storage space.

64. A computer-implemented method as claimed in claim 9 further comprising updating said representation in view of a change occurring to said data source, wherein said act of updating comprises:
identifying said change in said data source;
identifying a corresponding tuple in said representation that is associated with said change;
modifying said corresponding tuple in said representation if said change in said data source is a modification and said corresponding tuple exists in said representation; and
deleting said corresponding tuple in said representation if said change in said data source is a deletion and said corresponding tuple exists in said representation.

65. A computer-implemented method as claimed in claim 64 wherein changes are identified based upon a batch driven process.

66. A computer-implemented method as claimed in claim 64 wherein changes are identified in at least near real time.

67. A computer implemented method as claimed in claim 9 further comprising updating said representation in view of added tuples occurring to said data source, wherein said act of updating said representation in view of added tuples comprises:
assigning a rate of inclusion to select ones of said tuples added to the data source; and
sampling from said select ones of said tuples added into said representation based upon associated rates of inclusion.

68. A computer-implemented method as claimed in claim 67 further comprising adjusting select inclusion probabilities over time in response to modifications to said data source.

69. A computer-implemented method as claimed in claim 67 wherein said act of sampling from said added tuples comprises:
constructing a buffer that substantially mirrors said representation schema;
copying said added tuples into said buffer;
copying any ancestor tuples and descendant tuples related to each added tuple into said buffer;
assigning a rate of inclusion to said added tuples in said buffer; and
sampling tuples from said buffer into said representation based upon associated rates of inclusion.

70. A computer-implemented method as claimed in claim 9 further comprising maintaining the relative size of said representation by:
identifying bounds for said representation;
identifying a change to said data source;
updating said representation based upon said change to said data source;
performing a first set of operations if said representation is below said bounds comprising drawing a supplementary sample from said data source and joining said supplementary sample to said representation if deletions to said data source occur more frequently than additions to said data source;
performing a second set of operations if said representation is within said bounds comprising allowing maintenance to said representation based upon said update; and
performing a third set of operations if said representation is above said bounds comprising assigning a deletion inclusion probability to each tuple in said representation and subsampling said representation based upon said deletion inclusion probabilities.

71. A computer-implemented method as claimed in claim 9 wherein said representation is incrementally updated as said data source is updated.

72. A computer-implemented method as claimed in claim 9 wherein said representation is continually rebuilt.

73. A computer-implemented method as claimed in claim 72 wherein said representation is continually rebuilt by defining logical partitions of tables of said data source, ordering said logical partitions, and, for each logical partition:
loading a select partition into a buffer;
adding tuples to said buffer as necessary for said buffer to contain the closure of said select partition;
sampling said buffer;
joining the sampled buffer with said representation; and
updating rates of inclusion of tuples sampled from said buffer.

74. A computer-implemented method as claimed in claim 72 wherein said representation is subsampled to control the size of the rebuilt representation.

75. A computer-implemented method as claimed in claim 9 further comprising answering queries against said data source with approximate answers computed from said representation.

76. A computer-implemented method as claimed in claim 75 further comprising providing a variance with said approximate answer.

77. A computer-implemented method as claimed in claim 75 further comprising providing a confidence interval for the exact answer with said approximate answer.

78. A system for constructing a representation from a data source in order to provide response to queries related to information in said data source, wherein said data source has a plurality of tuples stored in said data source and a data source schema that includes defined relationships among at least a subset of the tuples in the data source, said system comprising:
at least one processor;
at least one storage device communicably coupled to said at least one processor arranged to store said data source and said representation; and
software executable by said at least one processor for:
creating said representation by copying at least a subset of said data source schema to define a representation schema;
adding additional data to said representation that represents information that is not in said data source;
defining tuples of interest within said data source and a degree of interest for each tuple of interest;
sampling tuples from said tuples of interest into said representation based upon said degree of interest in a manner that preserves at least a subset of said relationships among tuples in the data source; and
storing values in the representation that relate to the likelihood that each tuple sampled into said representation would be sampled into the representation if the sampling process were to be repeated.

79. A system as claimed in claim 78 wherein said software implements a designer component for:
interacting with a user; and
defining parameters used to construct said representation based upon said parameters.

80. A system as claimed in claim 79 wherein:
said designer component provides a user with a list of distinct valid values of categorical attributes from dimension defining tables and/or a list of valid value ranges for real-valued attributes; and
those subsets of tuples in said data source not associated with categorical values or value ranges that are selected by the user are marked for exclusion from said representation.

81. A system as claimed in claim 78 wherein said software implements a designer component for:
interacting with a user; and
defining parameters used to construct a collection of scaled representations based upon said parameters.

82. A system as claimed in claim 81 wherein said software is configured to construct a collection of scaled representations by first constructing a largest representation and then subsampling said largest representation.

83. A system as claimed in claim 78 wherein said software implements a designer component for interacting with a user to allow said user to adjust the balance of tuples in said representation and said software constructs said representation based upon said adjustment.

84. A system as claimed in claim 78 wherein said software implements an analyst component for:
intercepting an original query;
remapping said original query into a format compatible with said representation;
applying said remapped query against said representation; and
providing the results of the remapped query in response to said original query.

85. A system as claimed in claim 84 wherein said results of the remapped query include one or more approximate answers.

86. A system as claimed in claim 85 wherein said results of the remapped query include a variance with each approximate answer.

87. A system as claimed in claim 85 wherein said results of the remapped query include a confidence interval for the exact answer with each approximate answer.

88. A system as claimed in claim 84 wherein said software implements a builder component for constructing multiple representations of said data source and said analyst component is further configured for selecting between said multiple representations to select an optimal representation from said multiple representations to apply said remapped query against.

89. A system as claimed in claim 88 wherein said software is further configured to construct multiple scaled versions of said representation and said software is further capable of applying said remapped query against a select one of said multiple scaled versions of said representation.

90. A system as claimed in claim 88 wherein said multiple representations constructable by said builder component are selected from the group consisting of sampling, pre-computed aggregates, histograms, wavelets, data cubes, and data clouds.

91. A system as claimed in claim 78 wherein said software implements a reporter component for outputting one or more approximate answers to said original query.

92. A system as claimed in claim 91 wherein said reporter component optionally outputs a variance with each approximate answer.

93. A system as claimed in claim 91 wherein said variance is provided by the reporter component as hidden metadata.

94. A system as claimed in claim 91 wherein said reporter component optionally outputs a confidence interval for the exact answer with each approximate answer.

95. A system as claimed in claim 94 wherein said confidence interval is provided by the reporter component as hidden metadata.

96. A computer readable medium including program code representing computer implemented operations for constructing a representation from a data source in order to provide relatively quick response to queries related to information in said data source, wherein said data source has a plurality of tuples stored in said data source and a data source schema that includes defined relationships among at least a subset of the tuples in the data source, said operations comprising:
creating said representation by copying at least a subset of said data source schema to define a representation schema;
adding additional data to said representation that represents information that is not in said data source;
defining tuples of interest within said data source and a degree of interest for each tuple of interest;
sampling tuples from said tuples of interest into said representation based upon said degree of interest in a manner that preserves at least a subset of said relationships among tuples in the data source; and
storing values in the representation that relate to the likelihood that each tuple sampled into said representation would be sampled into the representation if the sampling process were to be repeated.

97. A method for translating simple SQL queries directed at sampling initiation and ancestor-sampled tables of a data source into revised SQL queries directed at an Information Reservoir or Information Reservoir collection created from said data source in order to calculate both approximate query answers and variances for the approximate answers, said method comprising:
comparing said simple SQL query to a list containing both SQL query types that can be translated and the associated translation rule or rules to be applied for each SQL query type that can be translated; and
applying said translation rule or rules associated with said simple SQL query to translate said simple SQL query into a revised query directed at said Information Reservoir or Information Reservoir collection created from said data source.

98. The method as claimed in claim 97 wherein said translation rules are text substitution rules.

99. The method as claimed in claim 97 wherein said simple SQL query can include an aggregate expression composed of linear combinations of simple aggregate functions directed at directly-sampled tables.

100. The method as claimed in claim 97 wherein said method is computer-implemented and said comparing and said translating are performed automatically.

101. A computer-implemented method for translating queries directed at a data source into revised queries directed at an Information Reservoir or Information Reservoir collection created from said data source in order to calculate both approximate query answers and variances for the approximate answers, said method comprising:
translating queries directed at said data source into a sequence of atomic operations that act on said data source; and
translating atomic operations that act on said data source to atomic operations that act on said Information Reservoir or Information Reservoir collection in order to calculate both approximate query answers and variances for the approximate answers.

102. A computer-implemented method as claimed in claim 101 further comprising the optional translation of atomic operations on said Information Reservoir or Information Reservoir collection to queries on said Information Reservoir or Information Reservoir collection.

103. A computer-implemented method as claimed in claim 101 further comprising a structure for storing table metadata for each table in said Information Reservoir or Information Reservoir collection, said table metadata comprising table names and aliases, foreign and primary keys, lists of attributes along with attribute sampling type, attribute variance, and location of associated rate of inclusion.

104. A computer-implemented method as claimed in claim 103 wherein said table metadata is defined not only for tables in said Information Reservoir or Information Reservoir collection, but also for each table that results from a query or atomic query operation applied to one or more tables of said Information Reservoir or Information Reservoir collection.

105. The computer-implemented method as claimed in claim 103 wherein said structure contains the schema of said Information Reservoir or Information Reservoir collection, said schema being optionally augmented with each table that is the result of a query or atomic query operation applied to one or more tables of said Information Reservoir or Information Reservoir collection.

106. The computer-implemented method as claimed in claim 105, wherein said queries directed at said data source may be translated to queries or atomic query operations directed at tables that resulted from previous queries or atomic query operations applied to one or more tables of said Information Reservoir or Information Reservoir collection.

107. The computer-implemented method as claimed in claim 101 further comprising a structure containing data necessary for determining which translation to apply during the query translation process.

108. The computer-implemented method as claimed in claim 107 where said data is a rule set comprising:
formulas for computing approximate query answers and variances for the approximate answers;
translation rules for replacing an atomic operation with a sequence of atomic operations; and
rules for updating table metadata and augmenting table collection schema.

109. A query system for use with an Information Reservoir or Information Reservoir collection created from a data source comprising at least one processor programmed to:
translate queries directed against said data source into a sequence of atomic operations that act on said data source; and
translate atomic operations that act on said data source to atomic operations that act on said Information Reservoir or Information Reservoir collection in order to calculate both approximate query answers and variances for the approximate answers.

110. A query system as claimed in claim 109 wherein said at least one processor is further programmed to optionally translate atomic operations on said Information Reservoir or Information Reservoir collection to queries on said Information Reservoir or Information Reservoir collection.

111. A computer readable medium including program code representing computer implemented operations for constructing a representation from a data source in order to provide relatively quick response to queries related to information in said data source, wherein said data source has a plurality of tuples stored in said data source and a data source schema that includes defined relationships among at least a subset of the tuples in the data source, said operations comprising:
creating said representation by copying at least a subset of said data source schema to define a representation schema;
adding additional data to said representation that represents information that is not in said data source;
defining tuples of interest within said data source and a degree of interest for each tuple of interest;
sampling tuples from said tuples of interest into said representation based upon said degree of interest in a manner that preserves at least a subset of said relationships among tuples in the data source; and
storing values in the representation that relate to the likelihood that each tuple sampled into said representation would be sampled into the representation if the sampling process were to be repeated.
